(19) United States
(12) Patent Application Publication
(10) Pub. No.: US 2023/0189382 A1
(43) Pub. Date: Jun. 15, 2023

(54) Devices for Measuring and/or Reporting in a Wireless Communication Network

(71) Applicant: Fraunhofer-Gesellschaft zur Förderung der angewandten Forschung e.V., München (DE)

(72) Inventors: Thomas HAUSTEIN, Berlin (DE); Paul Simon Holt LEATHER, Berlin-Schlachtensee (DE); Jasmina MCMENAMY, Berlin (DE)

(21) Appl. No.: 18/164,041

(22) Filed: Feb. 3, 2023

Related U.S. Application Data
(63) Continuation of application No. PCT/EP2021/071806, filed on Aug. 4, 2021.

(30) Foreign Application Priority Data
Aug. 5, 2020 (EP) 20189688.3
Jan. 14, 2021 (EP) 21151672.9
May 7, 2021 (EP) 21172908.2

(51) Int. Cl. H04W 76/20; H04W 24/10

(52) U.S. Cl. CPC H04W 76/20; H04W 24/10

(57) ABSTRACT

A device configured for operating in a bidirectional wireless communication network in a first operating mode in which the device is in a connected mode during a first time interval and in a second operating mode, in which the device at most performs passive communication during a second, different time interval is adapted to, in the first operating mode, obtaining a set of measurement results comprising at least one measurement result by measuring a radio link parameter associated with an operation of the wireless communication network. The device is configured for generating a measurement report comprising a set of results having at least one measurement result of the set of measurement results and for transmitting the measurement report to an entity of the wireless communication network.

### CROSS-REFERENCES TO RELATED APPLICATIONS

This application is a continuation of copending International Application No. PCT/EP2021/071806, filed Aug. 4, 2021, which is incorporated herein by reference in its entirety, and additionally claims priority from European Applications Nos. EP 20 189 688.3, filed Aug. 5, 2020, EP 21 151 672.9, filed Jan. 14, 2021 and EP 21 172 908.2, filed May 7, 2021, all of which are incorporated herein by reference in their entirety.

### BACKGROUND OF THE INVENTION

The present disclosure is related to a device configured for measuring and reporting in a wireless communication network. The present invention is further related to a device configured for measuring and logging the obtained measurement results in a wireless communication network, to a device configured for instructing a measuring device of the wireless communication network, to a wireless communication network, to methods for operating described devices and to a computer program product. The present disclosure is further related to measurement, logging and reporting in wireless networks.

Wireless communication links are used to connect the entities that comprise a wireless network. Although these links can, by definition, be unidirectional, they are typically bidirectional. Due to a variety of physical effects, these links are prone to varying levels of service quality.

It is known that wireless links are prone to varying levels of connection quality and that the reasons for such variations are numerous and include: small- and large-scale fading; blockage; interference; the effects of background noise; a loss of time, frequency and phase synchronization.

It is also known that in a communication link comprised of uplink and downlink directions, for example, from a user equipment (UE) to a basestation transceiver (BTS) and vice versa, respectively, the quality of service (QoS) is often direction dependent and can vary significantly over time. To provide and maintain links with the required or demanded QoS, link adaptation mechanisms that employ various techniques including feedback or close-loop control mechanisms are often used. However, QoS is typically assessed at the receiving end of the link, an efficient and successful link requires adequate link performance in both link directions not least to ensure that the QoS information determined at the receiving end of the link is returned to the transmitting end of the link. Upon receipt of same, the transmitter can then make the necessary adjustments in order to fulfil QoS requirements at the receiver. However, when the transmitter is not furnished with such information, it may incorrectly conclude that a link performance has degraded below a certain threshold or the connection has been broken even though its link with the receiver is adequate.

New services that require more stringent QoS parameters, for example high data rate; increased throughput; faster connection times; fewer lost packets, reduced packet delays; lower delay jitter, may degrade substantially at the service level if the end-to-end connectivity that comprises multiple wireless link elements cannot be guaranteed or maintained.

In July 2019, 3GPP published the study titled “Study on RAN—Centric Data Collection and Utilization for LTE and NR” and agreed New Work Item on support of SON and MDT for NR. The study and work items are aimed at developing standardised data collection solutions that help operators deploy and optimise 5G networks and deal with the increase in complexity, support for different verticals and use cases, split architecture of gNBs and many other new features of 5G. 3GPP Minimization of drive test (MDT) has been standardised since Release 10, providing network operators with optimisation tools in a cost-efficient manner. MDT supports two different modes: immediate and logged. Logged MDT is the procedure whereby the UE performs logging of measurement results and subsequently reports the logged measurement results. This is shown in FIG. 13 in which a basestation (labelled as “gNB”) sends a set or sequence of configuration instructions or commands to a specific device in the network (labelled “UE”). According to the configuration sent by the basestation, the device subsequently performs, records and reports certain measurements back to the basestation. It should be noted that in the current SOTA MDT, the network via the serving basestation is configuring a single given device. It should be further noted that whereas the process of configuration is performed when the two network entities (e.g. “gNB” and “UE”) are in the RRC_CONNECTED state, the “UE” measures and logs when it is in either the RRC_INACTIVE or RRC_IDLE state and reports once it is again in the RRC_CONNECTED state.

In FIG. 13 an example of a known minimization of drive tests is shown in which a basestation sends configuration commands to a UE which subsequently performs, records and report certain measurements.

Immediate MDT refers to the measurements performed by the UE in CONNECTED state and reporting of the measurements is available at the time of reporting. For immediate MDT, the following measurements, marked by M, are supported according to [TS 37.320].
M1: DL signal quantities measurement results for the serving cell and for intra-frequency/Inter-frequency/inter-RAT neighbour cells, including cell/beam level measurement for NR cells only [TS 38.215]
M2: Power Headroom measurement by UE [TS 38.213]
M3: Received Interference Power measurement
M4: Data Volume measurement separately for DL and UL, per DRB per UE [TS 28.552]
M5: Average UE throughout measurement separately for DL and UL, per DRB per UE and per UE for the DL, per DRB per UE and per UE for the UL, by gNB [TS 28.552]
M6: Packet Delay measurement separately for DL and UL, per DRB per UE [TS 28.552] and [TS 38.314]
M7: Packet loss rate measurement separately for DL and UL, per DRB per UE [TS 28.552] and [TS 38.314]
M8: RSSI measurement by UE (for WLAN/Bluetooth measurement) [TS 38.331].
M9: RTT Measurement by UE (for WLAN measurement) [TS 38.331].

Measurement collection triggers can be event-triggered (e.g. M1) or they can be the end of the measurement collection period (e.g. M3-M9) [TS 37.320].

In addition, in case of a radio link failure (RLF), NR RLF report content required for MDT includes:
Latest radio measurement results of the serving and neighbouring cells, including SSB/CSI-RS index and associated measurements in the serving and neighbouring cells;

The measure quantities are sorted through the same RS type depending on the availability, according to the following priority: RSRP, RSRQ, and SINR.
WLAN and Bluetooth measurement results, if were configured prior RLF and are available for reporting;
   “No suitable cell is found” flag when T311 expires;
   Indication per SSB/CSI-RS beams reporting whether it is configured to RLM purpose;
   Available sensor information;
   Available detailed location information;
RACH failure report (in case, the cause for RLF is random access problem or Beam Failure Recovery failure):
   Tried SSB index and number of Random Access Preambles transmitted for each tried SSB in chronological order of attempts;
      Contention detected as per RACH attempt;
   Indication whether the selected SSB is above or below the RSRP-Threshold SSB threshold, as per RACH attempt;
   TAC of the cell in which the UE performs the RA procedure;
   Frequency location related information of the RA resources used by the UE as per [TS 37.820].

For logged MDT, the network sends logged measurement configuration to the UE in connected mode, and then the UE collects measurements in RRC_IDLE/INACTIVE. Upon UE restarting the RRC connection, the UE firstly sends available indicator(s) to the network, and then the network can command the UE to send the measurements as indicated in [TR 37.816].

Logged MDT procedures deal with measurement configuration, measurement collection, reporting and context handling. Measurement configuration specifies periodic and event-based trigger (e.g. measurement quantity-based event L1, out-of-coverage detection trigger for logged MDT procedure for which logging interval is configurable and determines periodical logging of available data such as time stamp, location information) as well as logging duration. Optionally, the periodic measurement trigger is accompanied with a configuration of logging frequencies and cell IDs (i.e. PCI) for neighbour cell measurement. UE only need to log and report measurement results for the configured frequencies, if the results are available.

The logging configuration for event-based and periodic DL pilot strength logged measurements can be configured independently. Only one type of event can be configured to the UE.

When a logging area is configured, logged MDT measurements are performed as long as the UE is within this logging area. If a logging area is configured, logged MDT measurements are performed as long as the RPLMN is part of the MDT PLMN list. When the UE is not in the logging area or RPLMN is not part of the MDT PLMN list, the logging is suspended, i.e. the logged measurement configuration and the log are kept but measurement results are not logged.

For downlink pilot strength measurements, the logged measurement report consists of measurement results for the serving cell (the measurement quantity), available UE measurements performed in idle or inactive for intra-frequency/inter-frequency/inter-RAT, time stamp and location information.

In NR, in addition to the logged measurement quantities of the camped cell, the best beam index (SSB Index) as well as best beam RSRP/RSRQ is logged as well as the ‘number of good beams’ associated to the cells within the R value range (which is configured by network for cell reselection) of the highest ranked cell as part of the beam level measurements. Sensor measurements are logged if available.

For WLAN and Bluetooth measurement logging, the logged measurement reports consist of WLAN and Bluetooth measurement results, respectively.

The number of neighbouring cells to be logged is limited by a fixed upper limit per frequency for each category below. The UE should log the measurement results for the neighbouring cells, if available, up to (examples):
6 for intra-frequency neighbouring cells;
3 for inter-frequency neighbouring cells;
3 for NR (if non-serving) neighbouring cells;
32 for WLAN APs;
32 for Bluetooth Beacons.

For NR, EUTRA, WLAN and Bluetooth, the measurement reports for neighbour cells consist of:
Physical cell identity of the logged cell;
Carrier frequency;
RSRP and RSRQ for EUTRA and NR;
RSSI and RTT for WLAN APs;
RSSI for Bluetooth Beacons.

For each MDT measurement the UE includes a relative time stamp. The base unit for time information in the Logged MDT reports is the second. In the log, the time stamp indicates the point in time when periodic logging timer expires. The time stamp is counted in seconds from the moment the logged measurement configuration is received at the UE, relative to the absolute time stamp received within the configuration. The absolute time stamp is the current network time at the point when Logged MDT is configured to the UE.

Location information is based on available location information in the UE. Thus, the Logged MDT measurements are tagged by the UE with location data in the following manner:
ECGI, Cell-Id or NCGI of the serving cell when the measurement was taken is included in E-UTRAN, UTRAN or NR respectively;
Detailed location information (e.g. GNSS location information) is included if available in the UE when the measurement was taken. If detailed location information is available the reporting shall consist of latitude and longitude. Depending on availability, altitude, uncertainty and confidence may be also additionally included. UE tags available detailed location information only once with upcoming measurement sample, and then the detailed location information is discarded, i.e. the validity of detailed location information is implicitly assumed to be one logging interval;
For NR, sensor information (i.e. uncompensated barometric pressure measurement, UE speed and UE orientation) can be included, if available in the UE when the measurement was taken.

The neighbour cell measurement information that is provided by the UE may be used to determine the UE location (RF fingerprint).

Depending on location information availability, measurement log/report consists of:
time information, RF measurements, RF fingerprints; or
time information, RF measurements, detailed location information (e.g. GNSS location information);
time information, RF measurements, detailed location information, sensor information.

In addition to MDT, the SON Study Item TR 37.816 identifies specific areas that will be target for developing new features that will further help operators, targeting:
Capacity and Coverage Optimization
PCI Selection
Mobility Optimization
Load Sharing and Load Balancing Optimization
RACH Optimization
Energy Saving

### SUMMARY

An embodiment may have a device configured for operating in a bidirectional wireless communication network in a first operating mode in which the device is in a connected mode during a first time interval and in a second operating mode, in which the device at most performs passive communication during a second, different time interval; wherein, in the first operating mode, the device is configured for acquiring a set of measurement results comprising at least one measurement result by measuring or determining a radio link parameter associated with an operation of the wireless communication network; wherein the device is configured for generating a measurement report comprising a set of results comprising at least one measurement result of the set of measurement results and for transmitting the measurement report to an entity of the wireless communication network.

Another embodiment may have a device configured for operating in a bidirectional wireless communication network in at least a first operating mode in which the device is in a connected mode; wherein, in the first operating mode, the device is configured for transmitting and/or receiving wireless signals and for acquiring a plurality of measurement results, acquiring a measurement result comprising measuring or determining a radio link parameter associated with an operation of the wireless communication network; wherein the device is configured for generating a log so as to comprise information derived from the plurality measurement results and time information associated with the plurality of measurement results; wherein the device is configured for generating a measurement report from the log and for transmitting the measurement report to at least one entity of the wireless communication network; wherein the radio link parameter is associated with a link operated by the device; and/or wherein the device is configured for generating the measurement report so as to comprise information about at least one instance of the measurement result being acquired prior to a link degrading event causing degrading of the wireless link and for transmitting the measurement report to the entity of the wireless communication network after the link degrading event.

Another embodiment may have a device wireless communication network comprising: at least a first device according to the invention; and at least a second device being a device according to the invention; wherein the network is configured to perform a root cause analysis using the measurement report to analyse a cause for a link degrading event and/or to reconfigure the network to avoid or at least partly compensate for a link degrading event.

Another embodiment may have a device method for operating a device in a bidirectional wireless communication network in a first operating mode in which the device is in a connected mode during a first time interval and in a second operating mode, in which the device at most performs passive communication during a second, different time interval, the method comprising: operating the device in the first operating mode and acquiring, using the device, a set of measurement results comprising at least one measurement result by measuring or determining a radio link parameter associated with an operation of the wireless communication network; and generating, using the device, a measurement report comprising a set of results comprising at least one measurement result of the set of measurement results and transmitting the measurement report to an entity of the wireless communication network.

Another embodiment may have a device non-transitory digital storage medium having a computer program stored thereon to perform the method for operating a device in a bidirectional wireless communication network in a first operating mode in which the device is in a connected mode during a first time interval and in a second operating mode, in which the device at most performs passive communication during a second, different time interval, the method comprising: operating the device in the first operating mode and acquiring, using the device, a set of measurement results comprising at least one measurement result by measuring or determining a radio link parameter associated with an operation of the wireless communication network; and generating, using the device, a measurement report comprising a set of results comprising at least one measurement result of the set of measurement results and transmitting the measurement report to an entity of the wireless communication network, when said computer program is run by a computer.

A first recognition of the present invention is that in a scenario allowing for bidirectional communication, the device measures a radio link parameter and that by generating a measurement report from the obtained results, and by transmitting the measurement report to an entity of the wireless communication network, the wireless communication network may be provided with a detailed knowledge about the influences occurring on the wireless communication, thereby allowing it to determine root causes that degrade communication. Thereby, a high reliability of the wireless communication may be obtained.

According to an embodiment of the first recognition, a device configured for operating in a bidirectional wireless communication network in a first operating mode in which the device is in a connected mode during a first time interval and in a second operating mode, in which the device at most performs passive communication during a second, different time interval, is implemented such that, in the first operating mode, the device is configured for obtaining a set of measurement results comprising at least one measurement result by measuring or determining a radio link parameter of the wireless communication network. The device is configured for generating a measurement report comprising a set of results having at least one measurement result of the set of measurement results and for transmitting the measurement report to an entity of the wireless communication network. This allows to obtain measurement results that are obtained while the device is in the connected mode and, thus, possibly during a communication/transmission performed with the device.

A second recognition of the present invention is that a log or a stored number of measurement results is helpful for evaluating the wireless communication network for a link that is operated by the device itself and/or by generating the measurement report so as to comprise information about at least one instance of a measurement result being obtained prior to a link degrading event causing degrading of the wireless link, wherein the measurement report is transmitting after the link degrading event. That is, the radio link parameter is related to an own link of the device and/or refers to a time prior to a link degrading event or has been permitted thereafter. A link degrading event may be any event that causes a degrading of a link quality and/or even a link failure. This event may be related to the radio link itself, e.g., a device moving out of coverage or being temporarily blocked, or running out of battery or the like but may also have external effects, e.g., a storm that dislocates and/or destroys antennas, newly built buildings or the like.

According to an embodiment, in accordance with the second recognition, a device configured for operating in a bidirectional wireless communication network in at least a first operating mode in which the device is in a connected mode is configured, in the first operating mode, for transmitting and/or receiving wireless signals and for obtaining a plurality of measurement results, obtaining a measurement result comprising measuring or determining a radio link parameter associated with an operation of the wireless communication network. The device is configured for generating a log so as to comprise information derived from the plurality of measurement results and time information associated with the plurality of measurement results. The device is configured for generating a measurement report from the log and for transmitting the measurement report to at least one entity of the wireless communication network. The radio link parameter is associated with a link operated by the device and/or the device is configured for generating the measurement report so as to comprise information about at least one instance of the measurement result being obtained prior to a link degrading event causing degrading of the wireless link and for transmitting the measurement report to the entity of the wireless communication network after the link degrading event. This allows the device to monitor its own link and/or to report measurement results that may allow or support the network to determine information about the link degrading event retrospectively, thereby providing for information that may be used for a learning process for future events.

Further embodiments relate to a device that configures, instructs or requests devices for performing measurements which allows to generate and obtain the measurement results on demand.

Further embodiments relate to a wireless communication network, to methods for operating an apparatus described herein and to a computer program product.

### BRIEF DESCRIPTION OF THE DRAWINGS

Embodiments of the present invention will be detailed subsequently referring to the appended drawings, in which:

FIG. 1 shows a schematic block diagram of an apparatus according to an embodiment of the first recognition of the present invention;

FIG. 2 shows a schematic block diagram of a device being in accordance with the second recognition of the present invention;

FIG. 3 shows a schematic block diagram of a device configured for operating in a wireless communication network to instruct other device for measurements;

FIG. 4 shows a schematic block diagram of a wireless communication network according to an embodiment;

FIG. 5 shows a schematic block diagram of a wireless communication network in accordance with an embodiment, having at least three devices;

FIG. 6 shows a schematic block diagram of a wireless communication network in which a device operating as gNB maintains links with two different devices both being adapted as UE;

FIG. 7 shows a schematic block diagram of a wireless communication network according to an embodiment having at least four devices maintaining wireless or radio links;

FIG. 8 shows a schematic block diagram of a wireless communication network according to an embodiment comprising a number of at least two, at least three or at least four UEs;

FIG. 9 shows a schematic block diagram of a wireless communication network according to an embodiment in which a basestation and a UE are both operated as measurement and logging/reporting device;

FIG. 10 shows a schematic flow chart of a method for operating a device according to the first recognition;

FIG. 11 shows a schematic flow chart of a method for operating a device according to the second recognition;

FIG. 12 shows a schematic flow chart of a method for operating a device in a wireless communication network, for example, device of FIG. 3;

FIG. 13 shows a schematic illustration of a known network;

FIG. 14a/b show schematic representations of a wireless communication system in accordance with embodiments to illustrate the cases of inter cell interference

FIG. 15 shows a schematic representation of the wireless communication system of FIG. 18 in which Cross-link interference occurs;

FIG. 16 shows a schematic block diagram of an occurrence of CLI in an asynchronous network according to an embodiment;

FIG. 17 shows a schematic block diagram of an IAB network according to an embodiment;

FIG. 18 shows a schematic block diagram of an extension of the IAB network of FIG. 21 according to an embodiment;

FIG. 19 shows a schematic representation of different cases of interference handled by embodiments;

FIG. 20a-d show schematic block diagrams of arrangements of devices communicating wirelessly to illustrate the so-called hidden terminal problem in accordance with embodiments;

FIG. 21 shows a schematic block diagram of an arrangements of devices communicating wirelessly to illustrate the so-called exposed terminal problem in accordance with embodiments;

FIG. 22 shows a schematic flow chart of a method according to an embodiment and provides a high-level overview of the enhanced procedure for CLI interference management;

FIG. 23a shows a schematic flow chart of a method according to an embodiment and depicts a more detailed two-step CLI-mitigation approach;

FIG. 23b shows a schematic table indicating possible intervals for reporting detected interference in accordance with embodiments;

FIG. 23c shows schematic representations of different possible configurations 2702₁ to 2702_{N} of an example TDD slot;

FIG. 24 shows a schematic block diagram of a wireless communication system according to an embodiment to implement solutions described herein;

FIG. 25a-b show schematic representation in connection with embodiments related to self-interference; and

FIG. 26a/b show schematic plots in connection with embodiments related to self-interference.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well known structures and devices are shown in block diagram form rather than in detail in order to avoid obscuring embodiments of the present invention. In addition, features of the different embodiments described hereinafter may be combined with each other, unless specifically noted otherwise.

Some embodiments described herein relate to slots. However, slots are an illustrative example of a radio resource which comprise, alternatively or in addition, same resource blocks and/or subcarriers and slots/symbol. That is, as a resource, embodiments may incorporate one or more of at least one frequency bandwidth part (BWP), at least one resource block, at least one subcarrier and/or at least one time-domain slots/symbols. Embodiments described herein in connection with a time slot are, thus, not limited to a time slot but may refer, without limitation, to other types of radio resources.

The following embodiments relate to measuring or determining details of a wireless communication network. Some of those details may be referred to as a radio link parameter. The radio link parameter may be understood as a parameter relating or referring to the radio link. For example, the device in accordance with embodiments described herein may be configured for measuring or determining the radio link parameter as at least one of a within-link parameter, e.g., information related to a packet error rate, a throughput, an automatic repeat request count (ARQ) and/or a hybrid automatic repeat request count (HARQ). Alternatively or in addition, the device may be configured for measuring or determining the radio link parameter as an opposing-link parameter, e.g., information related to a cross-link interference (CLI), a signal-to-interference-noise ratio (SINR), an adjacent channel leakage ratio (ACLR) and/or a saturation. Alternatively or in addition, the device may be configured for measuring or determining the radio link parameter as a signal power, a signal quality such as a reference signal received power (RSRP), a reference signal received quality (RSRQ) or a signal-to-noise ratio (SNR). Alternatively or in addition, the device may be configured for measuring or determining the radio link parameter as an outside-of-the-link parameter, e.g., information indicating a signal power of a signal, e.g., as a function of frequency (including bandwidth), a time, a resource block, a beam, a cell identification, a direction information such as an angle of departure (AoD) and/or an angle of arrival (AoA), e.g., with respect to a particular TX beam and/or RX beam. That is, the radio link parameter may refer to a parameter of a link of which the device is a part, a different link and/or a parameter of a link that is deemed to not affect the device.

For example, the device may be configured for measuring or determining at least one of a PHY-layer parameter such as a bit error rate (BER), a block error rate (BLER), one or more modulation coding scheme levels (MCS levels), RSRP, RSRQ, SNR, SINR of a beam that is measured, for example, on a synchronization signal block (SSB), a channel state information (CSI)-reference signals (RS), a sounding reference signal (SRS) or the like, bam numbers on SSB, CSI-RS and/or SRS. Alternatively or in addition to the PHI-layer parameter, a higher layer parameter such as a number or ID of a serving or connected cell, information indicating cells observed by the device, a latency of communication, a jitter and/or a throughput of data may be measured as a radio link parameter. Alternatively, or in addition, as a radio link parameter may incorporate information suitable for optimising or assisting bidirectional communication in a way that supplementary information is provided, useful at either end of a link, i.e., the transmitter and/or the receiver. The radio link parameter may, for example, relate to receiver related signals or parameters such as the ones explained.

Alternatively, or in addition, the radio link parameter may relate to transmitter related signals or parameters. Whilst receiver related parameters may be obtained, for example, by measurements performed at a receiver, transmitter related parameters may be obtained by signalling, e.g., performed by the transmitter or an entity that has knowledge about the parameter used at the transmitter. Examples for such Transmitter/transmission related signals or parameters and configurations may be
Signals: e.g. embedded reference signals (RS), control signals, user plane signals, and/or other reference signals;
Transmission related signals may include but are not limited to:
   digital signals to go through digital transmit processing prior to being converted from digital into analogue signal domain;
   Digital or analogue control signals applied for beamforming, e.g. phase shifters, delay lines, attenuators and the like;
   Measured or captured signals, parameters from the transmitter chain, e.g. feedback signals for a digital pre-distortion (DPD), circuit/control of Self-interference-compensation (SIC) used for self- and/or adjacent channel interference cancelation/suppression or spurious emissions or out-of-band (OOB) radiation and/or adjacent channel leakage (ACLR) and the like.
Transmit parameters such as a Cell-ID, a carrier frequency, beamforming weights, antenna parameters or the like
Radio configuration parameters such as a minimum, maximum or actual number of retransmissions, one or more selected antenna panels, used or scheduled time and frequency resources, transmit scheduling information, transmission grants, uplink (UL)-downlink (DL) time and frequency relations, e.g., for closed loop control messages, CFO-pre-compensation (CFO: centre/carrier frequency offset)
a velocity, a geo-location, an orientation of the entity/device or antenna panel and/or even non-radio link parameters described below.

Whilst receiver related parameters or signals may be obtained by measuring, transmitter related parameters, signals or configurations may also be accessed or reported, i.e., a measurement itself is possibly not required. Some embodiments make reference to a measuring device and/or to measure a radio link parameter or other parameters. In view of reporting transmitter related signals, parameters and/or configurations, those embodiments directly relate to a determining device, to determining a radio link parameter, respectively.

Transmission related signals may be forwarded and stored, e.g., prior or during but also after the transmission process and/or separate or together with further information, parameters beneficial for post event analysis.

Beyond pure digital available data, parameters and settings, the transmission signal can be tapped, measured and logged at any stage of the transmission chain. The suitable measurement capability can be provided by a separate receiver/sensing apparatus or by using/sharing the embedded receive chain or some parts of it for signal detection, capturing and further processing including logging, analysing and/or reporting.

In view of the mentioned radio configuration parameters, and more particularly the UL/DL relations, such relations and/or relations between consecutively receive/transmitted signals may be measured/indicated/logged/reported/retransmitted, e.g., for a later post-event analysis or during the ongoing self-healing/optimization process before a critical event stage is entered.

The relation between UL-DL or between messages or settings within one direction (relative pointers/reference to messages, events, settings for unidirectional transmission/communication) and two directions (relative pointers/reference to messages, events, settings for bi-directional transmission/communication) may, alternatively or in addition, be part of such a relation to be analysed. A wireless communication system in accordance with embodiments may, thus, be configured for analysing the relation between messages or settings within one direction, e.g., relative pointers/reference to messages, events, settings for unidirectional transmission/communication) and/or two directions, e.g., relative pointers/reference to messages, events, settings for bi-directional transmission/communication.

Furthermore, such a cross-referencing can be extended with multi-hop communication protocols, where the cross-referencing may reach from one part of the concatenated links to another one. A wireless communication system in accordance with embodiments may, thus, be configured for analysing the relationship so as to comprise a cross-referencing between at least a first hop and a second hop of a multi-hop link

A wireless communication system in accordance with embodiments may, thus, analyse a radio communication link associated with the radio link parameter at a single end of the communication link; a first end and a second end of the communication link; and/or at least three ends of the communication link being a multi-hop link.

A wireless communication system in accordance with embodiments may, thus, be configured for analysing, e.g., after a link-degrading event and/or during a self-healing/optimization process before the link degrading event a relation referring to one or more of: an uplink (UL)-downlink (DL) relation; a relation between consecutively received signals; and a relation between consecutively transmitted signals.

Embodiments described herein relate to measuring, logging and/or reporting. Description provided in connection with described embodiments relates to MLRD standing for measuring, logging and reporting devices. In view of this, the logging is a possible implementation which is, however, not mandatory, in particular, when transmitting the measurements made directly or immediately. However, an implementation that, alternatively or in addition, allows for generating a log which serves as a basis for a measurement report is not precluded.

Embodiments provide for a link, a system and/or a network improvement which is achieved by allowing for accurate historical knowledge about the causes of the link degradation. Embodiments allow to make such knowledge available, accessible and obtainable. In known wireless networks, the data which would be needed to determine the cause of link degradation is neither available, accessible nor obtainable. Embodiments provide for mechanism and procedures through which parameters, events, commands and instructions are observed, recorded and reported. These observations or measurements and their logging and reporting can be made in one or both link directions and at one or both ends of a link. Furthermore, the link measurement, logging and reporting can be made before a link is established, during an active link connection and after a link has degraded to a certain threshold and/or when a connection is lost, such information providing for high advantages when reconstructing the reasons for degrading. The provision of such reports is made available to not only improve the quality of service of a given link but also to improve overall network performance.

As an example, a number of network devices or entities may be used to provide an end-to-end connection, wherein the quality of service between link elements may vary. The observation, logging and reporting of the inter-link service quality thus allows the root cause of the end-to-end performance degradation to be assessed. Devices can be suitably equipped to report or exchange information during a link or, following link failure, after a link is re-established. Such insights into potential root cause effects enable the inter-device performance and interaction to be improved in future connections. In addition, both coverage and capacity optimization (CCO) and energy saving improvements may be obtained. Thereby, the insufficiency of known concepts to enhance the performance of multi-beam communication network systems in 5G and beyond is addressed.

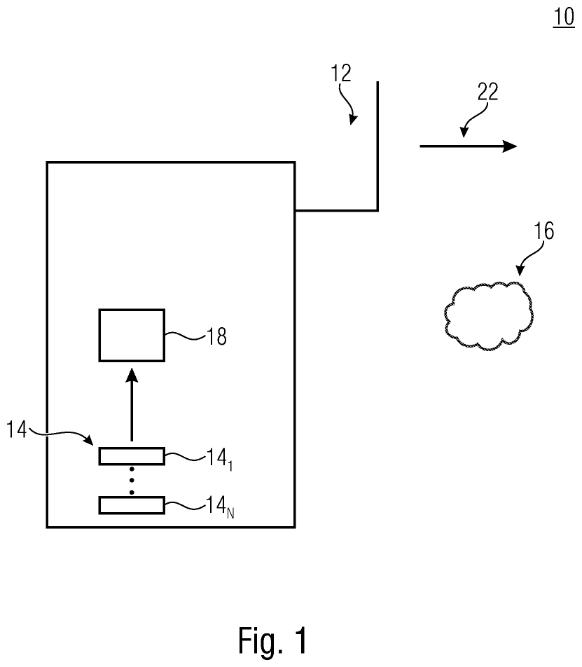

FIG. 1 shows a schematic block diagram of an apparatus 10 according to an embodiment. Apparatus 10 may be implemented, for example, in accordance with the first recognition of the present invention. Apparatus 10 is configured for operating in a bidirectional wireless communication network in a first operating mode during a first time interval and in a second operating mode during a second, different time interval. The second time interval may be prior or after the first time interval. In the first time interval, device 10 may be in a connected mode in which the device performance active communication. For example, such a mode may be referred to as RRC_CONNECTED (RRC=Radio Resource Control). In this operating mode, the device may be scheduled with resources of the wireless communication network which allows the device to transmit information, e.g., for transmitting a downlink signal if the device is implemented as a basestation or to transmit an uplink signal if the device is a participant of the network, a user equipment (UE) for example. In the first operating mode, the device is able to participate in a bidirectional communication. However, it is not necessary that the device being a UE transmits a signal or receives a signal, the device being a basestation or the like. That is, when compared to a broadcast or groupcast scenario in which a device is solely listening (receiver) or solely transmitting (transmitter) and the first operating mode allows for bidirectional communication.

In contrast to the first operating mode, in the second operating mode, the device may be implemented to perform, at most, passive communication, e.g., RRC_INACTIVE AND/OR RRC_IDLE MODE. In such a mode, the device may be part of the network but possibly does not perform active communication or transmit information.

In the first operating mode, the device is configured for obtaining a set 14 of measurement results 14ᵢ. For obtaining a measurement result, device 10 may measure a radio link parameter 16 of the wireless communication network. Measuring the radio link parameter 16 may incorporate a use of one or more sensors of the device 10 and/or an evaluation of wireless signals received and/or transmitted, for example, by use of the wireless interface 12.

The device is thus configured for obtaining the set 14 of measurement results in a connected mode. Device 10 is further configured for generating a measurement report 18, i.e., information comprising a set of results having at least one measurement result of the set 14 of measurement results. The device 10 is configured for transmitting the measurement report 18, e.g., using a wireless signal 22. The measurement report 18 may be transmitted to an entity of the wireless communication network.

Whilst the set 14 may be obtained by measuring the radio link parameter 16 such that at least one of the results 14₁ with i=1, . . . , N; N≥1 represents the measured radio link parameter, the measurement report may incorporate results that do not necessarily represent the radio link parameter. For example, additional measurements may be performed by the device 10 and those additional measurements or at least one result thereof may be incorporated into the measurement result 18. For example, the content of the measurement report 18 is based on a request received with the wireless device 10 prior to generating the measurement report 18. The device 10 may be configured for collecting measurement results and/or the set 14 based on the request such that, although capable of measuring the radio link parameter 16, device 10 reports different information. That is, device 10 may be configured for obtaining the set 14 of measurement results by measuring at least one non-radio link parameter associated with the operation of the wireless communication network. The measurement report 18 may be generated by the device 10 so as to comprise information indicating the non-radio link parameter. Examples for such non-radio link parameters of which device 10 may measure one or more include, amongst other things:
an acoustic parameter such as sound, ultrasonic, sound pressure level or the like
a vibration parameter such as amplitude and/or acceleration
a seismic parameter
a chemical parameter, e.g., material, substances or compounds as well as molecules being present, an electric parameter such as an electric voltage, current and/or electric potential being sensed
an electromagnetic parameter such as an electric field and/or a magnetic field a dielectric parameter
a radio parameter relating to a parameter that is measured at radio frequency, e.g., at least 3 hertz to higher frequencies of, for example, at most 300 gigahertz. Such a radio parameter may include, for example, a measurement of the power spectral density in a given frequency range. The radio parameter may thus relate to different parameters in the mentioned radio frequencies even if the parameter does not form a part of the radio link
a radar parameter
an environmental parameter such as a weather parameter, moisture, humidity and/or visibility
a flow related parameter such as fluid velocity, gas flow or the like
an ionizing radiation parameter
a parameter related to subatomic particles
a location-related parameter such as position, angle, displacement, distance, speed and/or acceleration
an optical parameter such as colour, wavelength and/or magnitude of light
an imaging parameter
a LIDAR parameter
a photon parameter
a pressure parameter
a force parameter
a density parameter
a level parameter, wherein level may be understood as a parameter in connection with a hydrological property such as sea level, river level or the like but may also relate to a level as in the meaning of straight (horizontal, vertical, at a given angle or inclination) which may be used to determine if a mast or antenna structure or the like has shifted due to an environmental effect, and/or in the meaning of a level related to an altitude in connection with a network device that is, for example, airborne (or a self-powered device that has slid down the side of a tree, mountain or other mounting structures)
a thermal parameter such as heat and/or temperature
a proximity parameter such as a presence or absence of bodies or objects
information indicating a potential, a suspected or known aggressor in view of wireless communication, e.g., an interferer.

That is, device 10 may be configured for measuring the radio link parameter and a non-radio link parameter. As indicated, the measurement report may contain information related to the non-radio link parameter whilst, optionally, forming the measurement report 18 in absence of the radio link parameter. Such information may provide for knowledge to the network by including information that is not necessarily directly related to the radio link parameter. For example, a storm may have dislocated an antenna of a basestation. Information indicating or related to such an event may form at least a part of the measurement report, thereby allowing the network or a higher level entity to determine a root cause for bad links or link failures or reconfiguration of the network as not the network itself faces a bad condition but external effects have led to other effects, e.g., the dislocated antenna.

In a scenario in which the device 10 is configured for generating the measurement reports so as to comprise the information indicating the non-radio link parameter and so as to not comprise the radio link parameter, the device can be configured for not measuring the radio link parameter, e.g., for this specific measurement report, and when generating the measurement report. This may allow to save computational resources and/or battery power.

Device 10 may be configured for measuring the radio link parameter and/or the non-radio link parameter and for generating the measurement report so as to report the measured information. For example, the measurement report may contain a single instance of one or more parameters. For example, the device may be configured for measuring a plurality of parameters comprising the radio link parameter so as to obtain a plurality of measurement results, i.e., the set 14 may comprise a plurality of results 14ᵢ related to different measured parameters. The device 10 may be configured for generating the measurement report by selecting for the set of measurement results to be included into the measurement report a subset of the plurality of measurement results being available or being recorded. In different terms, the device may perform measurements but may report only a part thereof, e.g., based on requested results or based on own decisions at the device. However, according to embodiments, the device performs measurements in accordance (at least in parts) with a received request which may reduce measurement overhead.

The device 10 may be configured for selecting a subset of measurement results to be included into the measurement report from the set 14 based on a selection signal received. The selection signal may indicate the parameters that are requested to be measured and/or reported by the device. For example, the selection signal may be a request and/or a configuration signal received from a further network entity.

The device 10 may be configured for generating the measurement report 18 as an immediate report but may, alternatively or in addition, be configured for generating the measurement report as a report of a logged measurement. That is, device 10 may store one or more measurement results and may recall those results, e.g., from an internal memory or the like, so as to generate the measurement report 18, for example, when a triggering event is occurring. Whilst the immediate report allows for a low latency between the measurements being made and the time the information is available at the network, logging may allow for a low network load by accumulating information and/or by transmitting information when the triggering event has occurred. Device 10 may be configured for generating the measurement report 18 so as to comprise information indicating the radio link parameter and a time information associated with the radio link parameter was measured. This may allow for comparing the measurement result with measurement results received from different entities which may comprise a common clock and/or for associating the measurement results with external or additional information received.

The time may relate to a time reference of the device, a different time reference in the wireless communication network and/or a combination of multiple time references.

The information associated with the time may relate to an absolute and/or relative time measurement and may include information indicating a coherence time, e.g., of time reference grids, a variance in time, a fluctuation and/or a time drift.

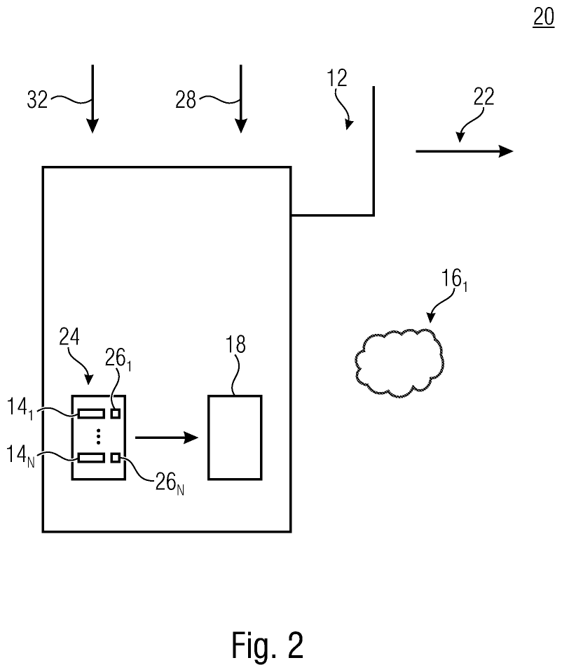

FIG. 2 shows a schematic block diagram of a device 20 being in accordance with the second recognition of the present invention. The device 20 may, as the device 10, be referred to as an MLRD. Device 20 may be configured for operating in a bidirectional wireless communication network in at least the first operating mode being described in connection with FIG. 1. In the first operating mode, the device 20 is configured for transmitting and/or receiving wireless signals and for obtaining a plurality of measurement results 14₁ to 14_{N}. Obtaining a measurement result may comprise a measuring of a radio link parameter, e.g., the radio link parameter 16₁. The device 20 is configured for generating a log 24 so as to comprise information derived from the plurality of measurement results and time information 26ᵢ associated with the plurality of measurement results 14ᵢ.

Optionally, further information may be included, e.g., information indicating a sensor type, the category of the parameter or the like. The device 20 may be configured for generating a measurement report, e.g., the measurement report 18 from the log and for transmitting the measurement report 18 to at least one entity of the wireless communication network, e.g., using the signal 22. The radio link parameter 16₁ may be associated with a link operated by the device, wherein the link may be a unidirectional link or a bidirectional link. Alternatively or in addition, device 20 is configured for generating the measurement report 18 so as to comprise information about at least one time instance of the measurement result being obtained prior to a link degrading event causing degrading of the wireless link operated by the device.

The device 20 may log the measurement result or the measurement results. The device 20 may report, to the entity of the wireless communication network, the measurement result after the link degrading event. For example, the link degrading event may incorporate a link failure or may lead to a link failure. The device 20 may transmit the measurement report 18 after re-establishing the link. When evaluating the past, the wireless network may still benefit from such information as it may associate the information contained in the measurement report with knowledge about failures in the network. For example, the device 20 may be configured for generating the measurement report 18 so as to comprise information about at least one instance of the measurement result being obtained prior to a link degrading event causing the degrading of the wireless link and for transmitting the measurement report to the entity of the wireless communication network after the link degrading event. For example, in a case where the link degrading event is an event causing a wireless link, i.e., the link of the device 20 or of a different device, facing a wireless link failure or at least temporary link interruption leading, at least for some time or a time interval, for an interruption of the wireless link, the device may report according to its capabilities. For example, if the own link is interrupted it may report after having re-established the link or after having established a side-link. If a link of a different device is affected, it may report without own disturbances. The device 20 may be configured for generating the log 24 and for reporting the log only in case a predefined triggering event occurs. The triggering event may comprise a received request, a link degradation or any other trigger, e.g., a lapsed time interval or other situations.

Embodiments particularly relate to a combination of events and/or multiple events to be the source for generating the measurement report or different versions of the measurement report. For example, different parameters arriving, exceeding or falling below a threshold may arrive at different measurement reports to be reported. Any other combinations are possible. That is, the device may be configured for transmitting the measurement report after a link degradation automatically or upon request. However, the request is not limited to be received after the link degradation but also may be received any time.

The device 20 may be configured for logging the measurements, i.e., to generate the log 24, in a state of being active (first operating mode), inactive or idle (e.g., a state being at least comparable to the second operating mode of device 10) in the wireless communication network.

Device 20 may be configured for including, to the measurement indicated in the measurement report 18, at least of an action in the wireless network determined by the device as such an action may be associated by the network to the link degrading event
an instruction recognized by the device
a request recognized by the device
a command recognized by the device and/or
a configuration of the device and/or other devices.

Such information may provide the network with a more global or globalized overview of the parameters effecting the network, directly or indirectly. Although being described in connection with device 20, device 10 may be adapted accordingly.

Device 10 and/or device 20 may be configured for logging the measurements in at least one of a continuous manner, a timed manner, e.g., in low-speed, high-speed or dynamic-speed, probably configurable, a sequence manner, an ordered manner, a requested manner, a windowed manner, an instructed manner, an event-based manner, a trigger-based manner, a threshold-based manner, e.g., a parameter is logged when falling below, arriving or exceeding a threshold value, and/or or a programmed or scripted manner.

That is, although logging is described in connection with device 20, device 10 may be implemented to generate a log accordingly. Vice versa, performing the measurements as described for device 10 may also be implemented at the device 20 such that one or more features described in connection with the device 10, device 20 respectively may be incorporated into device 20, device 10 respectively.

In connection with logging measurements, device 10 and/or device 20 may be configured for logging measurements for the measurement report together with a header, identifier, marker or stamp, i.e., additional information, containing one or more of:
an absolute time
a relative time
a time relative to a slot
a frame or the start of service (uptime)
a speed over ground
a location such as global positioning system (GPS) or other global navigation satellite system (GNNS) coordinates
an altitude
a cell-ID of the wireless communication network
a beam ID of a beam in the wireless communication network
an antenna pattern related to the beam and/or beam ID
a cell sector
a service set identifier (SSID)
an internet service provider (ISP)
a pathloss model (PLM)
a mobile network operator (MNO)
a radio access technology (RAT) connection type such as 5G, 4G, 3G, 2G, Y-5®, Bluetooth®, a long-range navigation (loran) and/or
a service type such as voice over IP (Vol P), video on demand, augmented reality, virtual reality or the like.

Each of those parameters may be related to the device itself and/or may be related to a different device but detectable by device 10 and/or 20 and, thus, log-able and/or reportable.

Device 10 and/or device 20 may include or incorporate or comprise sensor elements and/or calculation units such as processors or the like that allow to determine the respective parameter. Alternatively or in addition, device 10 and/or device 20 may be configured for receiving information indicating a measurement result from another device, e.g., using a wired or wireless interface. Device 10 and/or 20 may be configured for generating the log and/or measurement report so as to comprise the received measurement results. For example, the received measurement result may be stored in the log 24 which may be stored in a memory to which device 20 has access. Optionally, the received information, e.g., the measurement result itself and a time information, may be updated by an own time information or the like.

As described, providing the network with information that extends beyond the single wireless link and/or which is obtained during a time period in which the device is in the first operating mode in a bidirectional network, the ability of the network is increased to detect, correct and/or avoid disturbances in the network. In the following, examples for such a procedure are given. In a first example, a VoIP call is started in 4G and is handed over to 3G 2G and can, thus, experience QoS degradation (for example in voice quality). If link parameters related to such QoS degradation events were to be recorded at either both ends of the link and subsequently post-processed for root cause analysis, it is possible to reconfigure the network or the UE or the service so that the QoS is improved (in future). This may be facilitated through the optimization, correction and/or adjustment of the required parameters.

In another example, an integrated access and backhaul network (IAB) backhaul link comprised of MM Wave components in which beam forming systems are employed and, due to wind effects, may experience beam misalignment and, thus, a degradation in QoS or link failure. By deploying MLRDs, e.g., device 10 and/or 20, at one or both ends of the link, the relevant parameters can be measured and logged for subsequent analysis and examination, thus leading to the determination of the root cause and thereafter the appropriate optimization, correction or adjustment of the required parameters.

MLRD measurement, logging and reporting may be implemented, adapted and optimized individually and may be referred to as three separate topics. However, embodiments combine two or more thereof, e.g., the combination of measurement and logging and/or the combination of all three.

Measurement

The MLRD can measure (QoS) parameters on different layer of the protocol stack. For example:
PHY-layer
   BER, BLER, MCS levels
   RSRP/RSRQ/SNR/SINR of beams measured on SSB, CSI-RS, SRS
   Beam numbers on SSB, CSI-RS, SRS;
L3/Higher layer reporting
   Serving/connected cells
   Observed cells
   Latency
   Jitter
   Throughput

Parameters are selectable individually or in groups and groups can be pre-defined or defined dynamically. Measurement setting can include validity area and validity period. Measurement values can be flagged or described by a quality indicator (e.g. precision, accuracy, reliability, resolution). The QoS measurement is dependent on the equipment capability (super UE included).

An MLRD of certain capability may be configured to establish and maintain a link associated with a defined QoS over a configured period of time in order to probe/test/enable/investigate link behaviour/performance at particular time instances/locations/conditions which is different to known MDT-Minimization of Drive Testing.

The MLRD is capable of measuring parameters either within the link with which it has with another (network) entity, from other entities that may affect or oppose its link or outside of any link. Examples of within-link or inside-link monitoring include performances metrics such as packet error rate (PER), throughput, automatic repeat request (ARQ) counts and hybrid ARQ (HARQ) counts. Examples of opposing-link monitoring include performance metrics such as cross-link interference (CLI), signal-to-interference-noise ratio (SINR), adjacent channel leakage ratio (ACLR) and saturation. Finally, when an MLRD is measuring parameters that relate to the link between two other entities and the MLRD is not itself either of those entities and hence not part of the link, the MLRD can be said to be eavesdropping or overhearing the active link. In this case the MLRD, which is said to be outside-of-link, can measure signal power as a function of frequency (including bandwidth), time, resource block, beam, cell identification, direction information, AoD, AoA and so on.

Further MLRD measurement capabilities may include the following categories: acoustic, sound, ultrasonic, vibration, seismic; chemical; electric current, electric potential, electromagnetic, dielectric, radio, radar; environment, weather, moisture, humidity, visibility; flow, fluid velocity; gas; ionizing radiation, subatomic particles; position, angle, displacement, distance, speed, acceleration; optical, light, imaging, lidar, photon; pressure; force, density, level; thermal, heat, temperature; proximity, presence. These can be helpful in concluding the root cause of link degradation within the link.

To illustrate some of the above measurement categories, the following examples are given:

Terrestrial networks are typically comprised of basestation and antenna installations that are arranged to provide the required coverage and capacity for a given geographical region. Basestation antennas can be deployed on antenna masts or towers or on existing structures such as buildings, pylons and water towers. As a result of the effects of severe weather conditions (e.g. storms), earth tremors or natural disasters (e.g. avalanche, blizzard, earthquake, fire (wild), flood, freezing rain, heatwave, hurricane, landslide, lightning strike, tornado, tsunami, volcanic eruption), the position and orientation of basestation antennas can be changed or the antennas can otherwise be damaged such that coverage is affected. Measurement data collected from sensors (e.g. acoustic, ultrasonic, vibration, seismic, chemical, electrical, electromagnetic, wind, moisture, humidity, visibility, gas, position, angle, displacement, thermal) can be used to both forewarn a network or basestation of an approaching disturbance or otherwise be analysed after a performance degradation has been detected. As further example: data obtained from chemical sensors designed to measure gas levels (e.g. carbon dioxide) can be used to assess volcanic eruption and forest fires; data obtained from vibration, acoustic or seismic sensors can be used to assess earth tremors, storms, earthquakes, avalanches and landslides; and data obtained from electrical and electromagnetic sensors can be used to determine lightning strikes.

MLRD measurements of time can be relative to the MLRD's own time reference or another time reference (for example from another BTS, UE, MLRD or non-network entity) or as a combination of multiple time references. MLRD absolute and relative time measurements may include coherence time (of time reference grids), variances, fluctuations and drifts.

One or more MLRD(s) can be used for spectrum scanning and to observe beyond the channel or link of interest. Similarly, MLRDs can be used to locate the direction of radiating sources, including interference.

Logging

MLRD logging can be configured in active, inactive and idle mode. For example, measure on blank pilots of neighbouring and serving cells for CLI.

The MLRD is also capable of recording actions, instructions, requests and commands and configuration in all three of the use cases described above (namely, within-link, opposing-link and outside-of-link).

The MLRD records or logs measurement in a continuous, timed (low-speed, high-speed, dynamic-speed), sequenced, ordered, requested, windowed, instructed, event-based/trigger-based/threshold-based or programmed/scripted manner. In the case of event triggering, the MLRD can perform actions in either a semi-autonomous or completely autonomous manner. The measurement data can be recorded as-is or “raw”, uncompressed, compressed, averaged (running average/windowing), statistically processed or reduced (1^{st} order, 2^{nd} order statistics) or otherwise filtered. Furthermore, the measurement data can be recorded individually or as part of a defined group.

An MLRD can record a selection of measured (QoS) parameters together with a header, identifier, marker, stamp containing one or more of: absolute time; relative time; time relative to a slot, a frame or the start of service (uptime); the speed over ground; location (GPS/GNSS coordinates); altitude; cell ID; cell sector; SSID; ISP; PLM; MNO; RAT connection type (5G, 4G, 3G, 2G, Wi-Fi, Bluetooth, LORAN); service type (VoIP, Video On Demand, augmented reality, virtual reality).

MLRD data can be open, locked or otherwise protected for example by using block chain principles to limit unauthorised access, tampering or other forms of falsification.

The MLRD measurement depth (sampling interval, granularity) may be set according to parameter or a KPI requirement.

Additional MLRD parameter measurements and observations are not limited to include: potential, suspected or known aggressors and predators; and environmental conditions, disturbances or changes (e.g. being close to an electric/dielectric object).

Moreover, when an MLRD works in an autonomous or semi-autonomous manner, it can record or log measurements that another MLRD is making, thus acting as proxy-logger. The measurement and logging may require a handshake procedure, providing confirmation for logging, considering, for example, sample set or filtered-sample set (log on confirmation procedure).

MLRD could identify an event and send a COMMAND/NOTIFICATION to other MLRD to trigger measurement and/or logging and/or reporting. This COMMAND/NOTIFICATION may contain explicit instructions e.g. what and how to measure, the time(moment) of the event and/or the kind/classification of event. Furthermore, activation period, validity of requested measurements/logging/reporting could be further content of the COMMAND/NOTIFICATION. The signalling procedure of the COMMAND/NOTIFICATION should include a confirmation of execution etc., and fallback options, if COMMAND/NOTIFICATION was not received and/or certain actions requested could not be successfully executed.

Reporting

MLRD reports can be sent regularly, continuously, on demand, repeatedly, according to a schedule, at certain times, proactively, autonomously, automatically. MLRD reporting can be orchestrated by higher network entities, events or situation, or be triggered by parameter threshold or certain events (e.g. a drone should send connection and flight related report to the network after an accident).

When a link failure is detected by MLRDS at both ends of a link, one or both ends should provide a “before and while” link failure report to the other end automatically or on request after link/connection re-establishment.

Where and if available, the MLRD reports via an auxiliary measurement/reporting channel, a dedicated physical/logical reporting channel or a dedicated inter-MNO/inter-PLMN physical/logical reporting channel. In accordance with the channel being used, the MLRD uses the appropriate signalling structure and format including all necessary encryption, compression, encoding and security measures. The transmission of the MLRD report can be timed, sequenced, ordered, requested, instructed, event-based/trigger-based/threshold-based (e.g. upon returning home) or programmed. The MLRD sends its report to at least one of a network entity, a communication partner, a next member of a defined group, a basestation, a mobile network operator (MNO), a server running over-the-top (see below), a higher authority (for example, a regulator), an original equipment manufacturer (OEM) or a service provider.

An MLRD can report all of the recorded data sets containing selected parameters or KPI dimensions, information or conclusions during a given period (time window) or a subset of the data set thereof.

MLRD reporting can be into one direction (e.g. UE to network or network to UE) or in both directions. Furthermore, a third entity or further devices or entities in the network can be the source and/or the destination of such reports. If the report destination is not defined, the report can be sent in any direction away from the reporting MLRD. The number of “away-from-me” hops can be counted and limited according to configuration including the avoidance of loops or “home returns”.

As an example, reporting from the network to the UE may enable the UE to detect certain conditions which are prone to degradation or failure and thus lead it to adapt or reconfigure its transmit and/or receive strategies such that it will better adapt to such circumstances. This may lead to software updates from the device OEM. A reporting from the UE to the network side may enable the network to correlate parameters and conditions such that useful insights and performance improvement configurations/strategies can be obtained.

The MLRD does not necessarily report to all the devices that request a report from it. A level of selection, priority, authority or hierarchy is thus observed by the MLRD wherein examples of requests from public safety, law enforcement, lawful interception or regulatory investigation may not be denied. Alternatively, incentive driven requests may be optionally addressed.

MLRD reporting should be accompanied by a traceable certification of validity. In this context, validity is used to mean the quality of the measured data for example with traceability to a measurement laboratory, test house, certification authority and so on.

Multiple MLRD operation may require orchestration wherein a central entity distributes or allocates measurement commands and tasks to a plurality of MLRDs. The central entity can be thought of as a conductor of an orchestra and is thus a node or a device in the active link—this could also include the core network “behind” the radio link. The node or device does not necessarily have to be a network entity nor an entity of a similar radio access technology (RAT). Inter-RAT MLRDs are thus considered including examples of Wi-Fi, Bluetooth, DECT and 3GPP LTE/NR and systems beyond the current 5G technology. Further examples include test and measurement (T&M) equipment that connect to one or more MLRD without necessarily being connected to the network.

Multiple MRLDs may operate without orchestration through virtue of their autonomous or semi-autonomous functions (educated behaviour) and, by using suitable markers, enable post-mortem analysis of measurement reports. In this context, educated behaviour is not limited to include: swarm intelligence algorithms; embedded incentive functions based on game theory; and post-training pattern observation classification (e.g. using a “DNA print” obtained from a manufacturer).

Example: Mimic or support behaviour of other MLRDs, partial or complete knowledge of what they are doing, on request or autonomously and/or inter-MLRD communication and/or with or without the orchestrator.

As described, the measurement report may be generated based on instructions or requests received, such that the device 10 and/or the device 20 may be configured for generating the measurement report based on a report instruction signal 28 received with the device.

The report instruction signal 28 may comprise information indicating a request to generate the measurement report and/or details with regard to the parameters to be measured and/or reported.

The device 10 and/or 20 may be configured for logging measurement results, i.e., to generate the log 24. The device may be configured for receiving a logging instruction signal 32 and for logging the measurement result based on the logging instruction. As discussed for the report instruction signal 28, the logging instruction signal 32 may comprise information about measurements to be taken and logged, i.e., a time interval, an accuracy and/or a type of measurement.

The logging instruction signal 32 may comprise instructions relating to at least one of a parameter to be logged, a parameter to be not logged, a time interval for which logging is performed, a number of measurements to be logged and fallback options for one or more thereof. For example, the device 10, 20 respectively, may comprise for a certain capability of performing measurements and/or logging being known to the network, for example, by explicitly transmitting a signal from the device to the network and/or by having knowledge in the network about the capability, e.g., knowing sensor capabilities based on a particular type of the device. From those capabilities, the network may select the measurements it needs or requests.

In connection with measuring parameters, e.g., related to receiver related signals, the MLRD may accordingly be instructed to provide for transmitter related signals, parameters and/or configurations, information that is known or at least accessible to the transmitter itself. Alternatively, or in addition such information may be requested from a central entity managing those parameters, e.g., a scheduling node such as a basestation or the like.

The device 10 and/or 20 may be configured for measuring parameters based on parameters indicated in the report instruction signal 28 and/or indicated in the logging instruction signal 32. Alternatively or in addition, the device may be configured for not measuring parameters for which the device comprises measurement capability based on the report instruction signal and/or the logging instruction signal. That is, with the report instruction signal 28 and/or the logging signal 32, a part of the capability of the device may be unselected or removed from the report and/or log.

The device 10 and/or 20 may operate in accordance with the received instructions. However, in case signal 28 and/or 32 requests for measurement reports exceeding the capability or willingness of the device, the device may skip the request or may operate in accordance with the request at least in parts. For example, the device may exclude requested measurements for which no sufficient capabilities (or energy or the like) are implemented or available but may provide for the rest of the requested information instead of refusing to follow the instructions.

The device 10 and/or the device 20 may be configured for determining an event related to the operation of the wireless communication network and for logging the measurement result based on the determined event. As discussed, the network may associate a plurality and variety of parameters to be related to the operation of the wireless communication network, i.e., the radio link parameter and the non-radio link parameter. A specific determined event, i.e., a trigger event, may be predefined by the network. In case such an event occurs, the device may operate accordingly for logging the measurement result and/or for transmitting a measurement report. The device 10 and/or the device 20 may be configured for including, into the measurement report 18, and associated with the radio link parameter, a non-radio link parameter as described. The device 10 and/or the device 20 may be configured for at least one of generating and sending a report instruction signal to a further device of the wireless communication network so as to indicate a request to measure and report at least one parameter, and/or generating and sending a logging instruction signal to a further device of the wireless communication network so as to indicate a request to log at least one parameter. That is, device 10 and/or device 20 may be configured for not only receiving the report instruction signal 28 and/or the logging instruction signal 32 but also for transmitting a respective signal. For example, device 10 and/or device 20 may determine, based on internal and/or external evaluation, that additional information and/or measurement is necessary for generating the report and/or that other devices have to assist device 10, 20, respectively. Accordingly, device 10 and/or 20 may request or instruct other devices to assist.

Although embodiments allow for just sending the measurement report, e.g., in plain text or the like, additional mechanisms may be implemented so as to allow for a high security of network operation. For example, devices described herein may be configured for including validity information into the measurement report 18. The validity information may indicate a validity of the measurement. The validity information may comprise the traceable certification of validity as described above. Alternatively or in addition, the validity may include information indicating a permission to transmit the report, information indicating the precision or accuracy obtained with the measurements that are reported or the like. Alternatively or in addition, the validity information may indicate at least one of a time instance or time period the measurement was made, a resolution or accuracy of the measurement, a hardware used for the measurement, a distance to the source of the parameter to be measured and/or a certificate indicating a trust worthiness of the device.

Including the validity information may provide for a measure of reliability of the measurement report and the information contained therein. This may allow, for example, to select information amongst different measurement reports for evaluation of the network status and/or measures to be taken. For example, when receiving reports that are generated with different distances to a disturbing source, the network may decide to select the closer one (e.g., facing a comparatively low amount of additional sources on the sensor) or the farer one (e.g., allowing for a far field scenario when compared to a near field scenario).

However, embodiments relate to a device that is configured for protecting a content of the measurement report. This may allow to avoid unallowed evaluation of the measurement report and/or unallowed generation of a measurement report. For example, block chain principles may be used to limit unauthorized access, tampering or other forms of falsification.

Embodiments relate to providing the measurement report to an entity of the wireless communication network. A device in accordance with embodiments may be configured for transmitting the measurement report to at least one of a network entity, a communication partner, a next member of a defined group, a basestation, a mobile network operator (MNO), a server running over-the-top, e.g. a supervising entity, a higher authority such as a regulator, an original equipment manufacturer (OEM) and/or a service provider. According to an embodiment, a device is configured for including, to the measurement report, an information indicating a number of hops the measurement report is requested to be forwarded at a maximum. This may allow to limit a network load caused by the measurement report on the one hand and/or to arrive as an outdated measurement report at the facilitated receipt.

Alternatively or in addition, device 10 and/or device 20 may be configured for transmitting the measurement report based on a respective request. Such a request may be evaluated by the device for a priority information contained in the request. The device may be configured for transmitting the measurement report when the priority information indicates a priority of at least a predefined priority level and for not transmitting the measurement report when the priority information indicates a priority of less than the predefined priority level. As described, the level of selection, priority, authority or hierarchy may be observed. For example, an MLRD that has low battery charge may decide to report only on very important (high priority) requests whilst to allow itself to not report on standard requests or the like. Any other priority or hierarchy or selection mechanisms may be employed, for example, different device classes. For example, devices having access to a power network or that are operated by low-priority users (e.g., when compared to emergency services or the like) may provide for a higher amount of reports than other devices.

According to an embodiment, device 10 and/or device 20 may be configured for measuring the radio link parameter for a plurality of cells of the wireless communication network, e.g., at least 46, at least 256 or at least 512 cells. Such a number of the plurality of cells may be adjustable, e.g., by a network authority.

According to an embodiment, device 10 and/or device 20 may be configured for selecting, from a plurality of measurement results, a subset of measurement results to be included. That is, the set 14 may be evaluated for a subset based on one or more criteria. The device may be configured to include a predefined number of measurement results being ranked according to a ranking criterion such as distance, time lapse, signal strength and reliability. That is, the predefined number of results that may be referred to as best results or best-fitting results may be selected. Alternatively or in addition, the device may select measurement results to be included into the measurement report that are in accordance with a predefined selection criteria such as a best result quality. For example, only results that are at least of a predefined quality threshold, e.g., accuracy, age or the like, are included. Both criteria may be combined, e.g., select the best measurement results but at most a number of 5, 10, 20 or the like.

The device 10 and/or the device 20 may be configured for measuring at least one parameter, the radio link parameter and/or the non-radio link parameter during a time interval with a first accuracy and during a different second time interval with a second accuracy. For example, the device may monitor a specific parameter and in case the parameter is lower than a predefined minimum value or higher than a predefined maximum value and/or vice versa, and/or if a different parameter implements a trigger event, the parameter may be measured with a higher accuracy. This allows to obtain a course information about the measured parameter in absence of the trigger event and, in case of the trigger event, a higher accuracy. Omitting some of the measurements for a lower accuracy may allow for executing different tasks and/or for saving computational effort and/or electric power.

Alternatively or in addition, the second time interval leading to the increased accuracy may be started upon request being associated with the wireless communication network. In connection with associating a parameter with the operation of the wireless communication network, embodiments enlarge the known scheme by allowing the network, e.g., a centralized node or the like, to associate parameters, a non-link parameter with the operation of the wireless network.

In other words, embodiments allow for measurement and logging in combination.

In known concepts, the number of neighbouring cells to be logged is limited by a fixed upper limit per frequency for each category below. The UE should log the measurement results for the neighbouring cells, if available, up to (examples):
6 for intra-frequency neighbouring cells;
3 for inter-frequency neighbouring cells;
3 for NR (if non-serving) neighbouring cells;
32 for WLAN APs;
32 for Bluetooth Beacons.

Embodiments allow to record the “unexpected” for post mortem (e.g., with regards to degrading of the link) processing or analysis and allow or prepare for configurable recording. Configurable can include standardized or implementation specific.

The numbers 3 and 6 listed above seem to be too small for future deployments and the specification is therefore inflexible regarding configuration.

Furthermore, e.g. in a factory environment with UDN many cells are visible, as well in macro scenarios where even without MMIMO 10 or more cells are visible. Beamforming can substantially extend interference range and therefore more cells should be monitored.

Furthermore, we should consider UEs on drones which can observe potentially hundreds of gNBs at the same time.

Embodiments relate to
A value being adjustable and beyond around 64+ to 256/512 cells.
If number is limited, measurement can be performed on the k strongest cells (strongest can be with the meaning of total band (average), subband, particular beams SSB, CSI-RS etc.)
   An MLRD could measure and log specific values with “adjustable sampling density (temporal/frequency/spatial))” or “maximum hold” depending on, for example, a ranked order of neighbouring cells.
Furthermore, selection of values to be logged and their combination can be a function of reasoning of “unusual” events, anomaly detection.
Let us consider a clever way of formulating a causal phrase which may go into a standard

Embodiments provide for an MLRD having a temporal resolution for observation and logging that includes sub-second scale of frame/slot/symbol, FFT-sampling and guard time (e.g. TDD switching interval).

Embodiments also allow for obtaining measurement, logging and reporting in combination.

In known concepts, the logging configuration for event-based and periodic DL pilot strength logged measurements can be configured independently. But only one type of event can be configured to the UE, embodiments allow for a combination of events.

The configuration and triggering of measurement, logging and reporting can be extended to an event or a combination of events in a causal or non-causal sequence. For example, due to an excessive jitter of packet delivery, the throughput is varying or reduced below a given threshold and the DL RSRP, DL RSRQ and the SINR of the DL pilot are degraded below a required performance level (operational window etc.).

When a logging area is configured according to a known concept, logged MDT measurements are performed as long as the UE is within this logging area. If a logging area is configured, logged MDT measurements are performed as long as the RPLMN is part of the MDT PLMN list. When the UE is not in the logging area or RPLMN is not part of the MDT PLMN list, the logging is suspended, i.e. the logged measurement configuration and the log are kept but measurement results are not logged.

According to embodiments, measurements could be logged but are not automatically reported. Alternatively, measurements are logged with a different sampling density (time/frequency/space).

A roaming PLMN according to an embodiment can restrict an MLRD's configuration of measurement logging and reporting.

Devices 10 and 20 have been described in connection with an MLRD. As discussed, such measurement may be performed autonomously or by a decision made by the respective device and/or responsive to a trigger event. Optionally, the trigger even may be configured by a different device and/or a so-called orchestrated measurement may be performed. In such a measurement, a network node or a distributed collection of nodes may decide about parameters and/or information to be collected within the network. Such a device may instruct or request other devices such as MLRDs to assist with measurements and to report their measurements. Such a requesting device may select which device is requested for performing which kind of measurements. Alternatively or in addition, such a selection may be performed groupwise, e.g., based on a device type being requested, an operator operating the device and/or capability information provided by the device to the network implicitly or explicitly. Alternatively or in addition to an individual or groupwise request, a global request may be transmitted.

Wherein some embodiments are described so as to provide information to any node or entity in the network to optimise operation of the same, embodiments are not limited hereto but also allow to enhance a point-to-point communication in which a link between a transmitter/transceiver is used to transmit a signal to a receiver/transceiver providing for a kind of feedback about the link to allow closed loop communication. E.g., the receiver reports, directly or indirectly back to the transmitter. For such communication, embodiments according to the first recognition and/or the second recognition may relate to monitoring and/or logging to happen at the two ends of the link, i.e., double-ended or two-ended monitoring and logging.

That is, receiver related signals or parameters and/or transmitter related signal, parameters and/or configurations may be logged and/or provided to enhance also an end-to-end communication or at least a hop thereof, e.g., when using relays which is described below. For example, a receiving node may inform a transmitting node to enhance its communication and/or a transmitting node may inform a receiving node to enhance its reception. Such information may be measured, reported and/or logged as described, e.g., using timestamps, locations and/or other suitable associated information.

In view of the mentioned option to use a multi-hop communication as well as a single-hop communication, it is noted that as a such link one may understand a direct communication between two nodes, such as a transmitter and a receiver and/or between two transceivers. However, it is possible to use a kind of relay for such a link which may use one or more mechanisms for relaying such as amplify and forward (AF) and/or decode and forward (DF). That is, it is possible that a relay changes, e.g., a polarisation, a frequency range, a centre frequency, a coding or the like between a first part of the link and a second part of the link whilst it may also keep one or more properties unchanged. In such a case, especially when changing one or more parameters, a link incorporating a relay such as transmitter/transceiver→relay; relay→relay; and/or relay→receiver/transceiver may be considered as an own link having own parameters and/or conditions; wherein in view of the presented embodiments such multiple hops may also be aggregated to a single or at least a reduced number of links. That is, if an end to end link is comprised of several partial links, then two-ended monitoring and logging can be performed between any link which makes up a complete chain i.e. an end-to-end communication link. Relays may, thus, also report their radio link parameters and/or other parameters described herein and/or may make use thereof.

Whilst measuring or determining the radio link parameter may, in principle and in accordance with embodiments be performed at different locations in the network, e.g., at a node taking part in the communication (link) or not, some of the embodiments described herein relate to measuring or determining a radio link parameter at an end of the communication link. Such an end of a radio communication link may be implemented, for example, by a transmitter/transceiver, a relay implementing, e.g., both a receiver and a transmitter, and/or by a receiver/transceiver. Measurements, determinations of the radio link parameter(s) may, in accordance with embodiments be provided at one end only or at more than one end. For example, at two (of at least two) ends, e.g., at a transmitting node and a receiving node. That is, the related measurements/logging can be between a transmitter and a receiver at the one end of the wireless communication link between the two nodes, e.g. gNB and UE, or between the first transmitter and/or the first receiver on the one end of the wireless communication link and the second transmitter and/or the second receiver on the other end of the wireless communication link. In particular, when considering a possible multi-hop strategy, more than two ends may be used, providing for a multi-ended communication and according to embodiments a multi-ended monitoring logging and/or reporting. Alternatively, or in addition, the “two ends” referred to beforehand maybe at any position of such a multi-hop communication chain. Such a network may analyse a radio communication link associated with the radio link parameter at at least two ends of the radio communication link.

Some wireless communication networks in accordance with embodiments may be operated in a coordinated or predetermined manner in view of multi-hop chains to organised when connecting to devices with each other via a multi-hop connection. However, some wireless communication networks may operate according to a self-organising manner such that the network itself or controlling entities might be unaware of a specific chain or route until the link is established. In both cases one or more multi-hop links may comprise zero, one or more than one parts, hops that might be considered as weak, i.e., they may provide for low quality, reliability, availability or other wanted behaviours, i.e., they are deemed or considered to show a low amount of performance or a performance below a certain performance threshold which may be equivalent to show deviations or errors above s corresponding threshold. However, the wireless communication network may have knowledge or some kind of suspicion or hints about weak links or parts of a weak link and may consider those parts as more relevant than others, e.g., strong links.

For example, a weak part may be arranged between Relay Node R and Relay Node S. In view of this example, due to the self-organizing nature of the network, the internal route between the two ends of an end-to-end communication (incorporating the part via Relay Node R and Relay Node S) is not known until after the link has been made. In some connections, such a weak (partial) link (e.g., between Relay Node R and Relay Node S) might be used while in other connections/links, it might not. Also, even when the two ends of the end-to-end connection are the same, due to the self-organization or a variation in the organisation of the network, the “weak link” might not always be used, i.e., be used only in some cases.

Embodiments allow to avoid unnecessary or less relevant measuring, recording and reporting of all (potentially useless or less relevant) network data, e.g., data that might not include the “weak link”. For example, such a network may provide signalling means to indicate that measuring, logging and reporting is requested to be activated for a specific link (portion). Such an example may be transferred to other reasons leading to interest to measure a specific link or portion thereof without limitation. Such a signalling may be included, for example, in a header of a signal to be transported, in other parts of the signal or in a signal to be transmitted over different channels. It may allow to indicate, that there is a request to measure the indicated portion of the link, e.g., having a meaning similar to “If the signal is routed along a route involving the link between Relay Node R and Relay Node S, then activate measurement, determination, logging and/or reporting, wherein any number and/or any details about the link may be signalled. Whilst this may allow to avoid measurement in case such an indicated portion is not used, it may also allow to obtain information of interest. Whilst the description has ben made to use a positive list indicating links of interest, alternatively or in addition a negative list may be signalled, e.g., indicating links or portions thereof for which measurements may be skipped when usually performing measurements.

That is, a link or a part thereof may be subject to measurement or evaluation upon request, e.g., when considering the part as being weak or when aiming to check or evaluate the part based on other reasons. To support this, log files for the “weak link” part of the chain may be transferred/relayed/forwarded/returned to the respective analysing network entity. That is, embodiments provide for a wireless communication network being configured for signalling that at least a portion of a link is of interest, e.g., the portion being considered to be weak, and to selectively provide for measurement or determining of the radio link parameter and/or other parameters based on the signalling, e.g., when the indicated portion is actually used or enabled. The network may be adapted to provide and evaluate a respective log or measurement report to an analysing unit. The report or associated data may be measured or obtained by a node forming an end or intermediate end of the link or a node being outside the link as described.

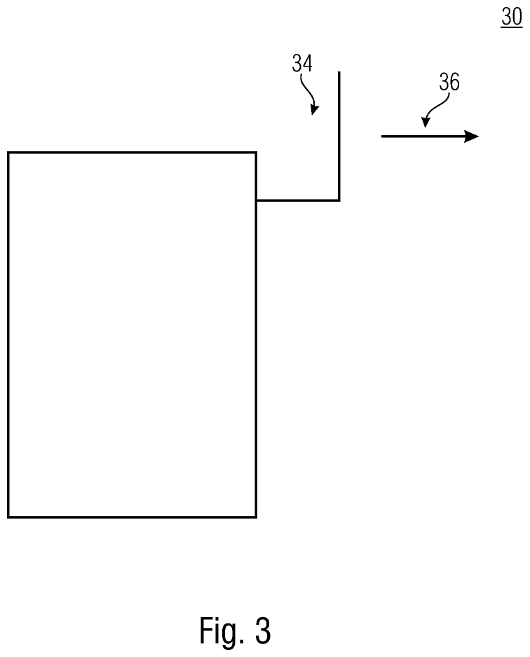

FIG. 3 shows a schematic block diagram of a device configured for operating in a wireless communication network. The device 30 is configured for instructing a measuring device such as device 10 and/or 20 of the wireless communication network. Device 30 may instruct device 10 and/or 20 for transmitting a measurement report comprising a measurement result comprising information indicating a radio link parameter associated with the operation of the wireless communication network. For example, the device 30 may comprise a wired, advantageously wireless, interface 34 and may be configured for transmitting a request signal 36, e.g., the report instruction signal 28 and/or the logging instruction 32. The request signal 36 may be a wired or wireless signal. For example, a wireless signal may directly be transmitted as the report instruction signal 28 and/or the logging instruction signal 32. Alternatively, the request signal 36 may be indirectly transmitted to a node that converts or re-transmits the request signal 36. Alternatively, the request signal 36 may be transmitted via wired interface towards a node that causes a wireless report instruction signal or logging instruction signal to be transmitted in the network. According to an embodiment, the wireless link to be monitored with the measurement result is a link of the device 30. Alternatively or in addition, the wireless link to be monitored is a link of the measuring device.

As described, device 10 and/or 20 may be configured for requesting a measurement report from another device. Such an implementation may arrive at the device 30 such that device 30 may also be considered as an embodiment of device 10 and/or 20. The device 30 may also be adapted to preform measurements as described in connection with the device 10 and/or the device 20 such that device 30 may also be an MLRD.

As discussed, the link to be monitored may be, in view of the measuring device, within-link, opposing-link and/or outside-of-link.

According to an embodiment, device 30 is configured for evaluating the measurement report for the radio link parameter being reported and for a non-link parameter associated with the radio link parameter and/or the operation of the wireless communication network. Device 30 may be configured to determine a reason being related to the non-link parameter that caused a degrading of the wireless link being indicated by the radio link parameter. That is, device 30 and/or a device connected hereto may be configured for determining a root cause for degrading operation of the wireless communication network.

According to an embodiment, the device 30 is configured for instructing a plurality of measurement devices to the four measurements and for transmitting measurement reports, so as to orchestrate distributed measurements. As discussed, at different locations and/or based on different capabilities different devices may be instructed differently.

According to an embodiment, the device 30 is a basestation of the wireless communication network. The MLRD 10 and/or 20 may be of a same or different type, i.e., a basestation, a UE, e.g., a flying UE such as a drone and/or a different entity.

Device 30 may be configured for instructing the measuring device of the wireless communication network to measure, from a plurality of parameters, a set of parameters, e.g., a selection from the parameters to be monitored in the network and/or of the capabilities of the device. The set of parameters may comprise at least one parameter, the plurality of parameters including the radio link parameter, wherein the set of parameters is at least one of predefined, defined dynamically and/or selected individually. As described, the measurement report may be requested so as to comprise a parameter different from the radio link parameter and, optionally, being generated without the radio link parameter.

According to an embodiment, a wireless communication network comprises at least one of the devices 10 and/or 20, wherein a plurality of devices 10 and/or 20 or a device 10 and a device 20 may be present. Further, the wireless communication network comprises at least a device 30. The wireless communication network may be configured to perform a root cause analysis using the measurement report to analyse a cause for a link degrading event and/or to reconfigure the network to avoid or at least partly compensate for a link degrading event.

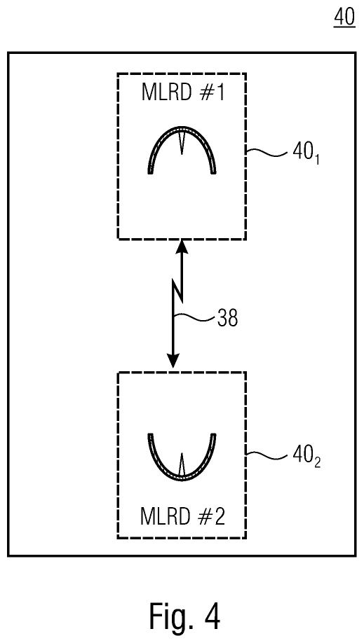

FIG. 4 shows a schematic block diagram of a wireless communication network 40 according to an embodiment. The wireless communication network 40 comprises two MLRDs 40₁ and 40₂ each of which may be in accordance with the description provided for device 10, 20 and/or 30, whilst devices 40₁ and 40₂ are adapted to measure, as described in connection with the devices 10 and 20.

In other words, FIG. 4 shows a generic example of two measurement-logging-and-reporting devices being used in a synchronized and orchestrated manner. Devices 40₁ and 40₂ maintain a radio link 38. The devices 40₁ and 40₂ both may observe, determine and/or evaluate the link 38 and report about a respective radio link parameter.

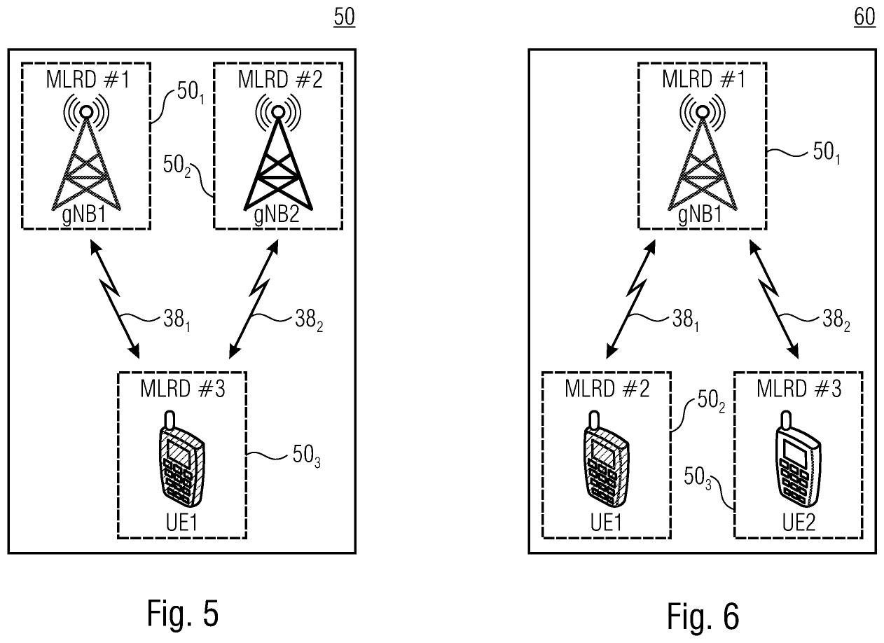

FIG. 5 shows a schematic block diagram of a wireless communication network 50 in accordance with an embodiment. At least three devices 50₁ and 50₂ and 50₃ are present in the wireless communication network 50. For example, each of the devices 50₁ and 50₂ and 50₃ may be implemented as device 10, device 20 and/or device 30 as described, for example, in connection with FIG. 4. That is, a device 50 may correspond to a device 40. By way of example, devices 50₁ to 50₂ are implemented as gNB but also perform the functionality of an MLRD. Device 50₃ may be implemented as a mobile device and/or a UE and operates as a third MLRD in the wireless communication network 50. This does not preclude additional devices in the network and/or cell. Device 50₃ may evaluate and report about two links 38₁ and 38₂ it maintains with devices 50₁ and 50₂, respectively.

In other words, FIG. 5 shows an example of communication between two basestations and a single UE in which each network entity is an MLRD. The active communication links 38₁ and 38₂ are observed by the MLRDs. Optionally, a link may be maintained or operated between devices 50₁ and 50₂. Such a link may be monitored with device 50₁, 50₂ and/or 50₃.

FIG. 6 shows a schematic block diagram of a wireless communication network 60 in which a device 50₁ operating as gNB maintains the links 38₁ and 38₂ with two different devices 50₂ and 50₃ both being adapted as UE.

That is, FIG. 6 shows an example of communication between a single basestation and two UEs in which each network entity is an MLRD. The active communication links are observed by the MLRDs.

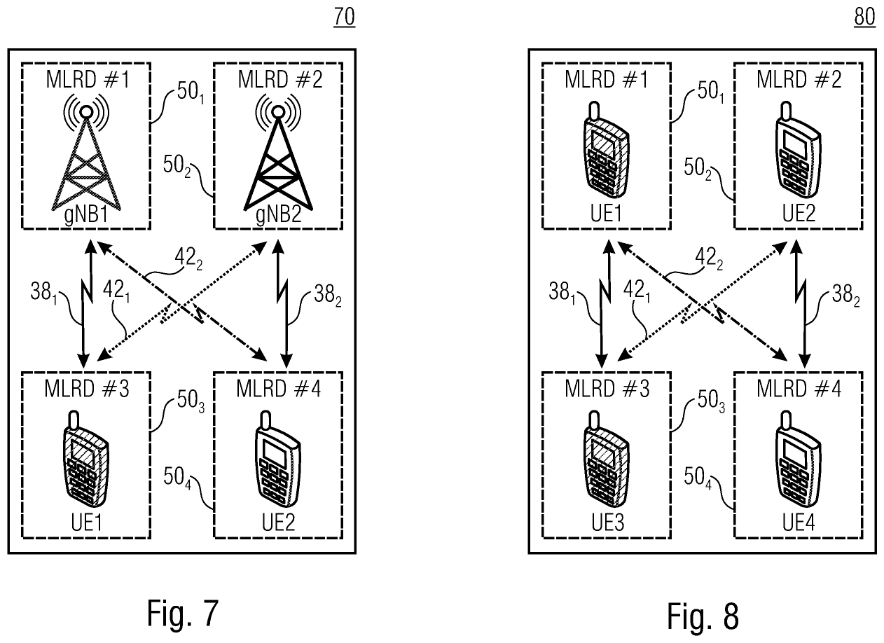

FIG. 7 shows a schematic block diagram of a wireless communication network 70 according to an embodiment. For example, at least four devices 50₁, 50₂, 50₃ and 50₄ are present in which devices 50₁ and 50₃ maintain a wireless or radio link 38₁ and devices 50₂ and 50₄ communicate via link 38₂. Devices 50₁ and 50₂ may be adapted as gNBs whilst devices 50₃ and 50₄ may be adapted as UEs, all devices operating as MLRD. The links 38₁ and 38₂ may interfere with one another as indicated by interference 50₁ and 42₂. Such interference may also be evaluated by the MLRDs. For example, device 50₃ may perform at least a part of an analysis of the link 38₂ although being not involved in this link.

In other words, FIG. 7 shows an example of two communication links, each comprising one basestation and one UE. The communication links between these entities are shown as well as interference 42 between links, the so-called cross-link interference. Each network entity is an MLRD. Both active communication links and the cross-link interference may be observed by the MLRDs. As discussed, the MLRDs may observe or measure same or different parameters.

FIG. 8 shows a schematic block diagram of a wireless communication network 80 according to an embodiment. When compared to the wireless communication network 70, the wireless communication network comprises a number of at least two, at least three or at least four UEs. When compared to the wireless communication network 70, the devices 50₁ and 50₂ are implemented as UEs as well as UEs 50₃ and 50₄.

In other words, FIG. 8 shows an example of four UEs in which UE1 (50₁) and UE3 (50₃) and in which UE 2 (50₂) and UE 4 (50₄) form side link pairs. The communication between links between these entities may cause so-called cross-link interference. Each network entity is an MLRD. Both the active communication link and the cross-link interference may be observed by the MLRDs.

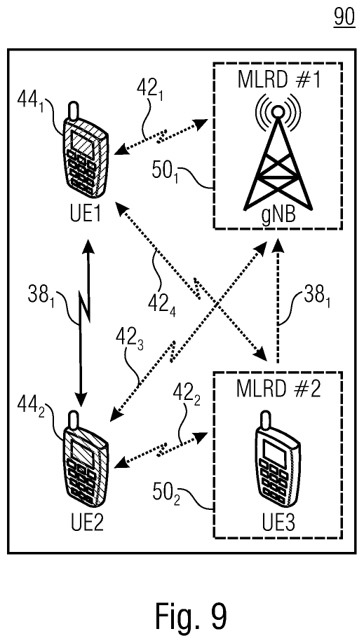

FIG. 9 shows a schematic block diagram of a wireless communication network 90 according to an embodiment. In the wireless communication network 90, device 50₁ being a basestation and device 50₂ being a UE are both operated as MLRD. Beside an exemplary uplink 38₁ from device 50₂ to device 50₁ a bidirectional sidelink 38₂ between mobile devices 44₁ and 44₂ is maintained in the wireless communication network. Interference 42₁, 42₂, 42₃ and 42₄ may be caused by any communication in the wireless communication network between any entity. For example, devices 42₁, and 42₂ may be implemented as a device 50.

However, an orchestrating entity decides to only use device 50₂ as an MLRD which may also be referred to as extended sensor or external sensor. A device of network 90 may the device be configured for receiving information indicating a measurement result from another device and for generating a log so as to comprise the received measurement result. That is, another device may be used as external sensor.

In other words, FIG. 9 shows an example in which UE1, UE2 and UE3 (devices 42₁, 42₂ and 40₂) may be used as extended sensors or antennas of a network. For example, device 50₂ provides for an MLR functionality to the network via the gNB. A side-link connection between UE1 and UE2, link 38₁ may be present. Potential interference paths are indicated by interference 44₁ to 44₄. This interference may be measured, logged and reported by the MLRD 1 and MLRD 2, device 50₁ and 50₁.

Both, the first recognition and the second recognition may relate to obtain information associated with a link. The embodiments described relate to measure a radio link parameter.

In connection with measuring a radio link parameter in accordance with embodiments and with regard to a strategy to use obtained information for interference management or mitigation, embodiments relate to determining interference associated with a receive beam pattern, e.g., by using this pattern at an MLRD. Further, the knowledge about the interference may be used for determining an impact of other devices on that interference. A wireless communication system according to an embodiment may use an MLRD for measuring/monitoring and/or logging/capturing at least one interference source parameter associated with a receive beam pattern. An interference source parameter may relate to or may indicate one or more of a direction of interference, a timing of the interference, a polarization of an interfering signal, a frequency of an interfering signal, information related to physical PRBs and/or bandwidth parts. The network may assess the interference impact of other network devices to be (potentially) used for interference management, i.e., an estimation of the impact a change in the behaviour of the other device may have on the interference. This may allow for selecting appropriate steps to be done by assuming the impact a different behaviour, schedule, transmit power or the like will have, if applied so as to select an action for this device that provides for the desired effect. For example, a root cause analysis may support such evaluation. Such a network may be configured for measuring an interference source parameter related to a receive beam pattern of a device, e.g., an MLRD, and for assessing, with the MLRD and/or other entities of the network, an interference impact of at least one other device on interference management for the receive beam pattern, e.g., to decide about a control of the other device for the interference management, e.g., yes/no, an amount of adaptation or the like.

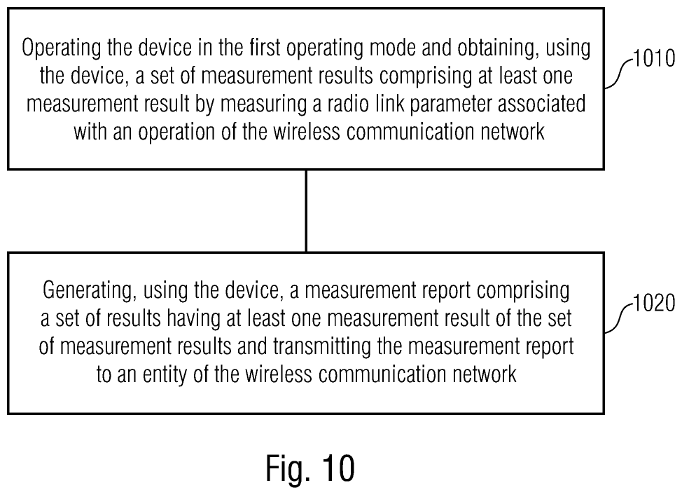

FIG. 10 shows a schematic flow chart of a method for operating a device in a bidirectional wireless communication network in a first operating mode in which the device is in a connected mode during a first time interval and in a second operating mode, in which the device at most performs passive communication during a second, different time interval. For example, method 1000 being illustrated may be used to operate device 10. Method 1000 comprises a step 1010 for operating the device in the first operating mode and obtaining, using the device, a set of measurement results comprising at least one measurement result by measuring or determining a radio link parameter associated with an operation of the wireless communication network. A step 1020 comprises generating, using the device, a measurement report comprising a set of results having at least one measurement result of the set of measurement results and transmitting the measurement report to an entity of the wireless communication network.

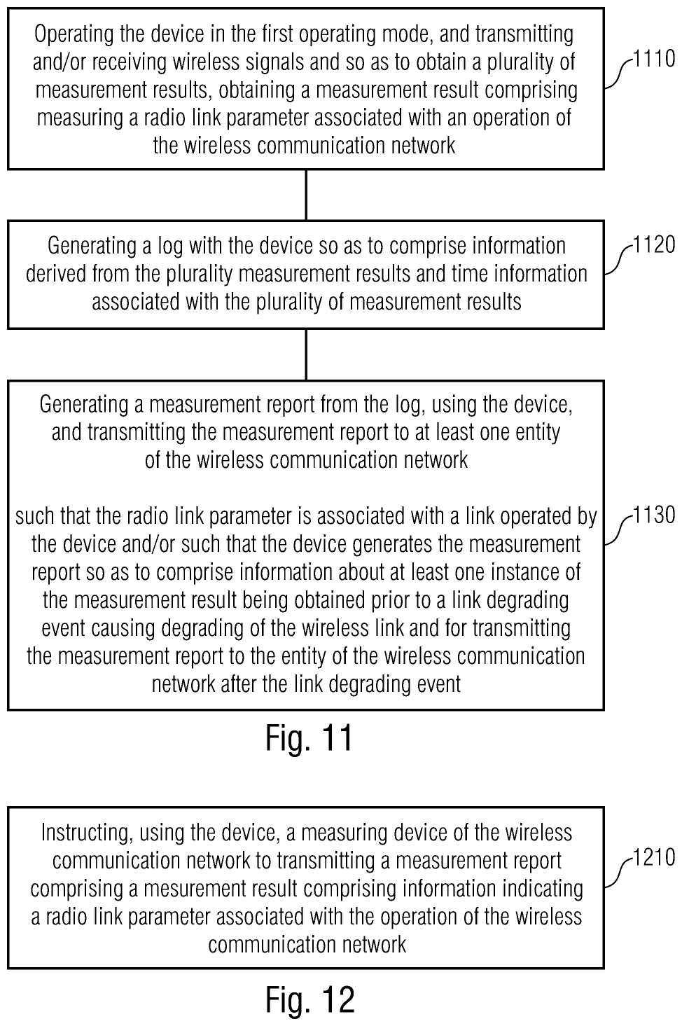

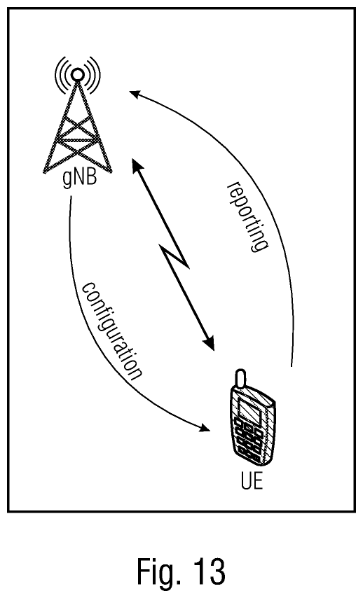

FIG. 11 shows a schematic flow chart of a method 1100 according to an embodiment. Method 1100 may be used for operating a device in a bidirectional wireless communication network in at least as first operating mode in which the device is in a connected mode, e.g., device 20. The method comprises a step 1110 comprising operating the device in the first operating mode, and transmitting and/or receiving a wireless signal and so as to obtain a plurality of measurement results, obtaining a measurement result comprising measuring or determining a radio link parameter associated with an operation of the wireless communication network.

A step 1120 comprises generating a log with the device so as to comprise information derived from the plurality of measurement results and time information associated with the plurality of measurement results. A step 1130 comprises generating a measurement report from the log, using the device, and transmitting the measurement report to at least one entity of the wireless communication network. Method 1100 is executed such that the radio link parameter is associated with a link operated by the device, association being performed by the wireless communication network and/or the operated device. Method 1100 is further executed such that the device generates the measurement report so as to comprise information about at least one instance of the measurement result being obtained prior to a link degrading event causing degrading of the wireless link and for transmitting the measurement report to the entity of the wireless communication network after the link degrading event as an alternative or an additional feature to the radio link parameter being associated with a link operated by the device.

FIG. 12 shows a schematic flow chart of a method 1200 for operating a device in a wireless communication network, for example, device 30. Method 1200 comprises a step 1210 comprising instructing, using the device, a measuring or determining device of the wireless communication network to transmitting a measurement report comprising a measurement result comprising information indicating a radio link parameter associated with the operation of the wireless communication network.

Embodiments allow for a plurality of advantages. For example, measurements are logged during active mode (currently they can be logged only in IDLE and INACTIVE state, or they can be collected and reported immediately in CONNECTED STATE). Embodiments allow to configure MLRDs to observe other communication links. Alternatively or in addition, multiple MLRDs can be used in an orchestrated, non-orchestrated, cooperative or collaborative manner. Alternatively or in addition, logging may be extended from observations from measurements of signals to logging instructions/requests/commands related to transmission and/or reception. Alternatively or in addition, logging may be extended from “being a response to a configuration” to “pseudo-permanent measurement and logging” towards keeping logs with higher sampling, density or precision on an “EVENT” and/or on an “COMMAND”. Alternatively or in addition, embodiments provide for solutions that will track and measure the appropriate parameters which will help to determine the root cause of link or beam failure.

Embodiments having been described above relate to measure and/or logging and/or reporting scenarios and/or a radio link parameter parameters related to a radio link parameter which is associated with a link operated by the device in a variety of scenarios. According to embodiment, such a scenario may also relate to interference, in particular, cross-link interference, CLI, and/or inter-cell interference, ICI.

To determine the interference and/or characteristics thereof, the victim may operate as an interference observing network device, i.e., an MLRD. However, according to embodiments, additional sources of information may be used to obtain knowledge about the interference. Such devices are described in the following and are referred to as Measuring, Logging and Reporting Devices, MLRD. Such devices may be used to observe the behaviour or condition of the network or a part thereof, e.g., in view of interference generated and may provide for such information to other devices. This may allow to provide an aggressor with information about an impact of its behaviour and/or a (potential) victim about information about present or future, expected/possible interference, e.g., a source thereof and/or locations that are suspected to provide a high or low amount of interference. In connection with such an implementation, interference, in particular cross-link interference may be examined in view of a single source of interference but also in view of a set of sources providing for a combined level or amount of interference for a possible victim.

Some aspects herein relate to determine, details about an occurring or possible interference in the network using e.g., by measurements. Aspects of the present invention may implement or incorporate aspects that are based on a transmitter avoiding causing interference to another entity and/or on adapting filters used for reception by use of a spatial receive filter so as to point a low sensitivity towards an interferer, which is also referred to herein as aggressor.

Embodiments described herein relate to both, devices that interfere with other devices while communicating. For a better understanding such devices may be referred to as interferer or aggressor. Embodiments further relate to devices that are interfered and possibly detect such a case that they are interfered or disturbed by other devices to which they may but possibly do not maintain (at least at present) a connection or data exchange. Such interfered devices may also be referred to as victims, e.g., of an aggressor.

Evaluating the Interference

An device or MLRD described herein may be used for detecting and/or mitigating interference, e.g., by adapting the beam pattern and/or measuring the network activity or condition, e.g., for controlling, estimating or reducing cross-link interference.

Embodiments are related to identifying, characterising or otherwise quantifying the interference so as to allow mechanism for mitigating interference to work precisely.

The present invention concerns the measurement and more importantly, the reporting of two forms of interference that affect the performance of wireless communication systems; inter-cell interference (ICI) and cross-link interference (CLI).

ICI is an inherent problem of cellular communication. It occurs when the adjacent cells use the same frequency resources, which affects signal quality of active users, especially at a cell-edge. This deterioration of UEs' SINR leads to a significant degradation in throughput and user experience. ICI affects both—TDD and FDD systems.

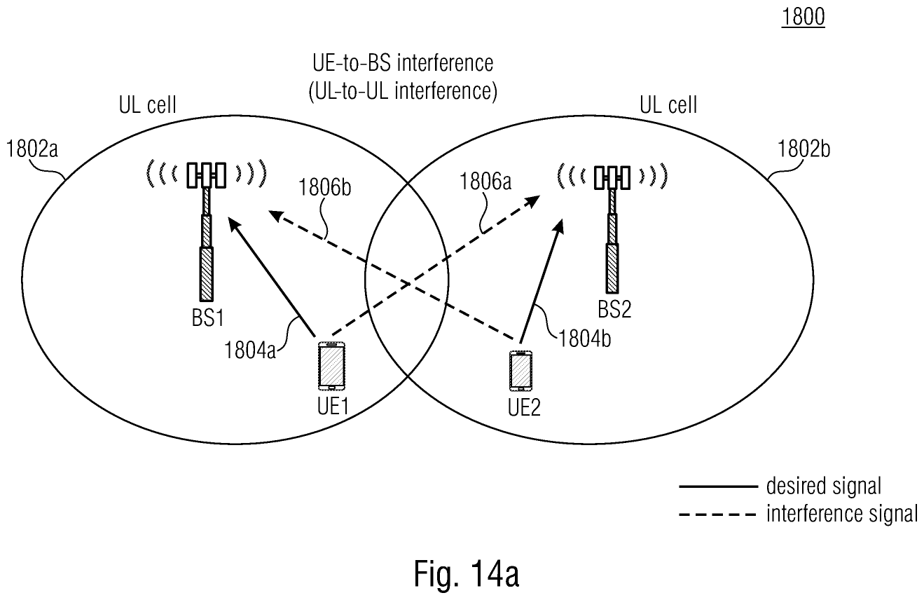

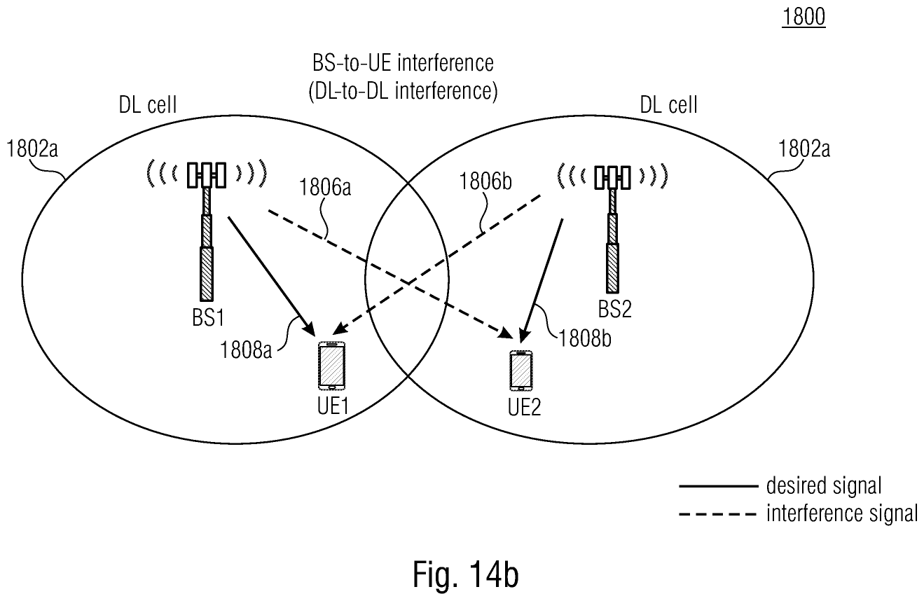

FIG. 14a/b depicts the cases of ICI in UL and DL slots in static TDD systems. Static TDD (S-TDD) requires the UL/DL subframe configurations of all cells using the same frequency band to be synchronized. ICI is a well-studied topic and various techniques to tackle ICI are a part of standardization since LTE/LTE-Advanced, such as ICI coordination (ICIC), enhanced ICIC (eICIC), and coordinated multipoint (CoMP).

FIG. 14a shows a schematic block diagram of a part of a wireless communication network 1800 that may form at least a part of embodiments described herein. As described in connection with the prior aspects, the wireless communication network 1800 may comprise one, two or more cells, e.g., cells 1802a, 1802b. In the illustrated scenario, both cells 1802a and 1802b may form an uplink, UL, cell. For example, UE 1 may transmit an uplink signal 1804a to its base station BS 1 and UE 2 may transmit an uplink signal 1804b to its base station BS 2. Those transmissions may form a desired signal but may also provide for unwanted interfering signals 1806a, 1806b, respectively. UE 1 being operated by BS 1 in cell 1802a may, thus, interfere BS 2 of a different cell and/or UE 2 operating in cell 1802b may interfere BS 1 of cell 1802a. The interfering signals 1806a and 1806b thus provide for an example for an inter-cell interference as a UE-to-BS interference occurring in UL slots, e.g., in an S-TDD system.

FIG. 14b shows a schematic block diagram of the wireless communication network 1800 during a downlink, DL, slot. There, a transmission of downlink signals 1808a of BS 1, of downlink signal 1808b of BS 2 respectively to the associated UEs UE 1 and UE 2 may cause interference 1806a and 1806b at the respective other UE. This may be referred to as BS-to-UE interference or as DL-to-DL interference.

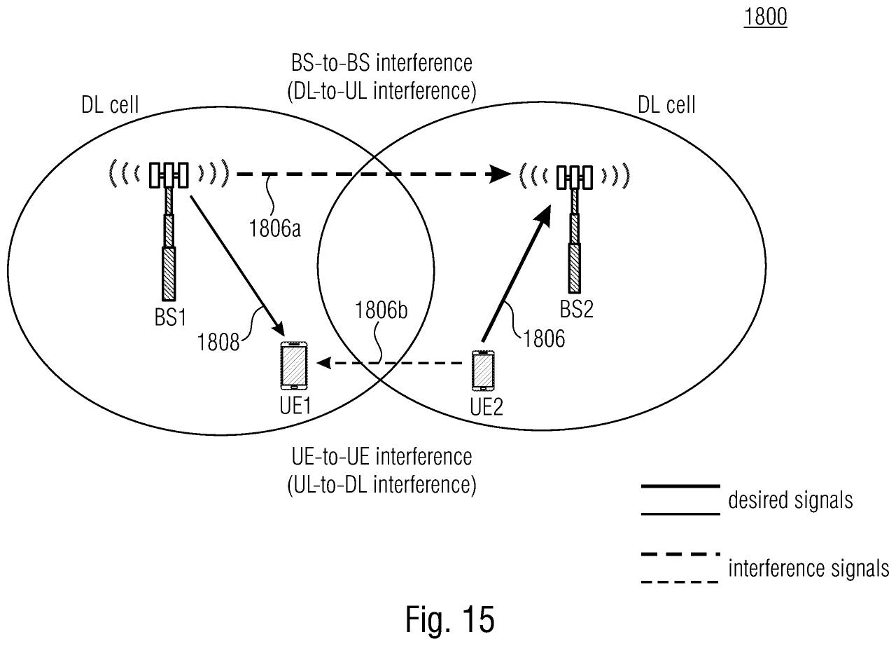

Cross-link interference occurs in dynamic TDD systems, where adjacent cells use different transmission directions, as can be seen in FIG. 15 showing examples of CLI [21]. Dynamic TDD systems improve spectrum utilization and enable flexible adaptation to varying traffic patterns. However, CLI remains of the major challenges. FIG. 15 shows a schematic diagram of a wireless communications network 1900 for representing a cross link interference (e.g., BS-to-BS interference/DL-to-UL interference and UE-to-UE interference/UL-to-DL interference.

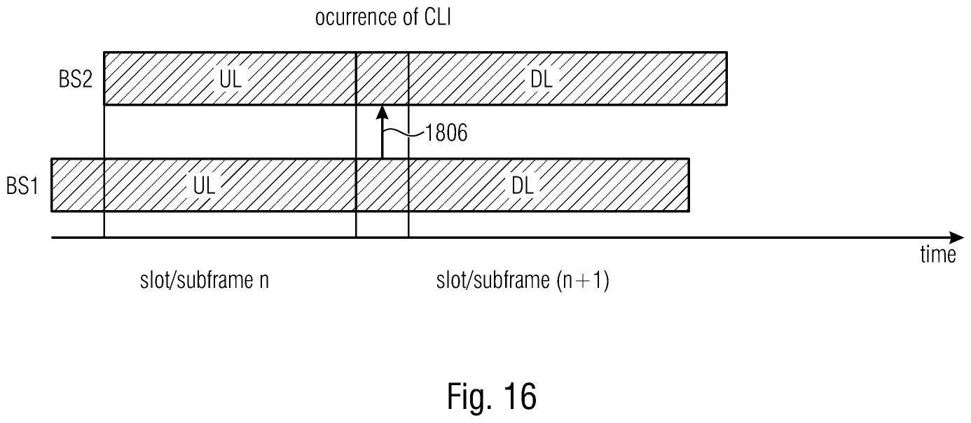

CLI can also occur in cases where adjacent cells are not synchronised and where a part of the frame uses the opposite direction, as depicted in FIG. 16 illustrating an example of occurrence of CLI in an asynchronous network, e.g., network 1800 or 1900. Although the transmission directions the same for the same subframe, CLI can occur if different transmission directions partially overlap.

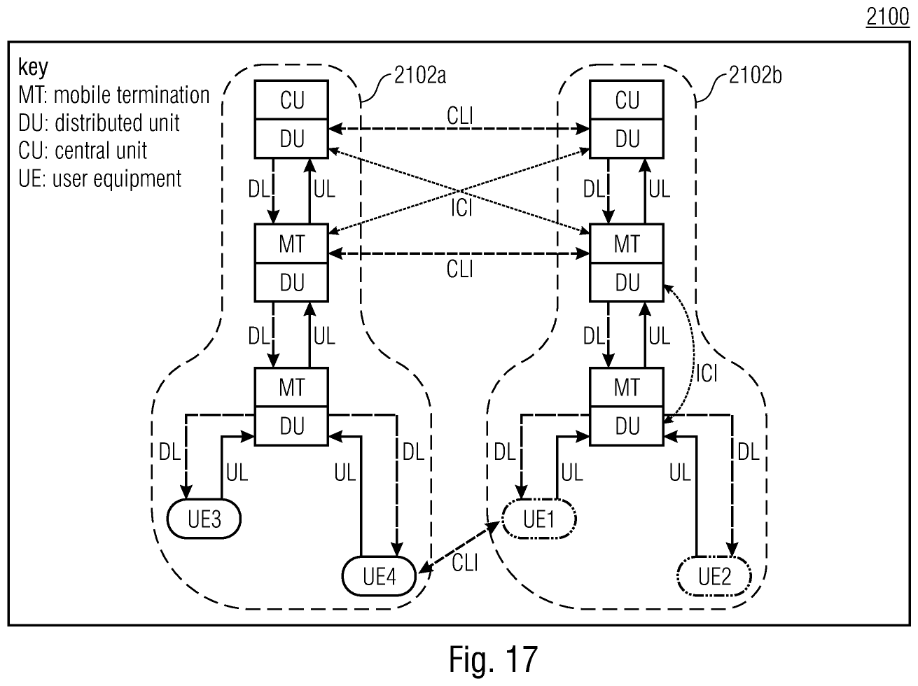

In integrated access and backhaul, IAB, networks, where traffic is carried over multiple hops, both ICI and CLI pose challenges. FIG. 17 depicts an IAB network 2100 comprising two (or more) adjacent, independent trees 2102a and 2100b. It should be noted that IAB network facilitates split gNB architecture with a central unit (CU) and distributed units (DUs).

A DU typically houses PHY, MAC and RLC layer, while the layers PDCP and above are located in the CU. This also means that the radio resource control (RRC) functions are located in the CU. An IAB node, on the other hand, consists of a mobile termination (MT) part, as well as a DU part. The MT connects to the CU or to another DU, whereas the DU consists of a base station part which can assign radio resources to MTs or UEs.

Returning toFehier! Verweisquelle konnte nicht gefunden werden. FIG. 17, in each of the trees 2102a and 2102b, there are three hops between a UE and a gNB CU. The cases of ICI are experienced in DL at each hop by the receiving UEs and MTs when adjacent DUs are transmitting. Similarly, on the UL, the receiving DUs will experience ICI, caused by the adjacent transmissions by the UEs and MTs. It should be noted that the UL ICI issues in IAB networks are more severe than in non-IAB networks, as the power levels by the IAB-MT are significantly higher than those of UEs. CLI in IAB networks also occurs due to the neighbouring cells using the opposite direction transmission/reception, as is described in more detail in the section “challenges”. In summary, in a multi-hop IAB network, the communication between a UE and CU/core network can be affected by ICI and CLI that can occur on any of the hops. Hence, CLI and ICI aspects are of particular importance due to the introduction of a) IAB nodes and b) flexible TDD structure.

With regards to (a), the inventors have identified that cases of CLI in IAB networks are not sufficiently covered by the current CLI framework. On the other hand, with regards to (b), the current CLI framework addresses the issues created by flexible TDD structures.

However, the framework relies on a backhaul-based coordination between the gNBs, which introduces delays. Furthermore, when flexible TDD is combined with the deployment of IAB nodes, the inventors have identified limitations in the current ICI and CLI frameworks. Furthermore, the current CLI (or ICI framework for that matter) does not address the case when adjacent nodes belong to different operators. Although in such cases, the power levels are smaller, the adjacent channel interference need to be considered. The current invention disclosure is concerned with these problems and corresponding solutions.

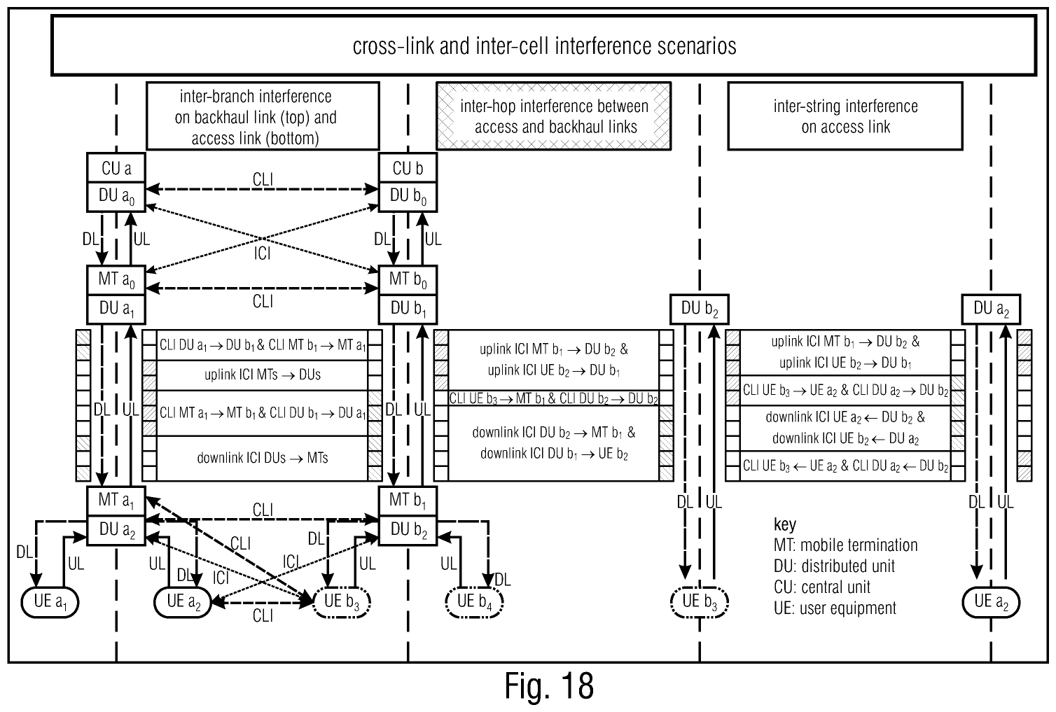

FIG. 18 is an extension of FIG. 17 which illustrates ICI and CLI in more detail. This is done for three example scenarios: “Inter-branch (or inter-tree) interference on backhaul and access link”; “Inter-hop interference between access and backhaul links”; and “Inter-string interference on access link”. The scenarios illustrate how interference could affect inter-branch, inter-hop and inter-string communication in either both the backhaul and access links (the first two cases) or in the access link only (the third case). FIG. 18 uses a frame-like structure (shown as a vertical stack of ten coloured squares) to illustrate how uplink and downlink collisions could occur between different network entities due to scheduling conflicts. For example, and with reference to the first scenario, the TDD frame patterns show correct scheduling between the downlink and uplink of DU a1 and MT a1 whereas in contrast however, the same scenario reveals collisions in the uplink and downlink frame patterns of MT a1 and DU b2. Similar effects are shown for the third scenario—UE b3 and DU a2. Details of the interference mechanism and the affected entities are presented in the text boxes between the frame patterns.

In other words, FIG. 18 shows an illustration of CLI and inter-cell interference in a multi-hop IAB network.

Challenges

In connection with the IAB nodes and CLI, there is an ongoing discussion in 3GPP RANI R1-2101878 [22] on the enhancements of the CLI framework, addressing some of the CLI cases that occur in IAB networks. Current CLI framework does not address all the use cases that exist in IAB networks.

Based on the discussion thus far in [22]] and other relevant references, the inventors have identified the following specific challenges of particular interest to consider in the invention:

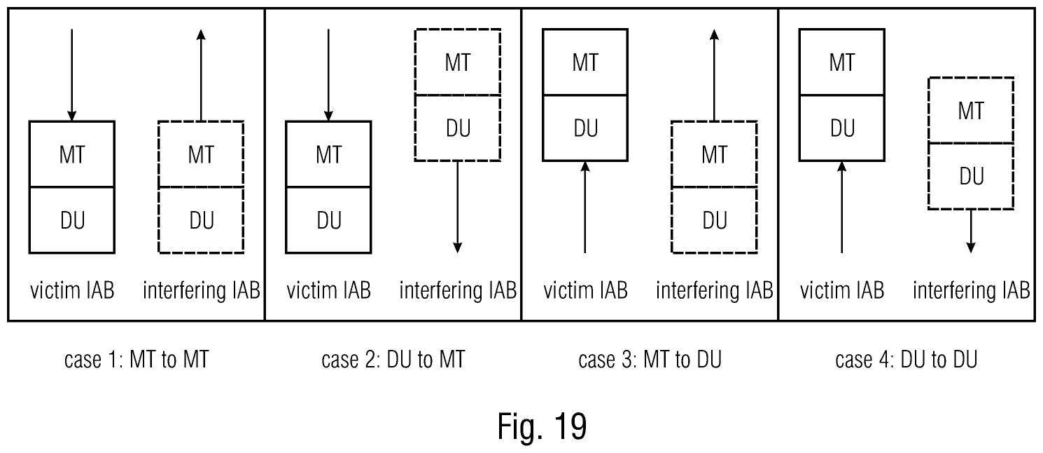

For representing different cases of CLI in an IAB network, reference is made to FIG. 19 showing a case 1 as an MT-to-MT CLI, a case 2 as an DU-to-MT interference, a case 3 as an MT-to-DU interference and a case 4 as a DU-to-DU interference as 3GPP-identified CLI interference cases in IAB networks.

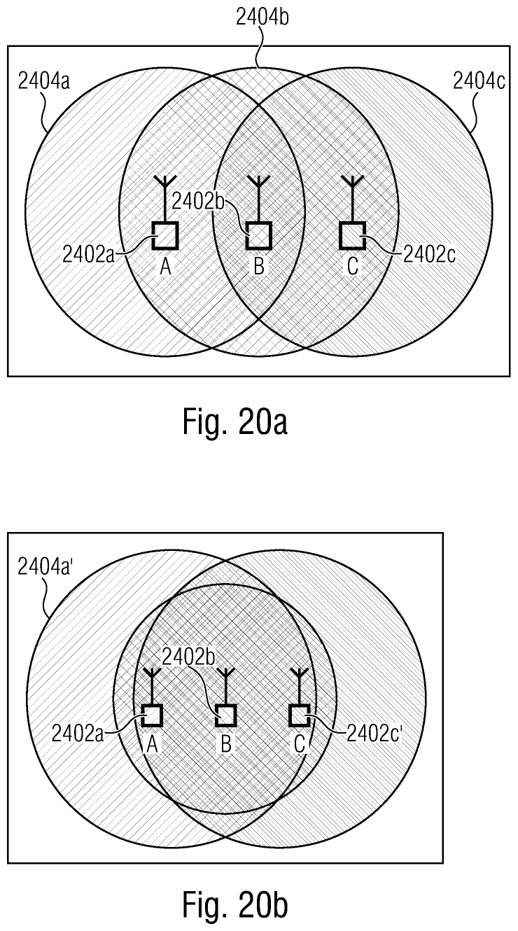

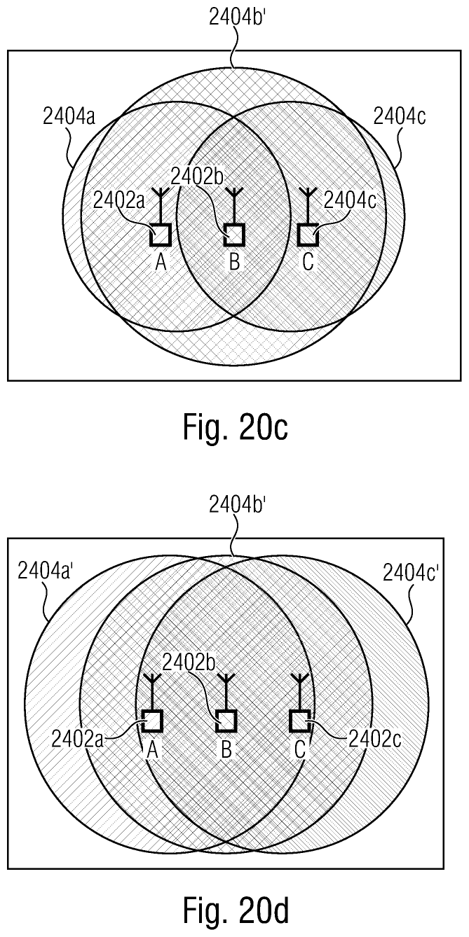

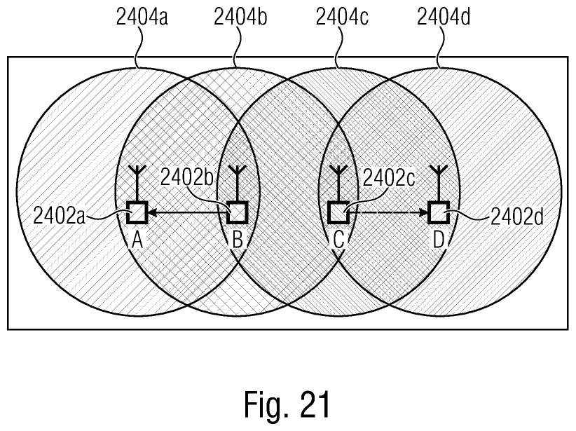

Challenges:
1. MT-MT interference (Case 1). Although current CLI framework (UE-UE case) can be used to mitigate CLI interference between different MTs, MTs have higher power and the interference effect has a potential to seriously degrade the downlink reception of the victim MT.
2. MT-DU interference (Case 3). Here, interfering MT is transmitting and victim DU is receiving. This case is analogous to a conventional case of UL UE interference on the base station. However, the power levels of IAB-MT are higher and thereby, the resulting interference.
3. DU-DU (Case 4) CLI framework currently does not address this case in the context of IAB network. Furthermore, while frame coordination could be performed between the neighbouring nodes using proprietary protocols, interference coordination between the nodes has to operate in multi-vendor deployments.
4. Classification of measurements/mitigation techniques based on the type of IAB-MT. Wide Area IAB-MT are characterised by requirements derived from Macro Cell and/or Micro Cell scenarios. Local Area IAB-MT are characterised by requirements derived from Pico Cell and/or Micro Cell scenarios.
5. Quantifying the measurement accuracy of CLI. In [23], it was pointed out that the CLI measurement accuracy of SRS RSRP could be degraded due to factors like network synchronisation error, unknown propagation delays between the IAB nodes, smaller CP duration in FR2, different timing alignment across nodes, large distance between child and parent node etc.
6. L2 vs L3 measurements/reporting—Current CLI measurements are L3 CLI measurements—they are longer-time scale measurements and are configured by and reported to the CU/gNB [24].
7. Differentiating between access and backhaul, as some interference cases affect access links more
8. Self-interference measurement, logging, reporting and mitigation. Self-interference occurs when a device operates simultaneously in Tx and Rx mode in the same or different carriers, sub-carriers, resource blocks or bandwidths parts running in different UL or DL slots, This is caused by reflections (from objects in the propagation environments and in-device/base station leakage). It is associated with, full-duplex operation and/or device malfunction.
   .
9. The so-called hidden terminal and exposed terminal problems (described below in connection with FIG. 20a-d and FIG. 21)

As outlined earlier, in inter-MNO environment, currently no mechanism can be assumed for the exchange of reference signal configurations and coordination of transmissions that can address some of the above-described cases.

Furthermore, some of the above challenges are not only related to IAB network, but also to UE the CLI framework, for example, Challenges 5 and 6 in the list above.

The performance of a wireless communication system (WCS) can be affected by the so-called hidden terminal (or node) problem and by the so-called exposed terminal (or node) problem. Since these problems are well-known—especially in the context of wireless local area networks (WLAN)—and as state-of-the-art and standardized solutions exist, the hidden terminal and exposed terminal problems are presented here together with the SOTA solution. As discussed already above, the inventors have identified certain problems which are not address by the current SOTA solutions described in this section. Potential solutions are thus presented in section “Solutions”.

The Hidden Terminal Problem

Although cellular networks do not typically operate in listen before talk, LBT, mode (except in the special case of NR-U), in dynamic TDD due to CLI and considering that not every gNB/IAB node is aware of scheduling decisions of other nodes, the associated challenges can be viewed similarly to the problems of hidden or exposed terminals.

In a WCS that provides communication between a number of terminals or nodes, using Carrier sense multiple access with collision detection (CSMA/CD), the hidden terminal problem occurs when a first node is visible to a second node but is not visible to at least a third node that communicates with the second node. This can occur in a WCS that does not provide the means for controlling transmissions from the different nodes.

To illustrate the problem, FIG. 20a shows three terminals 2402a (A), 2402b (B) and 2402c (C) and their coverage areas 2404a, 2404b, 2404c respectively (shown by overlapping circles with different shadings).

Here node B is in the coverage area of both nodes A and C. On the other hand, nodes A and C are out of range of one another and therefore are said to be hidden (from one another). Now suppose that nodes A and B have established connection and are transferring communication information between themselves and that during this communication, node C, which is not aware of the ongoing communication, attempts to establish a connection to node B. As the new transmissions from node C to node B could collide with the established transmissions between nodes A and B, the need to control or otherwise coordinate transmissions from multiple nodes is identified.

In other words, FIG. 20a shows a pictorial representation of the hidden terminal problem in which three terminals or nodes and their coverage areas are shown. These coverage areas reveal that even though both nodes A and C are visible to node B, they are hidden from one another.

Solution of the Hidden Terminal Problem

The solutions that address the hidden terminal problem are now discussed, as some of them can be considered how to be applied to address the challenges of CLI.

1. Increasing Transmitting Power

In order for a hidden node to become visible—and therefore for it no longer to be hidden—its coverage area needs to be extended. This can be achieved by increasing the transmission power of a “hidden” node which enables the non-hidden nodes to detect, or hear, the (previously) hidden node—see FIG. 20b. In the scenario shown in FIG. 20b, the transmission power and hence the coverage area of both nodes A and C are increased to coverage areas 2404a′, 2404c′ respectively whilst that of nodes B is left unchanged. The increased coverage of nodes A and C makes them visible to one other and they are therefore no longer hidden.

It should be noted that the hidden terminal problem is not however solved by increasing the transmission power and hence the coverage area of a non-hidden node (node B) only, see FIG. 20c where the transmission power and hence the coverage area of only node B is increased to coverage area 2404b′ whilst that of nodes A and C is left unchanged meaning that they remain hidden from one another.

If the transmission power of all nodes is increased—as shown in FIG. 20d—then the hidden terminal problem is also solved. However, as explained earlier in connection with FIG. 20b, when the coverage range of the non-hidden node (node B) is increased, so too is the chance of creating new hidden nodes (for example nodes D and E which are not shown in the figure). Since the new nodes D and E are in the extended coverage area of node B and could hence establish communication with node B, but are not in the coverage area of nodes A and C, then nodes A, C, D and E could be hidden from one another.

In practice, nodes A and C could be user equipment devices whereas node B could be a basestation or an access point. Increasing the transmission power at the latter is more likely to create problems for other users because it puts them in range of the access point and thus add new nodes to the network that now become hidden from other users.

2. Antenna Patterns

The radiation pattern of an antenna describes the way in which it spatially emits energy and, by reciprocity, the way in which it spatially collects energy. An antenna with a so-called directional pattern directs or collects energy in a given direction with preference to other directions. On the other hand, an antenna that radiates uniformly—albeit at least in one plane—is described to have an omni-directional pattern.

In the context of the hidden terminal problem, an antenna's directivity affects its visibility to other nodes. Therefore, devices which are equipped with directional antennas are more likely to create hidden nodes than those devices fitted with omni-directional antennas. In view of this, it would seem appropriate to favour omni-directional patterns over directional patterns. However, while coverage is improved—at least in the sense that this is provided more uniformly—the link distance that can be supported is easily reduced. A mechanism is therefore needed to solve the hidden terminal problem when created as the result of a directional pattern. Such a mechanism is provided by the present invention.

3. Obstacles

To some users, an otherwise omni-directional antenna pattern might be observed as being directional due to the presence of an obstacle, for example a structure such as a building, an office partition, a vehicle or a person. Therefore, and with similarity to the directional antenna pattern described earlier, obstacles can conceal the presence of a terminal from other terminals, thus creating a hidden terminal.

A potential solution to the problem of the hidden terminal created as the result of obstruction, is to move or remove the obstacle. For practical reasons however, this is not always possible. Alternatively, an increase of transmission power might also be effective if the losses introduced by the obstruction can be overcome. For building materials, such as stone, brick, concrete, steel and metalized glass, this might not be possible. An increase of transmission power can however create new hidden names as described in Section 1 explaining the effects of increasing the transmission power.

4. Moving the Node

A device that is otherwise hidden to certain devices could become visible (or unhidden) by moving the device to a new location so that it is in range and therefore visible to the other devices. Similarly, a device that is equipped with an antenna whose pattern is directional, could become visible to previously hidden devices by reorientating the device accordingly. Furthermore, a device that is equipped with an antenna whose pattern is reconfigurable, could adapt its antenna characteristics so that it is visible to other devices.

5. Protocol Enhancement

Software-based techniques can be used to implement polling or token passing strategies whereby a master (for example, an access point) dynamically polls client devices. These clients may only send data when invited by the master, thus eliminating the hidden node problem at the cost of increased latency and less maximum throughput.

A further protocol example is that of handshaking. In Wi-Fi standard IEEE 802.11, the medium access control (MAC) protocol is used together with request-to-send/clear-to-send (RTS/CTS) messaging. Here, client devices that wish to send data to the access point first transmit an RTS packet to the access point (AP) and, when the AP is ready to communicate with the client that sent the RTS packet, it then sends a CTS packet, thus allowing communication between the two devices. As the overhead for short packets can be quite large, handshaking is often not used, especially when the minimum size is configurable. In order for RTS/CTS to work efficiently, all stations have to be time-synchronized and the length of the data packets exchanged, have to match those indicated in the RTS/CTS.

The Exposed Terminal Problem

The exposed terminal or exposed node problem occurs in a WCS when one node is prevented from sending packets to other nodes because of (the risk of) co-channel interference with a neighbouring transmitter.

The exposed node problem is illustrated in FIG. 21 which comprises four devices 2402a-d with similar coverage areas 2404a-d that overlap with their closest neighbour(s). A first communication link is established between devices A and B in which the latter is transmitting while the former is receiving. At some time during the first communication, an attempt to establish a second communication between devices C and D is made. However, device C detects the transmission from device B and therefore does not activate its own transmission due to the risk of creating co-channel interference with the first communication even though receiving device D is out-of-range of transmitting device B (and, a link was to be made, receiving device A would be out-of-range of transmitting device C).

In other words, FIG. 21 shows a pictorial representation of the exposed terminal problem in which four devices form part of a wireless communication network. Due to the communication between one pair of devices—for example devices A and B—a second communication between devices C and D might not be prevented due to the risk of co-channel interference between devices B and C even though device B and D are out-of-range of one another.

Solution of the Exposed Terminal Problem

The IEEE 802.11 RTS/CTS mechanism discussed earlier helps to solve the problem of the exposed terminal but only if the nodes are synchronized and packet sizes and data rates are the same for both the transmitting nodes. When a node hears an RTS from a neighbouring node, but not the corresponding CTS, that node can deduce that it is an exposed node and is permitted to transmit to other neighbouring nodes. On the other hand, if the nodes are not synchronised (or if the packet sizes are different or the data rates are different) the problem may occur that the sender will not hear the CTS or the acknowledge (ACK) during the transmission of data from the second transmitting device. In cellular networks, power control is used to avoid the problem of the exposed terminal.

Standardization in 3GPP

Background of CLI Framework

In the current CLI framework in Release 16 [25], 2 metrics of CLI measurement exist:
RSRP (SRS selective) and
RSSI (integrated interference power)

RSRP relies on the same SCS between the aggressor and the victim. RSSI measurements can be done with any combinations of SCS of own BS and interfering link.

To mitigate CLI, gNBs can exchange and coordinate their intended TDD DL-UL configurations over Xn and F1 interfaces; and the victim UEs can be configured to perform CLI measurements. There are two types of CLI measurements:
SRS-RSRP measurement in which the UE measures SRS-RSRP over SRS resources of aggressor UE(s). The interferers' SRS configuration parameters include parameters, such as the number of symbols, comb structure, cyclic shifts of root Zadoff-Chu sequence etc.
CLI-RSSI measurement in which the UE measures the total received power observed over RSSI resources. RSSI measurements represent the linear average of the total received power (in [W]) observed only in certain OFDM symbols of measurement time resource(s), in the measurement bandwidth, over N number of resource blocks from all sources, including co-channel serving and non-serving cells, adjacent channel interference and thermal noise.

Layer 3 filtering applies to CLI measurement results, and both event triggered and periodic reporting are supported. According to [26}, Sec. 17.2:
CLI measurements are only applicable for RRC_CONNECTED intra-frequency [27], TS 38.215, Sections 5.1.19 and 5.1.20:]:
   when SRS-RSRP measurement resource is fully confined within BW of DL active BWP
   the requirements apply when the subcarrier spacing for SRS-RSRP measurement resource configuration is the same as the subcarrier spacing of the active DL BWP of serving cell.
when CLI-RSSI measurement resource is configured within active BWP
   the subcarrier spacing for CLI-RSSI measurement resource configuration can be same or different from the subcarrier spacing of active BWP. UE shall perform CLI-RSSI measurement with the SCS of the active BWP.

### DETAILS ON EMBODIMENTS

It is to be noted that, within this document, interference mitigation and interference management are used interchangeably.

As outlined in above, the current CLI framework for BS-BS interference is relying on a backhaul-based coordination between the gNBs to tackle CLI for gNBs and UEs alike. In addition to the delay on the backhaul between e.g. DUs and CUs to coordinate transmission/reception patterns, in an IAB network, there may be several hops between the reporting MT/DU and CU, which further increases the delay. Hence, there is a complexity and cost associated with the coordination-based mechanisms between adjacent cells. The complexity becomes even greater when adjacent cells belong to different MNOs. Hence, this invention proposes a 2-step interference management/mitigation framework, which enables UEs/IAB-MTs with specific capabilities to tackle interference on two levels:

Long-term interference which will be called strategic interference handling and short-term interference mitigation which will be called tactical interference handling. The naming relates to the time scales indicating that a strategic interference handling will allow the exemplary two interfering systems to coordinate the used radio resources such that a maximum number of independent scheduling decisions can be facilitated while at the same time remaining resource contention/collisions can be resolved by a reasonable amount of tactical (short-term) interference handling methods. The overall purpose of such two layered interference handling method is the intention to support distributed decision making as much as possible and resolving remaining interference issues locally if possible at lowest level between the interference source and the interference victim. This becomes in particular important for the CLI channel at the terminal/device side since device distribution and associated inter-device CLI is a-priori unknown and even if known after an initial observation may change over time due to device mobility and the independent scheduling decisions of different base stations.

Long-term interference mitigation is usually handled at layer 3 (L3) of the protocol stack according to mechanisms specified e.g. in 3GPP, where statistical averaging of measurement reports are performed. Long-term interference mitigation is, therefore, expected to operate on longer time-scales, in the order of seconds, minutes or longer. On the other hand, short-term interference mitigation is usually handled at layer 1 and 2 (L1/L2) of the protocol stack, and is expected to operate on time scales between a few to hundreds of milliseconds, or even microseconds, to sometimes even seconds.
Long-term interference mitigation (strategic) may be based on
   Reporting by the UE or IAB-MT to the gNB, which acts on the reported interference
   Observation/measurements of CLI by the UEs/devices/nodes including resulting statistics e.g. Interference temperature, periodicity of CLI events, spectral, temporal, or spatial signatures of interference sources.
Short-term interference mitigation (tactical) may include or be based on
   Enhanced LBT mechanisms
   Adaptation of receive spatial filters (antenna pattern adaption) or spectral filters (RF-filters)
   Spatial pre-emption

An example can be given with scheduling users onto the slots that overlap in direction (by different MNOs). If the users can tackle the interferences between themselves (i.e. tactically), they do. Otherwise, they report to their base station. In brief this means, as long as the capability of the device/node and/or the channel conditions allow for a local interference suppression method by the device/node itself it will do so, provided sufficient knowledge about the interference signal, which includes interference channel, interference source or structure of the interference. If local self-contained interference suppression is infeasible or doesn't result in the required interference suppression level, the interference source should be requested to mitigate interference by changing/adapting its transmission strategy. In order to facilitate such supporting action the device/node can either directly communicate with the interfering source and/or inform its own serving base station/communication partner about the interference source or other descriptive identifiers/parameters enabling identification of the identity of the interferer. Furthermore, the victim device/node can contact/communicate with the serving BS/communication partner of the interferer in order to request/trigger a change/adaptation of transmit strategy of the interferer. Also, if patterns causing interference can be recognised, shifting TDD structure can be also performed either by the victim's or interferer's BS.

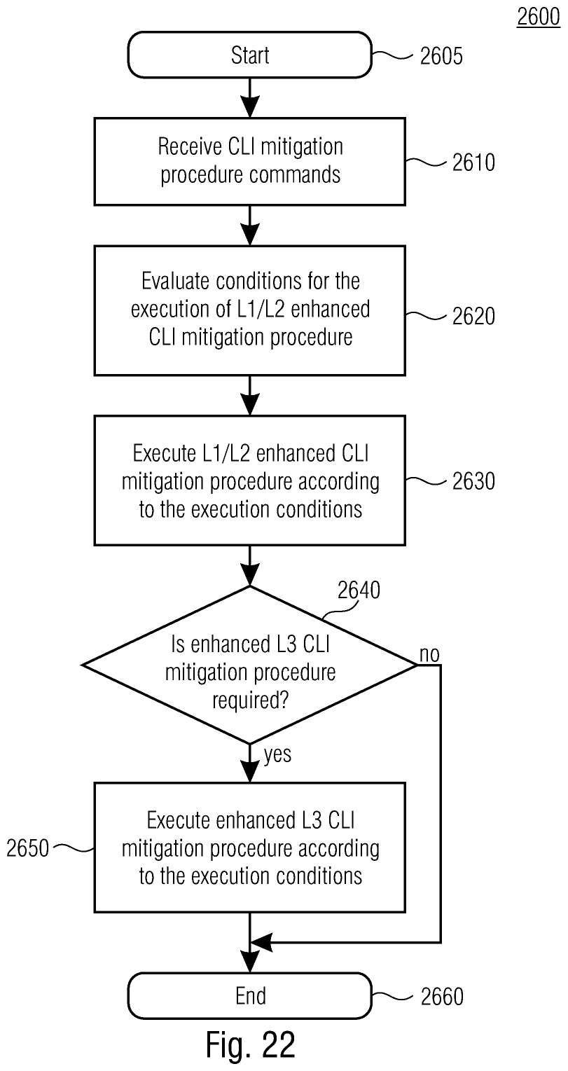

FIG. 22 shows a schematic flow chart of a method 2600 according to an embodiment. FIG. 22 provides a high-level overview of the enhanced procedure for CLI interference management procedure 2600 according to an embodiment, focusing on the UE/IAB-MT case. In the first step 2610 after a start 2605, the UE receives enhanced CLI mitigation commands. The commands include CLI measurement configuration and the execution conditions for the enhanced CLI mitigation procedure(s). The UE then evaluates the conditions for the execution of L1/L2 enhanced CLI mitigation procedure(s) in 2620. Alternatively, the UE can receive a notification signal, based on e.g. regular UE measurement reporting, that the conditions for triggering L1/L2 enhanced CLI management procedure(s) are met.

If, following the execution of L1/L2 CLI mitigation procedure(s) in 2630, conditions that warrant additional, enhanced L3 CLI mitigation procedure(s) still exists which is determined in 2640, the UE proceeds with their execution in 2650. Otherwise, the procedure is completed, 2660.

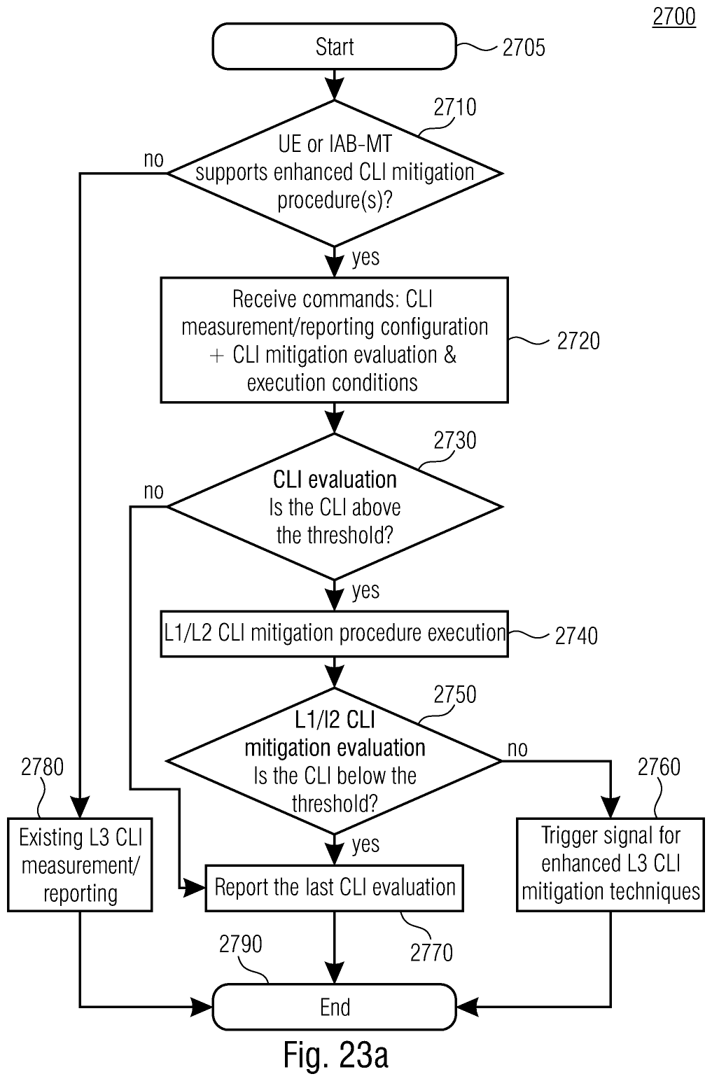

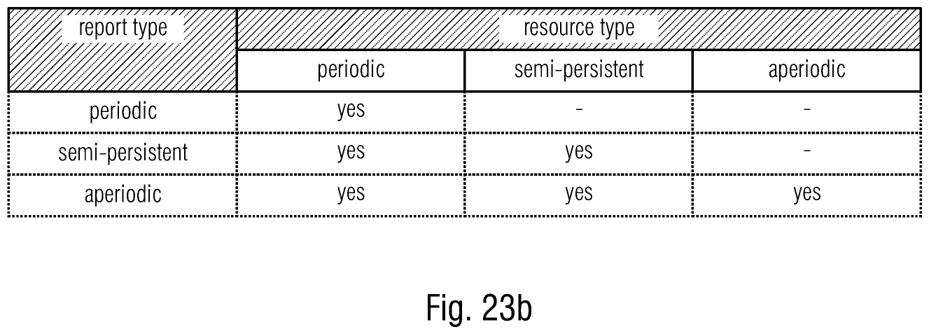

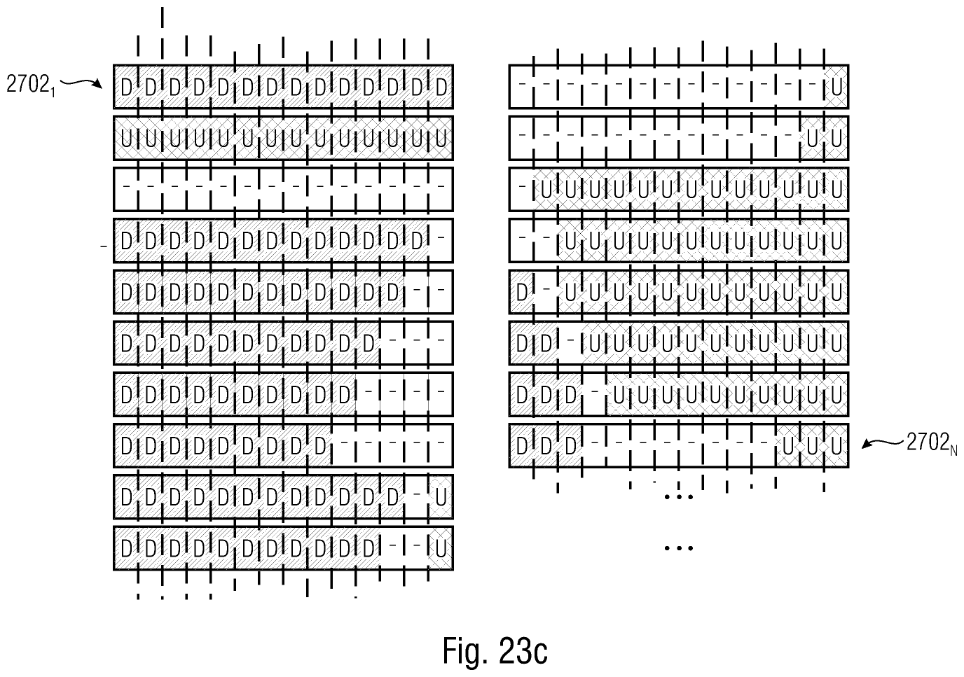

FIG. 23a shows a schematic flow chart of a method 2700 according to an embodiment and depicts a more detailed two-step CLI-mitigation approach, with the focus on the procedural aspects of a L1/L2 CLI mitigation mechanism. The approach envisages enhancing the current measurement configuration & reporting mechanism by defining and separating L1/L2 (short-term) and L3 CLI mitigation (long-term) measurement techniques.

At present, on the UE or IAB-MT side, CLI measurements rely on the existing measurement framework. The details of CLI measurement resource configuration are given in CLI measurement object MeasObjectCLI information element, configured by RRC [28], (38.331, v16.3.1, p. 449-450.). These measurement resources are configured by gNB and typically represent resources that can be potentially configured as UL resources in the neighbouring cells. Normally, inter-node signalling of dynamic TDD configurations are used for configuration of these resources. This framework, however, in case of, for example, SRS CLI measurement cannot be presumed to cater for adjacent channel interference, i.e. for the inter-MNO case, as the SRS configuration of the interfering UEs need to be known by the base station in order to be provided to the affected UE. CLI measurement based on RSSI, on the other hand, measures all the co- and adjacent-channel interference, which means that it could be used when interference originate from the same or different operator.

The measurement reporting can be configured as periodic, semi-persistent or aperiodic, depending also on the measurement resource type (periodic/semi-persistent or aperiodic) [Dahlman] as indicated in FIG. 23b. To understand potential improvements to the interference measurement evaluation, it is important to understand the main features of CSI-RS, which is at the heart of NR downlink measurement. Namely, CSI-RS supports single- and multi-port transmission and can be configured with up to 32 antenna ports. While CSI-RS is configured on per-device basis, the same set of CSI-RS resources can be configured/shared by multiple devices, whereby sharing i.e. separation achieved by code, frequency (different subcarriers within a symbol) or time-domain (different symbols in a slot)

FIG. 23b shows a schematic table indicating possible intervals for reporting detected interference in accordance with embodiments, e.g. a report to be transmitted in 2770 and/or 2780. For example, being scheduled with a periodic resource allocation, a periodic, a semi-persistent and/or an aperiodic reporting may be supported whilst a semi-persistent scheduling may allow at least for a semi-persistent and/or aperiodic reporting. For example, an aperiodic resource allocation may allow for an aperiodic reporting.

CSI-RS resource may start at any OFDM symbol of the slot and it usually occupies 1/2/4 OFDM symbols depending upon configured number of ports. In frequency domain, CSI-RS is configured for a given downlink bandwidth part and is then assumed to be confined within that bandwidth part and use the numerology of the bandwidth part. The CSI-RS can be configured to cover the full bandwidth of the bandwidth part or just a fraction of the bandwidth. In the latter case, the CSI-RS bandwidth and frequency-domain starting position are provided as part of the CSI-RS configuration. Within the configured CSI-RS bandwidth, a CSI-RS may be configured for transmission in every resource block, referred to as CSI-RS density equal to one. A CSI-RS may also be configured for transmission only in every second resource block, referred to as CSI-RS density equal to ½. For more details, see [29, 13Dahlman, Ahmadi].

CSI-RS can be periodic, aperiodic (event-triggered) and semi-persistent, which is configured by RRC signalling. The UE is informed of aperiodic transmission instance by means of DCI while the activation/deactivation of semi-persistent resource transmission done using MAC Control Element.

Furthermore, CSI-RS can be configured as zero-power (ZP) & non-zero-power (NZP) resources [29.[Dahlman]. These resources are configured via the existing downlink measurement framework, which uses higher layer signalling and one or more CSI Resource Settings. They can include channel and interference measurement resources configured as follows:
Non-Zero Power (NZP) CSI-RS resource for channel measurement [30], TS 38.214, v.16.4, 5.2.2.3.1.]
NZP CSI-RS resource for interference measurement [30], TS 38.214, v.16.4, 5.2.2.3.1.]
CSI-Interference Measurement resource for interference measurement [30], TS 38.214, v.16.4, 5.2.2.4.]

NZP CSI-RS are used for channel measurements and based on that residual interference can be estimated by subtracting the expected received signal from what is actually received on the CSI-RS resource. [Dahlman]. CSI-IM, on the other hand, enables direct measurement of interference, measuring either resources where interfering gNBs are transmitting CSI-RS or where interfering gNBs are transmitting data. Furthermore, within a BWP, the UE can be configured with one or more Zero-Power (ZP) CSI-RS resources, which are as not available for PDSCH for the serving cell [30], TS 38.214, v.16.4, 5.1.4.]. This enables the UE to estimate inter-cell interference.

Here, however, additional configurations can be foreseen. Namely, current measurement configuration and reporting mechanism should be enhanced with short and longer-term interference measurements configuration and reporting that will correspond to L1/L2 and enhanced L3 mitigation techniques. To improve CLI measurement results on the considered resources, and the impact of subsequent actions, particularly in the case of, for example, CLI-RSSI, the UE could have the capability to enhance the evaluation of CLI by combining and extrapolating from the existing downlink and CLI measurements. In enhancing the interference estimation, e.g. CLI, the measurement configuration could, for example, group the measurements on specific frequency and antenna resources, using the above-discussed measurements. By combining, e.g. summing and subtracting channel measurements on CSI-RS, which includes residual interference, CSI-IM interference measurements, measurements on CSI-RS ZP resources and CLI measurements, a better interference estimation could be achieved. Clearly, only the corresponding measurements, on the same resource blocks and/or subcarriers and slots/symbols should be combined. Similar method, combined with other measured and derived parameters, such as estimated angle-of-arrival could be applied to determine the type of interference, e.g. ICI or CLI. Below is also an example of how existing CLI measurements could be categorised:
A coarse CLI measurement, based on regular slot observation (L3)
   Categorise slots by e.g. RSSI (interference temperature as an average)
Fine CLI measurement
   Time-slots of your own system, it can be refined on the symbol level
   Bandwidth parts, BWP,
Further refinement of CLI measurement (provided similar frame structure) using RSRP (SRS or SSBs)
   Time-slots of your own system, it can be refined on the symbol level
   BWP
   Resource Blocks and/or subcarriers

Returning to FIG. 23a, after a start 2705 in the first step 2720, if the victim receiver (e.g. UE or IAB-MT) has the required capability, see decision 2710, additional CLI measurements configuration, reporting as well as execution conditions for the invocation of CLI mitigation techniques are provided by the base station/CU.

Both transmission (and therefore measurement) and reporting can be periodic, semi-persistent or aperiodic. The evaluation procedure is started either based on earlier provided configuration or a trigger signal by e.g. a DU or a CU. The evaluation procedure also has the timer associated with it. At the expiry of the evaluation timer, the condition is evaluated and if the UE/IAB-MT detects in 2730 that CLI measurements go above a pre-defined threshold, a short-term interference mitigation technique may be invoked in 2740.

The CLI threshold can be defined as interference power-level or power-level range, but can also include aspects such as angle of arrival or differential angle of arrival with respect to the main lobe. L1/L2 interference mitigation techniques may include spatial Rx spatial filter adaptation and/or sensing. Here, different sensing techniques could be invoked. Each L1/L2 CLI mitigation technique has an associated execution timer, upon which expiry the CLI measurements are performed. If L1/L2 sensing mechanisms do not reduce CLI interference below the required, predefined threshold over a predefined period, which is evaluated in 2750, enhanced L3 CLI mitigation techniques are invoked to arrive at 2760. Alternatively, if L1/L2 sensing mechanisms do reduce CLI interference below the required, predefined threshold over a predefined period, the last CLI evaluation may be reported in 2770.

However, if the UE or IAB-MT does not support such enhanced CLI mitigation (“No” in 2710), existing L3 CLI measurement/reporting may be triggered, 2780.

Method 2700 may end at 2790 which also allows repetition of method 2700.

In the following, several embodiments of the present invention are defined and explained in more detail. The embodiments relate to measure and/or handle interference, in particular CLI and ICI.

The embodiments may be implemented in devices such as UEs, IoT devices and (or base stations as described above by implementing additional capabilities in view of measurement, logging and/or reporting. For implementing the described solutions, the devices or apparatus described herein may be used or adapted, e.g., a device 26, 30 40, 45, 50, 11, 20, 31 and/or an MLRD.

1.1 Scheduling

CLI and/or ICI may be avoided or mitigated by adapting a schedule of one or more scheduled entities. A schedule may be at least a part of a communications configuration that is determined to organise communication of devices within a wireless communication system and/or a cell thereof.

Such a wireless communication system may be operated by one or more base stations that organise themselves, possibly other base stations and/or other devices such as UEs and/or IoT devices. A base station may be controlled, however, by a supervising entity or the like.

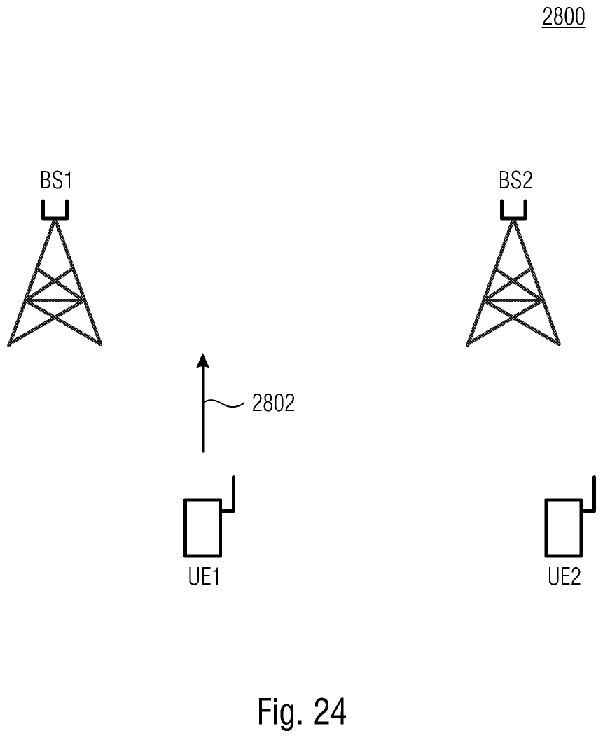

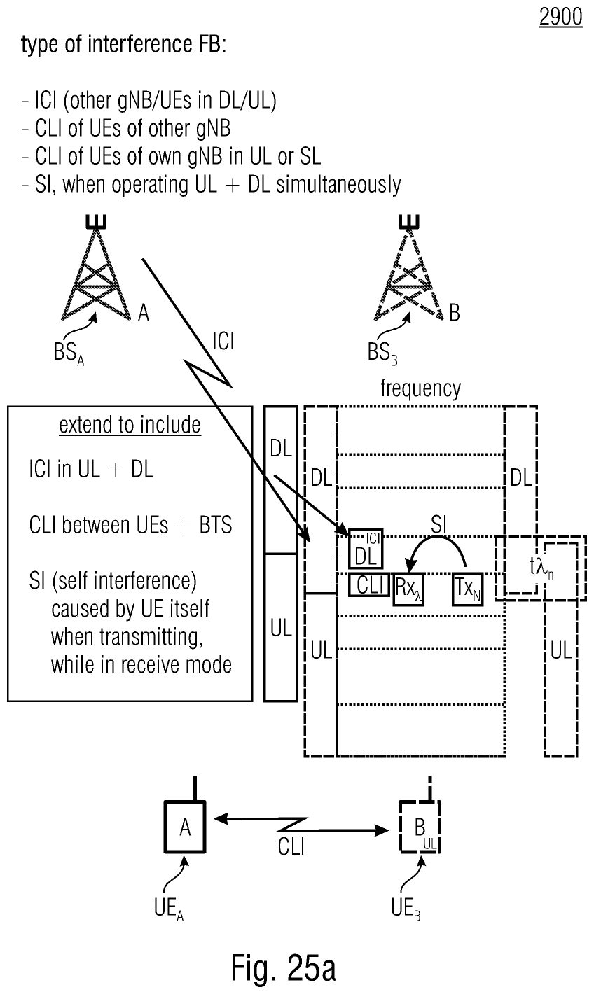

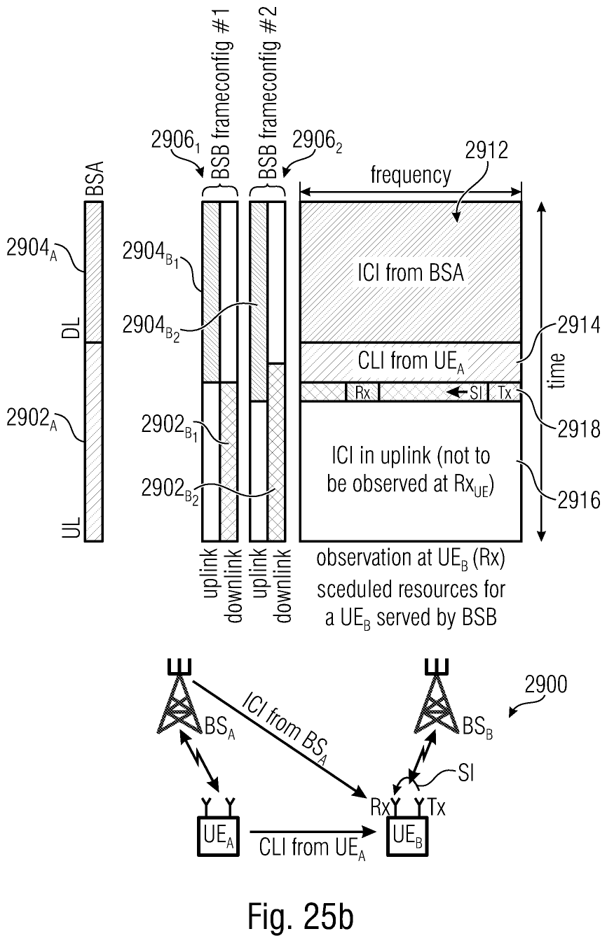

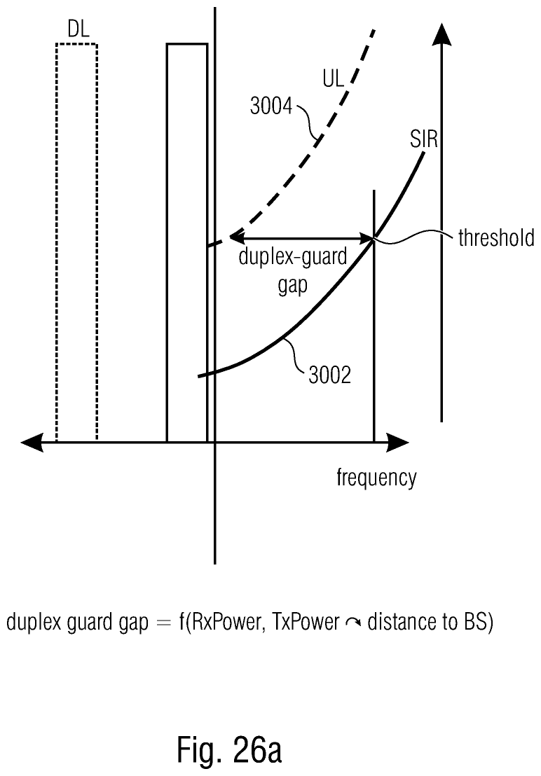

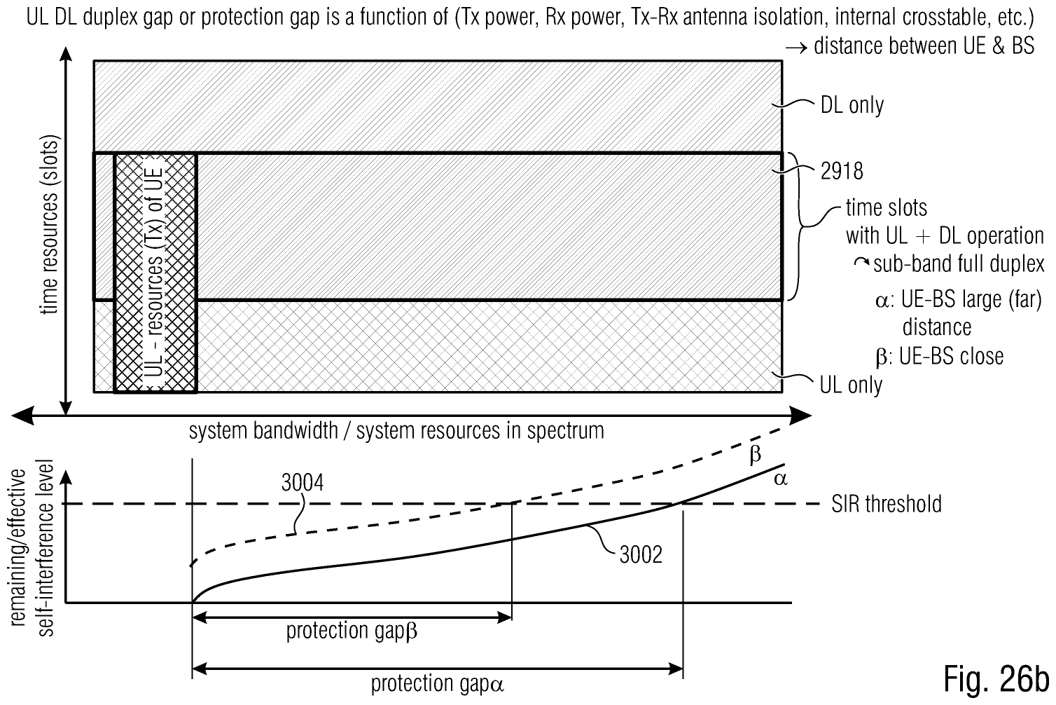

According to an embodiment a wireless communication system, e.g., system 1800 and/or 2800 shown in FIG. 24 comprises a base station BS1, BS2 adapted for scheduling, using a communications configuration, communication of a plurality of devices UE1, UE2 but possibly also BS1 and BS2, the plurality of devices including a reporting device UE1. The reporting device UE1 is configured for performing communication in the wireless communication system in accordance with the communications configuration, e.g., in accordance with the schedule.

The reporting device UE1 is configured for using information indicating a set of reference signals, i.e., at least a subset of two reference signals, more than two or even all, used in the wireless communication system. The reporting device UE1 is adapted for determining an amount of interference interfering with the communication in the wireless communication system for each of the set of reference signals by measuring to obtain a measurement result indicating the amount of interference perceived by the reporting device UE1 through the reference signals of the set of reference signals. The amount of interference may relate to a level or a different quantity of interference, e.g., a power level detected in one or more slots and/or on one or more resources, a number of slots and/or resources interfered or the like.

The reporting device UE1 is configured for reporting, to the wireless communication system a measurement report being based on the measurement result. For example, a signal 2802 may be transmitted to BS1 serving UE1. Alternatively, the signal 2802 containing the report may be transmitted to a different device using a suitable communication channel.

Optionally, the reporting device UE1 may also log the results of measurements and/or information derived thereof to obtain a log, which may be reported based on a decision of the reporting device UE1, upon request or based on the communications configuration. Operation of the device is not limited to reporting and/or logging but may also incorporate observation and/or measurement of at least a part of the network.

The wireless communication system is configured for using the measurement report and information about other devices communicating in the wireless communication system and information related to reference signals used by the other devices for adapting the communications configuration of at least one device of the plurality of devices for mitigating interference. The information related to the reference signals may comprise one or more of an identifier, time/frequency domain configuration, a comb structure, sequences used, including cyclic shifts etc., e.g., for sounding reference signals, SRS. The wireless communication system may adapt a configuration or schedule, for example, of an interfered victim and/or an interfering aggressor.

A reporting device operating in accordance with this solution may operate, for example, in accordance with an MLRD described herein and may extend the MLRD functionality in accordance with the solution.

According to an embodiment the wireless communication system is configured for identifying an interferer causing interference to the reporting device; and for adapting the communications configuration of the reporting device and/or of the interferer to reduce an amount of interference. Identifying may incorporate to determine any information such as an ID or the like allowing to identify, at the time the interference was detected, the interferer. Thus, instead of an identifier related to the device itself also other information may be used, e.g., reference signals (e.g., containing an identifier and/or a pattern in the time/frequency grid), an ID of filters or the like may be used to identify the interferer. For example, the aggressor and the victim belong to a same gNB and/or one of the victim and the aggressor is the gNB.

According to an embodiment the wireless communication system is configured for further identifying the interferer to cause the interference potentially to other devices in the vicinity of the reporting device; and for adapting the communications configuration of the reporting device and/or of the interferer to reduce an amount of interference. However, the adaption of the communications configuration is not limited to those two devices but may also incorporate other devices, e.g., in the vicinity of the victim and/or devices that have to be re-scheduled based on the re-scheduling of the victim and/or the aggressor. For example, the adaption of the communications configuration may be done to achieve an overall mitigation of interference in the cell and/or network which may include, in some examples, an increase of interference for one or more nodes, e.g., nodes that can handle additional interference for the sake of interference reduction at other nodes.

According to an embodiment, the reporting device is configured for obtaining the measurement result based on measuring uplink resources scheduled to the reporting device for obtaining information related interferer causing interference to the reporting device and based on measuring uplink resources scheduled to the other devices for obtaining information related to the interferer to cause the interference potentially to the other devices.

According to an embodiment, the reporting device is configured for measuring interference by observing transmit signals of other devices, e.g. in their current uplink slots and for performing the measurement while the reporting device is in a receive mode, e.g., during a current downlink, DL, and/or uplink, UL, slot. We can use uplink slots to measure, but it remains unclear if these UL resources belong to the system of the device or to the system of the “other” devices wherein other refers to devices of another system/base station. In the context of a currently used UL/DL configuration (e.g., TDD) a current UL slot may become a DL slot in a future configuration. In this embodiment, the interference may be measured observing transmit signals by other devices in e.g. their current UL slots and performing the measurement while the measuring device is in receive mode e.g. during a current DL and/or UL slot. When considering, for example, full duplex, to which the embodiments are not limited but allow fur such an implementation, the meaning of UL and DL slots becomes more blurred, therefore, the embodiment may also relate to measuring transmit signals from the device itself (Self-interference), another bases station in DL (inter-cell-interference) or from other UEs (cross-link-interference) in D2D or in UL.

According to an embodiment, the wireless communication system comprises a plurality of base stations. The reporting device is configured for reporting the measurement report to the base station UE1 being a first base station and being a scheduling base station for the reporting device, i.e., a serving base station. The wireless communication system may be configured for identifying an interferer causing interference to the reporting device, the interferer being scheduled by a different second base station, e.g., UE2 served by BS2 and interfering UE1 as causing interference 1806b as shown in FIG. 14a/b. The first base station may adapt a communications configuration for the reporting device to mitigate the interference, e.g., to adapt scheduling of the victim. Alternatively or in addition the first base station may provide information to the second base station, such that the second base station may adapt a communications configuration of the interferer to mitigate the interference based on the information.

It is to be noted that the reporting device may detect interference at its own location. Such information may, at the network side and/or at the reporting device be used to identify that further devices, e.g., in a neighbourhood or in a vicinity of the reporting device might also be at last a potential victim of the interferer, which may be used to also change the communications configuration of the potential victims, e.g. based on a collection of reports including ones from the other devices and/or by avoiding such reports from other devices which may avoid network traffic.

According to an embodiment, the reporting device is adapted to transmit, to the base station a suggestion for a future communications configuration, e.g., based on a listen before talk procedure or enhanced listen before talk procedure described herein.

According to an embodiment, the wireless communication system is adapted for using information about interferes and the interference they cause in the wireless communication system based on reports received from reporting devices to determine the communications configuration to obtain an overall mitigated interference for scheduled devices based on an optimization criterion. Such an optimisation criterion may be, e.g., a local minimum for each node, that each node perceives interference each below a threshold that may be device individual, group-individual (e.g., groups of different types of devices—e.g., loT, UE, and/or of different distances to the reporting device, e.g., assuming that a greater distance to the reporting victim requires a lower reduction of interference or the like) or valid for all devices.

According to an embodiment, the wireless communication is configured for determining, from the measurement result or the measurement report, a type of the interference and for including a type information indicating the type into the measurement report. A type may be, for example, a categorisation with regard to a type such as CLI/ICI, a pattern in the frequency and/or time domain. The reports may be provided, e.g., based on or using resources as indicated in FIG. 23b. The device may be configured for evaluating the type of interference at least in parts based on the configured measurements and/or an angle-of-arrival estimation.

According to an embodiment of this solution and/or other solutions, the device may adapted for reporting the measurement report using at least one uplink resource and/or at least one flexible resource.

According to an embodiment, the reporting device is adapted for measuring continuously, repeatedly or based upon request and for deciding whether to report the measurement report or not based on a decision criterion applied to the measurement result. E.g., the reporting device may report only in cases that it has detected interference being above a certain threshold and/or if it requested by a requesting node.

According to an embodiment, the reporting device is adapted to evaluate the measurement results and for generating the measurement report to comprise an evaluation result. The evaluation result may be transmitted with signal 2802, for example, instead or in addition to the measurement results. The evaluation may incorporate, for example, a location of a source of the interference, details on the interference such as a temporal and/or spatial pattern or the like. For example, the reporting device could estimate interference power, based on the earlier described combined measurements, together with the estimation of AoA of interference source, by using different AoA estimation techniques.

According to an embodiment, the reporting device is adapted to generate the measurement report by condensing, compressing or summarizing a set of measurement results which may allow to reduce the amount of data being transmitted.

A device for operating in a wireless communication system in accordance with the described solution, e.g., the reporting device is configured for performing communication in the wireless communication system in accordance with a communications configuration obtained from a base station of the wireless communication system and scheduling communication of the device. The device is configured for using information indicating a set of reference signals used in the wireless communication system; and for determining an amount of interference interfering with the communication in the wireless communication system for each of the set of reference signals by measuring to obtain a measurement result indicating the amount of interference perceived by the device through the reference signals of the set of reference signals. The device is configured for generating a measurement report based on the measurement result and reporting the measurement report to the wireless communication system.

According to an embodiment, the observed interference is possibly relevant to links of the reporting device and possibly other devices and links in vicinity of the reporting device. That is, the device may be, for example, configured for logging measurement results.

According to an embodiment, the device is configured for estimating, from the measurement result, a type of the interference and for including a type information indicating the type into the measurement report.

A base station, e.g., BS1 and/or BS2 configured for operating in a wireless communication system in accordance with the described solution is adapted for scheduling, using a communications configuration, communication of a plurality of devices, the plurality of devices including a reporting device. The base station is configured for receiving a report, e.g., with signal 2802 generated by the reporting device, the measurement report indicating an amount of interference perceived by the reporting device through a reference signal of a set of reference signals used in the wireless communication system. The base station is configured for using the measurement report and information about other devices communicating in the wireless communication system and information about reference signals used by the other devices for adapting the communications configuration of at least one device of the plurality of devices for mitigating interference.

In other words, the solution relates to avoidance through SCHEDULING in different time slots or BWP or spatial domains.

Reports to be transmitted in embodiments described herein for this or a different solution may be transmitted by use of uplink symbols and/or slots of a TDD frame implemented in the wireless communication system and/or using flexible symbols and/or slots. As an example, FIG. 23c shows schematic representations of different possible configurations 2702₁ to 2702_{N} of an example TDD slot having different configurations in view of a distribution and amount of uplink symbols U and downlink symbols D as well as flexible symbols “-”. For example, uplink symbols may be used for transmitting measurement reports. Embodiments are not limited to a specific configuration of a TDD slot nor are they limited to a TDD configuration but may also use, as an alternative or in addition, other multiplexing techniques such as frequency division duplex, FDD, code division duplex and/or spatial multiplexing. In other words, such a configuration may be a part of system design, so that gNB knows exactly within the slot/frame, when, for example, a UE transmits ‘OK to receive in x+n symbol/m-slot’, and hence when it will be scheduled to receive. There are also flexible symbols/slots in TDD pattern that could be utilised for a smart report. Embodiments relate to utilising flexible symbols/slots in TDD pattern for a smart report.

1.2 Adaptation of Victim's Spatial Receive Filter

Whilst solution 1.1 related to adapting a communications configuration such as a schedule, to mitigate interference, at least for the victim, the victim may adapt its spatial receive filter. That is, an advantageous direction of a sensitivity of an antenna unit of the victim may be changed, e.g., in order to reduce the sensitivity or the direction from which the interference of an aggressor impinges. In one example, a null of an antenna receive pattern may be pointed towards the aggressor, whilst possibly accepting a reduced sensitivity along a direction towards an intended transmitter, e.g., a base station. Even if a null is not appropriate, at least a reduced sensitivity may be pointed towards the aggressor when compared to a situation in which the victim is interfered, e.g., above a predefined threshold level.

A device configured for communicating in a wireless communication system in accordance with such a solution comprises an antenna unit. The antenna unit may be formed in accordance with antenna arrangement described herein, i.e., having one or more antenna panels, wherein each antenna panel may comprise one or more antennas. By use of the antenna unit together with a receive filter and/or a transmission filter, a directivity for receiving a signal, for transmitting a signal respectively may influenced, and a method which is also known as beam forming may be executed by the device.

The device is configured for selecting and using, for communication in the wireless communication system, a first of a set of different spatial receive filters as a selected filter with the antenna unit to implement a directional selectivity for a reception of signals with the antenna unit; wherein each of the spatial receive filters is associated with a main direction of directional sensitivity; wherein the device is configured for receiving signals from a communication partner using the first spatial receive filter.

The device may be configured for performing a measurement procedure during a time different from the communication, the measurement procedure comprising selecting the selected filter in accordance with a direction of an interfering link towards the device, the interfering link interfering with the device. For example, the receive beam pattern may be pointed towards the interfering link.

The device is configured for using information indicating a set of reference signals, e.g., some or all used in the wireless communication system; and for determining an amount of interference interfering with the communication for each of the set of reference signals by measuring to obtain a measurement result indicating the amount of interference perceived by the device through the reference signals of the set of reference signals.

The device may be adapted to select a second spatial filter for the communication based on the measurement results to mitigate interference perceived with the first spatial receive filter. For example, a different directivity is implemented that results in less interference. That is, the device may deviate from a filter that is determined or obtained when using a standard procedure, e.g., a beam correspondence procedure, to reduce the perceived interference. This decision and/or adaption may be reported to one or more other nodes, e.g., an intended transmitter from which signals are intended to be received which may allow the other device, the transmitter, to optionally select a different transmit beam pattern, e.g., to exploit changed multipath components.

According to an embodiment, the device is configured for selecting the selected filter in accordance with a direction of the interfering link towards the device based on information indicating a control resource set, CORESET, of the interfering link.

According to an embodiment, the device is configured for monitoring at least one of:
a physical broadcast channel, PBCH;
a demodulation reference signal in the PBCH, PBCH DM-RS;
a primary synchronization signal, PSS;
a secondary synchronization signal, SSS

to obtain a measurement result and for obtaining the information indicating the CORESET from the measurement result.

According to an embodiment, the device is configured for reporting information indicating at least one of
a spatial receive filter used for the measurement procedure;
a control resource set, CORESET, of the interfering link;
the first spatial receive filter;
the second spatial receive filter
an amount of interference perceived with the first spatial receive filter; and
an amount of interference perceived with the second spatial receive filter.

A device operating in accordance with this solution may operate, for example, in accordance with an MLRD described herein and may extend the MLRD functionality in accordance with the solution.

1.3 Adaptation of Aggressor's Spatial Transmit Filter

According to this solution, sensing as a part of this procedure can be used to adapt the Tx filter.

Instead or as an alternative to adopt the spatial filter of the victim, i.e., the receive filter, a spatial transmit filter of the aggressor, i.e., the interferer may be changed or adapted. Both of the solutions, i.e., changing the victims filter and/or the aggressor's filter may be performed individually or together with one another and, further, together with or independent from a change of the communications configuration. That is, the solutions do not exclude one another, but may be performed together in any configuration, which is also true for the solutions being described below.

A device in accordance with this solution may be a first device and is configured for communicating in a wireless communication system, e.g., one of the base stations and/or UEs in network 1800 or 2800, the device comprising an antenna unit and being adapted for establishing a link with a base station.

The device is configured for selecting a first spatial transmit filter for transmitting a signal with the antenna unit based on a beam correspondence procedure with the base station. That is, the device may select a regular spatial transmit beam.

The device is configured for using information indicating a time of transmission of a signal from a different second device. For example, the device may listen to broadcast channels or other sources of information to obtain information of other devices within a same or a different cell and/or network. The device measures interference caused by the second device to the first device during the time of transmission and via an interfering channel. That is, based on knowledge when the potential victim transmits, the potential aggressor listens with the selected receive filter to a signal sent with the potential victim.

The device is configured for deriving information indicating an amount of interference caused by the first device at the second device using a reciprocal channel assumption with respect to the interfering channel. That is, the device determines how the potential victim interferes with the potential aggressor. From this and based on the reciprocal channel assumption, the device as the potential aggressor determines how it interferes with the potential victim.

The device is configured for selecting a different second spatial transmit filter based on the information indicating the amount of interference so as to mitigate the interference of the first device at the second device. That is, based on the obtained knowledge, the device tries to reduce the effect of its signal on the victim within boundaries, e.g., to ensure a reliable communication with the intended receiver of the potential aggressor.

According to an embodiment, the device is configured for measuring for the interference caused by the second device to the first device during the time of transmission and via an interfering channel using a matched spatial receive filter to obtain a main direction of the directional selectivity towards the second device; and evaluating an interference power based on a maximum interference measured thereby.

The device may be configured for calculating a suitable spatial receive filter for mitigating the interference caused by the second device and may derive the information indicating the amount of interference caused by the first device by providing an estimate of interference that will be caused when using a similar or equivalent spatial transmit filter, e.g., based on beam correspondence, for transmission. The device is configured for selecting the different second spatial transmit filter to mitigate interference

In other words, the solution relates to change of aggressor's spatial transmit filter.

In CLI interference situations, the interference either between UEs or between base stations are depicted in FIGS. 18 and/or 19.

While base stations are usually assumed to be deployed in a fixed geo-location with a fixed or repeated directional coverage and range (exception are e.g. mobile IAB nodes), UEs usually will be distributed within the coverage of their serving base stations and therefore two users serviced by different base stations may be far apart or in close proximity. Thus near-far CLI situations combined with potentially different relative distance between a base station and its associated users gives rise to hidden terminal or exposed terminal situations and the associated communication problems when simultaneously accessing the same or adjacent channels.

Although cellular networks do not typically or necessarily operate in LBT mode, in dynamic TDD due to CLI and considering that not every gNB/IAB node is aware of scheduling decisions of other gNBs/IAB nodes, they can be viewed similarly to the problems of hidden or exposed terminals.

Various approaches in literature were proposed to solve the above-described problem. Many of them do not address the issue and result in introducing additional problems; e.g. sheer increase of transmit power reduces the hidden terminal problem for two distinct wireless links while increasing the interference range and therefore creating new and more hidden nodes if further wireless links are in the vicinity.

In this invention, by exploiting side information (interference measurements, monitoring, and potential source identification), a number of solution components that tackle the hidden node and exposed node problem have been identified. In the following the principles and associated procedures are introduced and described.

1.4 Enhanced Listen Before Talk with Probabilistic Transmission Grant Announcement—eLBT

This solution relies on the principle that a victim (receiver) signals the transmitter when to transmit, assuming the interferer/aggressor is silent).

The solution provided herein, which can be combined with one or more of the other, also described aspects, is based on the finding that by listening to uplink and/or downlink and/or flexible slots should be used to determine that such a future slot is suitable for the device.

A device in accordance with this solution is configured for communicating in a wireless communication system, e.g., 1800 and/or 2800 and for receiving a signal from a communication partner, e.g., a base station and/or a different device such as a UE.

The device is configured for observing a set, i.e., at least one, at least two or more or even all of slots, which may be all downlink slots, all uplink slots or flexible slots or a combination thereof as illustrated in FIG. 23c, of the wireless communication system, e.g., during which the communication partner transmits or receives signals. For example, the device may be a UE, e.g., operating at least in parts in accordance with an MLRD configuration, and may, for mitigating CLI, observe the UL communication of a different UE. The device may, for example, in flexible slots or in some UL slots where it is not scheduled to transmit, be configured to also observe transmissions by other transmissions UEs or gNBs.

According to an embodiment the device is configured for requesting a schedule of downlink and/or uplink signals from the communication partner in the at least one selected future radio resource together with an indication which radio resource to be used.

According to an embodiment the indication comprises at least one of a prioritized, deprioritized, whitelisted, blacklisted and barred indication of future radio resources.

The device is configured for measuring, for each of the slots, interference occurring in the slot, to obtain measurement results. The device is configured for reporting, to the wireless communication system, e.g., a base station, a UE or the like, the measurement results or information derived thereof. Such a derived information may be a measurement report. For example, signal 2802 or a different signal may be used for transmission.

The transmitted information may allow the base station or a different scheduling entity to determine slots suitable for the device. Alternatively, the device may already indicate one or more specific slots that it considers suitable. This may include a basis for selection at the scheduler which may select one or more or all suggested slots.

Alternatively or in addition, the device may be configured for determining, based on the measurement results and based on an interference criterion, at least one selected future slot.

The device is configured for transmitting information indicating the at least one future slot to the wireless communication system; and/or for requesting a schedule of downlink and/or uplink signals from the communication partner in the at least one selected future slots.

According to an embodiment, the device is configured for measuring the interference as a cross-link-interference perceived from at least one link of a different device.

According to an embodiment, the device is configured for measuring the interference based on receiving a reference signal such as a sounding reference signal, SRS; and/or based on an evaluation of a signal power received as a cross-link-interference from at least one link of a different device. That is, CLI can be also determined by measuring RSSI on the configured resources, these resources can be resources where SRS is transmitted, but do not necessarily represent SRS RSRP.

According to an embodiment, the set of slots is based on a time in which other devices communicating with the communication partner operate in a transmit mode whilst the device operates in a receive mode.

According to an embodiment, the device is to determine, from the measurement results, statistics indicating suitable slots in the temporal past; and to derive, using the statistics, the selected future slots as slots that are expected to allow a successful decoding of a signal transmitted to or by the device.

According to an embodiment, the device is configured for determine a candidate for the future slot as the selected future slots based on a decision whether the candidate fulfils a predetermined criterion with regard to a transmission quality. Such a criterion may, for example, be related to an amount of interference, a bit error rate, a possibility of a required retransmission, a required transmission power for transmission or combinations thereof.

According to an embodiment, the device is configured for determine the selected future slots as being expected to have a level or amount of interference of at most a first interference threshold and/or a level/amount of interference of at least a second interference threshold.

According to an embodiment, the device is configured for determine the selected future slots based on at least one probability of:
a packet collision in the selected future slot,
the device being out of coverage during the selected future slot
packet loss higher than a threshold in the selected future slot
Signal to interference ratio, SIR, exceeding a predetermined threshold the selected future slot
Packet erasure events over multiple retransmissions occurring when using the selected future slot

According to an embodiment, the device is configured for receiving, from the wireless communication system and responsive to transmitting the information or the request an indication indicating that the device is scheduled to receive information in the slot; wherein the device is configured for transmitting, to the wireless communication system a confirmation signal, e.g., a clear to send, CTS indicating a confirmation for the indicated slot; and/or wherein the device is configured for transmitting, to the wireless communication system a dismissal or rejection signal indicating a rejection for the indicated slot. A rejection may also be indicated as optional as transmitting the dismissal signal, which may be interpreted as a denial. Alternatively or in addition, the device may be configured for transmitting, to the wireless communication system a packet retransmission request signal indicating an expected misdetection or channel degradation for the indicated radio resource. That is, when having knowledge about an expected future interference or an expectation that reception of the future signal by use of the future radio resource might be error-prone, a re-transmission may already be requested prior to the transmission. For example, the device may be configured for transmitting information indicating a plurality of selected future radio resources to the wireless communication system; and/or for requesting a retransmission of downlink data packets from the communication partner in a plurality of selected future radio resources. The indication may indicate a subset of the plurality of future radio resources as a selection thereof.

According to an embodiment, the device is configured for transmitting information indicating the a plurality of selected future slots to the wireless communication system; and/or for requesting a schedule of downlink signals from the communication partner in a plurality of selected future slots. The indication indicates a subset of the plurality of future slots as a selection thereof.

According to an embodiment, the device is configured for transmitting, prior to the selected future slot, a pre-emption signal to the wireless communication system to indicate an expected signal in the selected future slot.

According to an embodiment, the measured slots comprise at least one uplink slot and/or at least one downlink slot; and/or the future slot is an uplink slot or a downlink slot.

In other words, listen-before-talk (LBT) is a widely-established concept used in various communication protocols e.g. WiFi (IEEE 802.11 series) and NR-U, which works sufficiently well with a low number of users and/or overlapping base station footprints. Nevertheless, LBT is prone to hidden node and exposed node problems, which are proposed to be addressed by the following procedure:

Assuming the UE-UE CLI situation in a flexible TDD scenario where adjacent base stations are using different TDD frame formats resulting in unidirectional or bidirectional CLI between UEs or groups of UEs belonging to different base stations. While multiuser scheduling in DL and UL is arranged for each group by their serving bases stations, multiuser interference in UL and DL can be sufficiently resolved by existing channel feedback and scheduling mechanisms and associated protocols.

While inter-cell-interference (ICI) in DL and UL can be coordinated by the serving base stations among each other exploiting interference measurements by the UEs or at the base station side at least with base stations belonging to the same MNO, further side information and/or further information exchange is needed when such concepts are to be extended across multiple MNOs operating in e.g. adjacent parts of the spectrum.

In the UE (a)-UE(b) CLI situation usually at least one of the UEs is becoming a victim when receiving data from its associated base station in DL while the other UE is already transmitting to each associated base station in UL. Since UL and DL scheduling are usually performed by each UEs base station independently, such victim-aggressor pairing situations are dependent on the scheduling AND the proximity of two UEs.

In our given scenario a receiving UE is observing e.g. all DL slots from its base station and occurrences of CLI in particular slots listening to SRS or other reference signals from UEs belonging to the group of UEs active in transmit mode while the UE is still in receive mode.

The CLI can be measured based on RS using the configured SRS (RSRP) or CLI-RSSI. Furthermore, a UE can create e.g. statistics about the observed interference level in temporal, spectral and/or spatial domain in order to get meaningful insight into proximity of interference sources, their spatial distribution, effective near-far behaviour due to varying allocated transmit bandwidth, etc.

Furthermore, these statistics can be used by the UE to identify suitable time slots for future use by its base station in the DL, where suitable means that the expected/estimated CLI will be below a certain threshold allowing the UE to successfully detect DL signals/data from its own BS. The level or amount of interference may be determined on one of different levels/hierarchies. For example, a symbol level may be used, making this also short-term interference mitigation mechanism, based on immediate sensing.

Detail about mixed TDD slots (featuring UL and DL symbols) and frames will be provided.

Such signalling of potentially secure radio resources in e.g. time or frequency is denoted Extended LBT with probabilistic transmission grant announcement or request.

As a practical example this may be implemented in the following way:

UE is observing interference occurrences over a selected window of time and concludes/determines suitable time slots/BWP for future transmission by the gNB to the UE
There can be several levels of “suitability”, e.g. very secure/suitable e.g. in slots only subject to ICI, moderately secure/suitable e.g. for CLI slots with sparse or low level interference observed or low level of suitability for maybe best effort transmissions.
Such levels of security/suitability in terms of expected transmission/channel quality e.g. expected/predicted CQI (channel quality indicator) can also be expressed as low interference indicator (LII) or high interference indicator (HII) associated with a threshold relevant for the intended transmission, potentially including MCS level, QoS or probabilistic metrics like probabilities on
   packet collision,
   out of coverage
   packet loss higher than a threshold
   SIR exceeding threshold
   Packet erasure events over multiple retransmissions
   etc.

UE signals these slots as suitable/good enough for future DL transmission to the gNB OR requests gNB to use these slots for next transmissions
This can be understood like a “Ready to Receive” (RTR) command, where the receiver is triggering the transmitter for action.

gNB includes this information in scheduling decisions and will schedule UE on particular slots.

If UE identifies sudden interference to occur in scheduled slots harming the DL transmission beyond a tolerable level, then
UE will signal to gNB that formerly secure/suitable status of slot is no longer valid and
gNB will schedule retransmissions and further new packet transmissions on alternative slots, where validity is still expected.

An alternative implementation, more similar to the classical RTS/CTS protocol would be the following:

UE is observing interference occurrences over a selected window of time and concludes/determines suitable time slots/BWP for future transmission by the gNB to the UE
There can be several levels of “suitability”, e.g. very secure/suitable e.g. in slots only subject to ICI, moderately secure/suitable e.g. for CLI slots with sparse or low level interference observed or low level of suitability for maybe best effort transmissions.
Such levels of security/suitability in terms of expected transmission/channel quality e.g. expected/predicted CQI (channel quality indicator) can also be expressed as low interference indicator (LII) or high interference indicator (HII) associated with a threshold relevant for the intended transmission potentially including MCS level, QoS or probabilistic metrics like probabilities on
   packet collision,
   out of coverage
   packet loss higher than a threshold
   SIR exceeding threshold
   Packet erasure events over multiple retransmissions
   etc.

gNB signals to UE its intention to use the reported slots (marked as suitable/good enough for future DL transmission) for upcoming transmissions e.g. in next frame this is a kind of RTS (Request To Send) signalling from the gNB to the UE
the DL scheduling attempt announcement may include a description of slots and/or BWP

UE will respond with a form of CTS (clear to send) message, that it still expects the channel to be suitable in near future.

gNB will schedule packets for UE on confirmed slots upon CTS message received. If UE identifies sudden interference to occur in scheduled slots harming the DL transmission beyond a tolerable level, then
UE will signal to gNB that formerly secure/suitable status of slot is no longer valid and
gNB will schedule retransmissions and further new packet transmissions on alternative slots, where validity is still expected.

Optionally, the UE could send out a pre-emption beacon/signal/message while or after sending the CTS to its gNB in order to trigger potential aggressor(s) NOT to send in a future slot.
One flavour of the solution could be an implicit addressing/indication of future resources according to a code book/look-up table describing the relationship between a pre-emption beacon/signal/message and the slots/BWP aggressed for pre-emption.

It should be noted that the above mechanisms while envisaged to work on a time-scale that spans a few or dozens of slots, could also be applied on a symbol level, making this also short-term interference mitigation mechanism, based on immediate sensing.

1.5 Remote LBT or Collaborative LBT

Another solution related to a concept based on listen before talk in accordance with embodiments is explained in the following.

A wireless communication system in accordance with such a solution, e.g., network 1800 or 2800 or another network described herein comprises at least one base station and a plurality of devices being scheduled with communication by the at least one base station.

That is the plurality of devices are operated in at least one cell of the wireless communication system.

Each of the scheduled devices is configured for observing a device-individual set of resources, i.e., at least one, some or all of the wireless communication system, wherein a resource comprises, for example, an uplink slot, a downlink slot, a flexible slot and/or a set of at least symbol being used for uplink or downlink. As a resource, embodiments may incorporate one or more of at least one frequency bandwidth part (BWP), at least one resource block, at least one subcarrier and/or at least one time-domain slots/symbols. As a resource, instead of or in addition to slots embodiments also relate time domain and/or frequency components and/or combinations thereof e.g. resource block (RB).

A slot may be understood as a time period of relevant meaning within the frame structure of a radio frame used by the communication system AND that it can represent e.g. a sequence of signal samples (smallest length); and/or as a length of a symbol (e.g. OFDM symbol) and/or as the length of a guard interval (e.g. OFDM GI) and/or as a sequence of symbols (e.g. OFDM symbols with or w/o cyclic extension) which can be a “SLOT” (as called in 3GPP language) or a “SUB-SLOT” or a “partial SLOT” or whole “FRAMES” and/or partial or whole “SUBFRAMES”.

That is, the term slot is not limiting to a specific amount of time but all possible temporal interference options are covered as well.

That is, when referring to a radio resource in time, the embodiment may also be implemented by using, as an alternative or in addition, a radio resource in the frequency domain, e.g., bandwidth parts (BWP), Resource blocks (sequence of set of subcarriers over a sequence of OFDM symbols, Subcarriers etc. Embodiments are not limited to half duplex but may also operate in full duplex. That is, a frequency radio resource may be defined in a similar way as a time radio resource such as a slot.

Although radio resources in the intended future operation such as a future time slot are mentioned in some embodiments, those embodiments operate also as a targeted or indicated radio resource in the future are as a frequency resource and/or a combination thereof, therefore including full or partial RB (resource blocks).

Further, the devices are configured for measuring, for each of the resources, interference occurring in the resource, to obtain measurement results; and for reporting, to the wireless communication system, the measurement results or information derived thereof. Such information derived from the measurements may include, for example, a measurement report indicated above. Reporting of the devices may allow to determine suitable resources for one or more devices in uplink and/downlink at an entity such as a base station that has access to the collective of measurements, e.g., to optimise communication and/or interference for a set of devices.

The set of radio resources may include a first resource configuration, e.g. currently used configuration and/or a second resource configuration, e.g. future used configuration. In a future configuration the resource may be used as uplink resource and/or as flexible resource. That is, the term downlink resource may limit the embodiment only to an extend that by use of this resource a signal is transmitted so as to be received with the device and, thus, even as uplink resource.

The wireless communication system is configured for determining a communications configuration for the plurality of devices that mitigates interference caused by transmitting signals to the devices during future resources based on evaluation of the reported resources, e.g., by extrapolation.

According to an embodiment in accordance with this solution, the wireless communication system is configured for identifying, for future resources and for a reference communications configuration, potential interferes and potential victims potentially interfered by the interferers; and at least one of:
scheduling at least one interferer and/or at least one victim to a different radio resource when compared to the reference communications configuration; and
changing a transmission behaviour of a potential interferer

to determine the communications configuration.

According to an embodiment in accordance with this solution, the wireless communication system is adapted to repeatedly measure the resources and determine the communications configuration, e.g., based on a mobility of network nodes in the wireless communication system.

In other words, similar to the mechanism described above the observation can not only be done by a device individually but as a collaborative task performed by a group of UEs and sharing their measurements and/or observations among them and/or with their BS and/or with the group of potential CLI victims or aggressors. For example, the wireless communication system is adapted to repeatedly measure the radio resources of a first UL/DL configuration and/or a different second UL/DL configuration and to determine a measure for interference such as CLI, for the first and the second UL/DL configuration, and for selecting one of the first and the second UL/DL configurations as a future UL/DL configuration based on the interference. That is, based on measurements of measuring devices, impacts of interference on different UL/DL configurations may be determined and based thereon, a suitable configuration may be selected or determined, e.g., avoiding specific interference for one or more devices, obtaining a low amount of interference for all devices or the like.

The mechanism could be aligned to the listen before selecting radio resource pool resources in sidelink (SL) communication, where UEs observe spectrum occupancy around them and share their observations via the BS to become common knowledge of all UE in a given geo-location area.

According to embodiments, there measurements may done in sidelink, SL, and they may, dfor example, be available there, e.g., a Channel Busy Ratio (CBR) and a Channel occupancy Ratio (CR) that are also referred to as SL CBR and SL CR CBR being defined as the ratio of occupied subchannels within the previous 100 slots. The channel is occupied if RSSI goes above some threshold. The CR estimates the channel occupancy generated by a TX UE.

Remote LBT allows to coordinate transmitters and receivers among the group of potential aggressors and potential victims by exploiting collaborative observations and sharing these with the scheduling entities and/or the group of potential aggressors.

The information about users or a group of users which may cause an intolerable interference burden to UEs in the group of potential victims can be used to:
Reschedule them on to other radio resources (response at aggressor side)
Change their transmit behaviour with respect to Tx power or directivity (response at aggressor side)
Protect potential victims by avoiding vulnerable radio resources (response at victim side via BS)

Such temporary avoidance of certain transmit opportunities for particular UEs have to be updated regularly due to changes cause by user mobility and therefore change of proximity relations between UE/devices.

In that sense the Remote LBT or Collaborative LBT is not suitable to make decisions immediately before a transmission burst is initiated but rather on a longer time scale over multiple slots or radio frames.

1.6 Spatial Proximity Pre-Emption for CLI Reduction

This solution is based on the finding that although being scheduled with one or more resources, other devices may interfere with the scheduled device or may be interfered by the device, e.g., as being not aware of the schedule. The solution suggests to indicate the schedule to allow devices to avoid interference or being interfered.

A wireless communication system in accordance with this solution, e.g., network 1800 or 2800 or a different network described herein is configured for providing a wireless communication at least from a base station to a device.

The device is configured for observing a radio environment of the device to obtain an observation result, e.g. by performing measurements described herein. The device is configured to determine, based on the observation result, at least one radio resource such as a slot or symbol in uplink or downlink as being vulnerable to a cross link interference and/or ICI.

The device is configured for reporting, to the base station a report indicating the at least one radio resource. Such a report may be a signal, e.g., signal 2802 and/or a fully-fledged L3 report, which may include additional interpretations such as statistical averaging.

The device receives information indicating a communications configuration to receive a signal in a scheduled radio resource;

The wireless communication system is configured for transmitting a pre-emption signal system to indicate an expected signal in the scheduled future radio resource.

Examples in accordance with the solutions also relate to such an pre-emption signal being sent from
a base station serving the victim(s)
a base station serving the aggressor(s)
The victim(s).

According to embodiments, the pre-emption signal may be sent by an aggressor base station, e.g., an interfering base station, e.g., for ICI and/or by aggressor UEs directly; and/or by a base station serving aggressor UEs and/or any other entity, which can initiate (send) a NO-transmit command to the aggressor UEs

According to an embodiment in accordance with this solution, the base station is configured for determining the communications configuration based on the report.

According to an embodiment in accordance with this solution, the wireless communication system is configured to transmit the pre-emption signal with the device to receive the signal in the scheduled future downlink slot; and/or with the base station to transmit the signal in the scheduled future downlink slot.

According to an embodiment in accordance with this solution, the pre-emption signal is adapted to identify/address at least one radio resource to be temporarily protected by other devices nearby by avoiding transmitting using the at least one radio resource.

According to an embodiment in accordance with this solution, the wireless communication system is adapted for observing the radio environment also with the base station to obtain a bi-directional observation.

According to an embodiment in accordance with this solution, the device is configured for observing the radio environment during an initial stage. For example, a UE is configured using RRC in terms of measurements, resources and reporting. The UE can be also configured but not activated initially, so they can be activated at a later stage. This includes measurements and reporting.

According to an embodiment in accordance with this solution the base station is configured for observing the slots, i.e., the radio resource, and parts of the spectrum associated with a link with the device; and for reporting information indicating a link quality or an interference information associated with the link to the device to obtain a bi-directional link information at the device together with the observation result. The spectrum component may be of importance to reduce or specify the allocated part of the spectrum (a number of resource blocks or a bandwidth part (BWP) or a sub-band).

In other words, in this solution component it is assumed that a UE (receiving device) is during an initial stage observing its radio environment and therefore able to anticipate certain radio resources, e.g. time slots vulnerable to CLI and/or ICI.

Furthermore, the receiving device/UE is informed by its base station about scheduled future transmissions e.g. by means of (semi-) persistent scheduling and uses means to transmit a pre-emption beacon or message into its proximity in order to signal to members of the potential interferer group (CLI aggressor group) that proximity pre-emption is requested.

These means include transmitting a signal by the potential victim UE itself or by its BS or by the BS of the other UE. Such signalling could identify/address certain radio resources to be temporarily protected by other device nearby not transmitting. The mechanism could be aligned to the pre-emption protocols in URLLC with grant-free transmission in contentious mode. This protocol allows individual or group-wise cancellation of previously given transmission grants by the base station of the aggressor UEs.

A further extension of such mechanism is a bi-directional link observation and repeat windows of opportunity to listen, while the nearby transmitter is silent.

Such extension could be understood either as a “considerate nearby transmitter” when avoiding (not responding to scheduling requests by its BS) or otherwise as a “receiver (victim) oriented transmitter (aggressor) tasking”).

Embodiments of the present invention may be adapted, for this or a different solution, for a dynamic indication for restriction and/or availability of beams between nodes of the wireless communication system in the configured radio resources; wherein radio resources can be allocated/addressed in time (e.g., a slot) and frequency (subcarrier, bandwidth parts, ands) and/or combinations of the two dimensions.

2. Implementation Methods

Three method inventions have been identified: implementation in FR2; interference source identification; and enable IM based on SRS with different SCS.

2.1 Implementation in FR2

This solution relates measuring interference and may be implemented by one or more nodes in a network described herein, e.g., network 1800 or 1900 individually or collaboratively.

A method for measuring interference in accordance with the solution comprises:

operating a device in a wireless communication system, the device being adapted to operate in a downlink mode, the device comprising an antenna unit, the device adapted for selecting and using one of a set of different spatial receive filters as a selected filter with the antenna unit to implement a directional selectivity for receiving signals with the antenna unit during the downlink mode, e.g., based on a relative location of the gNB with respect to the device;

applying the selected filter;

measuring prior or after the downlink mode the interference with the antenna unit and the selected filter; and

determining an impact of the measured interference on a reception of a signal during the downlink mode. Such a step may be implemented at the UE, the gNB or other entities.

The time of measurement may be prior, during and/or after the downlink mode and may be performed with the antenna unit and the selected filter. The impact of the measured interference on the reception of the signal may be determined during a previous, current or future downlink mode.

According to an embodiment, the measuring the interference comprises receiving a reference signal such as a sounding reference signal or any other configured resource: and determining, from reception of the reference signal/configured resource a Reference Signal Received Power; and/or receiving a signal from a data signal and/or a control signal and determining from the reception of the signal a Received Signal Strength Indication.

Alternatively or in addition, measuring the interference may comprise receiving a reference signal such as a Synchronization Signal Block, SSB or Channel State Information Reference signals (CSI-RS); and determining, from reception of the reference signal a Reference Signal Received Power; and/or receiving a signal power from data and/or control signals; and determining, from reception of the Received Signal Power a Received Signal Strength Indication.

In other words, the solution relates to use an MLRD to observe interference by:
Applying a particular spatial beam (receive filter)
for FR2 UE should measure with the same spatial receive filter as used to receive DL signal from gNB
Observe RSRP and/or RSSI

2.2 Interference Source Identification

A method for addressing interference in accordance with this solution comprises

operating a receiver-device in a wireless communication system, the device comprising an antenna unit for receiving signals in the wireless communication system;

receiving a reference signal transmitted by an interfering device in the wireless communication system;

informing the wireless communication system that the receiver-device suffers from interference caused by the interfering device; and

identifying the interfering device using measures related to the reference signal/configured resource.

For example, the aggressor or interfering device is adapted to change the transmission strategy to change the experienced interference. This can relate to a power control, a different time-slots or the like.

According to an embodiment of this solution, identifying the interfering device comprises:

determining a Reference Signal Received Power of a reception of the reference signal at the receiver-device;

evaluating one or more of a bandwidth part associated with the reference signal; a resource block used for transmitting the reference signal and a time slot used for transmitting the reference signal to obtain an evaluation result; and

providing a report to a base station, comprising information indicating the evaluation result; and

evaluating a past scheduling in the wireless communication systems to identify the interfering device.

According to an embodiment of this solution, the evaluation result is obtained by measuring a resource configured as a zero power, ZP, or a non-zero power, NZP resource, or by a combination of these channel and interference measurement. NZP channel measurements may, for example, include a residual interference, a CSI-IM and/or interference measurements in the neighbouring cells on the configured resources. ZP measurements may include, for example, measurements in the serving cell.

According to an embodiment of this solution, identifying the interference device comprises a combination of information obtained from the reference signal of the interfering device together with its timeslot and the settings of the spatial filter used in the receiving device.
According to an embodiment, identifying the interference device comprises a combination of information obtained from the reference signal of the interfering device wherein the reference signal may be at least one of:
   Identifiable Sounding Reference Signal (SRS) sequence (number/ID),
   A specific phase shift/phase applied on a SRS or SRS sequence,
   A synchronisation signal block, SSB,
   A channel State Information Reference Signal, CSI-RS,
   A SSID from a WiFi access point,
   A bluetooth beacon, or
   Any other identifiable and known reference signal, a receiver could correlate with and derive a measurement specifically related to the interference transmitter.

2.3 Enable IM Based on SRS with Different SCS

This solution further defines solution 2.2.

According to an embodiment, one or more of a bandwidth part associated with the reference signal; a resource block used for transmitting the reference signal and/or a time slot used for transmitting the reference signal is evaluated by use of an interferer-subcarrier spacing underlying the evaluation, the interferer-subcarrier spacing being different from a subcarrier spacing scheduled to the receiver-device. That is, for evaluation a different subcarrier spacing is used or considered, e.g., for decoding.

According to an embodiment, the method comprises: informing the receiver-device about the interferer-subcarrier spacing; and/or measuring different subcarrier spacing during the evaluation to obtain different evaluation results and determining the interferer-subcarrier spacing.

In other words, in the case where the SCS of the aggressor and the victim links are different:
RSRP measurement should be done with SCS of aggressor
Can be combined with RSSI and SIC (depending on ratio between interference and signal)
UE should have knowledge about SCS of the aggressor link

A receiver device in accordance with embodiments is configured for operating in a wireless communication system, and for implementing a method of one of solutions 2.1, 2.2 and 2.3.

Devices described herein, in particular devices for measuring and optionally for reporting and/or logging may be adapted to read or measure all this information within an own cell and/or possibly from the cells that are not their own.

A receiver device in accordance with embodiments is configured for operating in a wireless communication system, and for implementing a method of one of solutions 2.1, 2.2 and 2.3.

3.1 Full Duplex Mechanisms

Further embodiments relate to a recognition in connection with full duplex operation in a wireless communication system, e.g., system 1800 or 2800 adapted accordingly. When operating in full duplex, a device such as a UE may suffer from self-interference as it may suffer from CLI and/ICI. For mitigating self-interference a frequency gap may be established between a radio resource used for transmission and a resource used for reception. This gap may be dependent from one or more parameters comprising, e.g., a distance to the communication partner, e.g., a base station. For example, having a short distance to the base station allows receiving a signal from the gNB with a high signal power/quality whilst requiring a low amount of transmission power to send a signal to the gNB, therefore causing a low amount of self-interference which allows for a small gap. However, having a large distance, e.g., at a cell edge, leads to a low signal power of signals received from the base station and a comparatively high power for transmitting a signal to the base station therefore a high level of possible self-interference which may be addressed with a large gap. That is, the reception power, the transmission pawer and the gap may be distance dependent, dependent from similar effects respectively as, e.g. in multipath environments good or bad channels may also be obtained for large distances, short distances respectively.

FIG. 29a shows a scenario 2900 of an example wireless communication network or at least a part thereof, e.g., network 1800 or 2800. In the scenario, two base stations BS_{A} and BS_{B} with a coverage overlap and two example UEs are present, wherein UE_{A} is served by BS_{A} and UE_{B} is served by BS_{B}.

BS_{A} operates, for example, in a fixed/static UL/DL frame configuration depicted with uplink, UL 2902_{A} and downlink, DL 2904_{A}. shown in FIG. 29b.

BS_{B} can operate in a 1^{st} frame configuration 2906₁, wherein UL and DL resources are not allocated simultaneously (traditional TDD) and in a 2^{nd} frame configuration 2906₂ (of two or more possible configurations), wherein UL and DL resources are partially exclusive in time and partially shared (partial full duplex configuration).

In the right part of the FIG. 29b a time-frequency grid is displayed which UE_{B} can be tasked to observe/measure wrt to interference experienced on different time-frequency resources.

When BS_{A} and BS_{B} both are operating in DL (upmost area 2912), UE_{B} may observe/measure inter-cell-interference (ICI) from BS_{A}.

In time slots where BS_{B} is still operating in DL while BS_{A} is already in UL, UE_{B} will observe/measure cross-link-interference (CLI) from UEs belonging to BS_{A}, in this example represented by UE_{A}. This CLI can be observed over a period of e.g., 2 time slots when BS_{B} is in a 1^{st} frame config and over a period of 3 time slots when BS_{B} is in a 2^{nd} frame config, see area 2914.

In the downmost area 2916, when BS_{A} and BS_{B} are both in UL mode, the UEB can will not be affected by interference by BS_{A} (silent as UL receiver) or UE_{A}, since it is not expecting signals from BS_{B}. During these time slots BS_{A} and BS_{B} may observe/measure ICI in UL from the UEs from the other's UEs, respectively.

Furthermore, there exist two time slots in the 2^{nd} frame config where UE_{B} can transmit while BS_{B} is transmitting as well (Full-duplex operation), causing self-interference (SI) to itself and cross-link-interference (CLI) to other UEs nearby which are about to receive data from BS_{B}, see area 2918.

In these particular time slots UE_{B} can be tasked to measure SI and/or CLI from other UEs belonging to BS_{B} on various levels of detail, in particular with respect to the observed/measured frequency resources in these (full duplex) time slots.

The observing/measurement device, e.g., in accordance with embodiments described herein (UE in DL or BS in UL) may report the interference measurement results including a possible frequency and time slot dependency and the associated type of interference, wherein the type of interference may include at least one of the following:
DL Inter-cell-interference ICI) from BS_{A} or another identifiable BS or a sum of BSs
UL Inter-cell-interference (ICI) from UEs belonging to the other BS
CLI of the UEs from the other BS (UE_{A} and BS_{A} in this example)—Ues from other BS operate in UL or SL (sidelink)
CLI of UEs from own BS when operating in UL or SL (sidelink)
Self-interference (SI) when operating transmitter and receiver simultaneously at the UE e.g. when receiving packets in DL and transmitting packets in UL or SL

That is, FIG. 29b depicts a scenario where the receiving device (UE₈) is measuring different types of interference, while either receiving signals from its base station (BS_{B}) during a 1^{st} frame configuration or for a tentative 2^{nd} frame configuration which may be used in the future.

FIG. 30a/b illustrates that in time slots 2918 operated in full duplex mode not all transmit and receive resources have to be in full overlap. Theory about and practical implementations of self-interference-cancellation schemes in a device show that transmitting and receiving at the same (identical) time-frequency-resource is feasible under certain favorable conditions, but in many less favorable scenarios considered infeasible or requiring to much technical effort, while reception on frequency resources sufficiently apart from the UL resources used by the transmitted seems feasible with limited effort, therefore allowing to reuse the same overall spectrum for simultaneous UL and DL operation by appropriate scheduling of such full duplex resources across the frequency band and the associated UEs operating in receive and transmit mode.

Furthermore, it has to be noted that in such scenario a device receiving signals in DL may have its reception performance impaired/degraded by either self-interference, when transmitting at the same time and/or cross-link-interference (CLI) from other UEs scheduled in UL while the particular UE is receiving packets in DL.

Depending on the implemented antenna isolation between the TX and the RX antenna in a device, the transmitter power used in UL and implemented Interference mitigation schemes the effective Signal-to-Interference-Ratio (SIR) will significantly depend on the frequency gap between the bandwidth part of the transmitted signal and the bandwidth part of the received signal(s).

Plot 3000 in the bottom of the FIG. 30b depicts the relationship between SIR under self-interference conditions and the frequency gap between the transmit and receive BWP. The solid line 3002 represents a scenario alpha/a, where the UE is far away from the BS, therefore receiving a low receive signal power and requiring a high transmit power in UL to bridge the pathloss, resulting in a unfavorable low SIR for the receive band. The curve shows that with sufficient gap between the UL and DL BWP the SIR will be above a threshold, representing a sufficiently high channel quality for successful data transmission (communication) in DL.

The dashed line 3004 represents a scenario where the UE is closer to the BS and the received signal level is higher and at the same time the UL transmit power is lower because the pathloss to bridge is smaller. The resulting SIR curve is shifted vertically compared to the far-distance case (solid) and the threshold is passed already at with a smaller frequency gap (gap beta/β).

The gap in frequency can be associated with a fixed or configurable threshold, representing a minimum frequency distance to be maintained in order to provide a channel quality above the threshold.

Such gap should be determined by the measurement device and reported to the BS, where such information can be used to schedule UL and DL resources appropriately for the UEs (devices) capable of operating in full-duplex mode.
For example, the UE is measuring, evaluating AND reporting:
   an effective SIR,
   a worst case SIR,
      a best case SIR,
      an average/weighted SIR,
   a SIR above a threshold,
   aSIR below a threshold,
   aSIP within a range,
Furthermore, a UE can measure, evaluate and report frequency depending/selective SIR like above and
   a frequency protection gap
   UL-DL separation gap
   Full-duplex gap
   A self-interference protection gap,
   A CLI/SL interference protection gap

Furthermore, the type of interference observed and represented in the SIR value may be:
CLI from particular or a group of UEs
caused by self-interference with a frequency gap of at least or exactly of a particular value or range.

A device configured in a wireless communication network, e.g., in a full-diplex mode, the device configured for:

measuring self-interference related parameters related to wireless communication of the device, e.g., including signal power from the wireless network or from outside the wireless communication network; and

reporting the self-interference related parameters; and/or determining a self-interference mitigation parameter for mitigating the self-interference and for reporting the self-interference mitigation parameter.

The self-interference parameter comprises at least one of:
an effective SIR,
a worst case SIR,
a best case SIR,
an average/weighted SIR,
a SIR above a threshold,
a SIR below a threshold,
a SIP within a range,

The device may be configured for evaluating and reporting frequency depending/selective SIR like above and
a frequency protection gap
UL-DL separation gap
Full-duplex gap
A self-interference protection gap,
A CLI/SL interference protection gap

The device may be configured for measuring one or more of CLI from particular or a group of UEs caused by self-interference with a frequency gap of at least or exactly of a particular value or range.

Similarly, cross-link-interference (CLI) from other UEs operating in UL mode during a full-duplex slot can be characterized in a similar way, wherein the CLI-protection gap is a function of TX power (near-far between UE and BS) and proximity between UEs creating CLI for each other. A BS scheduler can evaluate CLI and SI reports and associated frequency duplex-gap or protection gap for scheduling decisions, which may include appropriate user grouping in order to reduce the CLI of users scheduled in full-duplex slots, some of the UEs receiving signals from the BS while other UEs transmit to the BS.

User grouping can be done in sub-bands where sufficient protection gap is maintained between BWPs used for UL and DL by users in proximity to each other or for a UE transmitting and receiving at the same time.

For example, the reported information about SI and CLI in full-duplex slots can be used to schedule UL and DL resources such, that: groups of UEs operating in UL (transmit) mode are sufficiently separated in frequency domain from another group of UEs operating in DL (receive) mode. Each group can be allocated to BWP allowing observing/measuring UEs to observe CLI from particular BWP allowing a reduced effort in signaling frequency dependent CLI feedback.

When a BS provides knowledge about such BWP (sub-band) allocation, devices (UEs) can measured, evaluated and report in a more efficient manner, when providing feedback about CLI, SI and quantized frequency protection gaps. For example, a UE is provided with information about the configuration of particular BWP (sub-band) allocated for particular UL and or DL resources. Furthermore, the device (UE) can be configured to use the above provided information for a quantized measurement, evaluation and reporting of CLI, SI, protection gaps etc.

In the following, additional embodiments and aspects of the invention will be described which can be used individually or in combination with any of the features and functionalities and details described herein.

Aspect 1. A device (10) configured for operating in a bidirectional wireless communication network in a first operating mode in which the device is in a connected mode during a first time interval and in a second operating mode, in which the device at most performs passive communication during a second, different time interval;

wherein, in the first operating mode, the device (10) is configured for obtaining a set of measurement results (14) comprising at least one measurement result by measuring or determining a radio link parameter (16) associated with an operation of the wireless communication network;

wherein the device (10) is configured for generating a measurement report (18) comprising a set of results having at least one measurement result of the set of measurement results and for transmitting the measurement report (18) to an entity of the wireless communication network.

Aspect 2. The device (10) of aspect 1, wherein the device (10) is configured for obtaining the set of measurement results (14) by measuring or determining at least one non-radio link parameter associated with the operation of the wireless communication network and for generating the measurement report so as to comprise information indicating the non-radio link parameter.

Aspect 3. The device (10) of aspect 2, wherein the device (10) is configured for generating the measurement report (18) so as to comprise the information indicating the non-radio link parameter and so as to not comprise the radio link parameter (16).

Aspect 4. The device (10) of aspect 3, wherein the device (10) is configured for not measuring or determining the radio link parameter (16) when generating the measurement report (18) so as to not comprise the radio link parameter (16).

Aspect 5. The device of one of previous aspects, wherein the device (10) is configured for measuring or determining a plurality of parameters comprising the radio link parameter (16) so as to obtain a plurality of measurement results; wherein the device (10) is configured for generating the measurement report (18) by selecting for the set of measurement results (14) a subset of the plurality of measurement results.

Aspect 6. The device (10) of aspect 5, wherein the device (10) is configured for selecting the subset based on a selection signal received, the selection signal indicating the parameters that are requested to be measured and/or reported by the device.

Aspect 7. The device (10) of one of previous aspects, wherein the device (10) is configured for generating the measurement report as an immediate report.

Aspect 8. The device (10) of one of previous aspects, wherein the device (10) is configured for generating the measurement report as a report of a logged measurement.

Aspect 9. The device of one of previous aspects, wherein the device is configured for generating the measurement report so as to comprise information indicating the radio link parameter (16) and a time information (26) associated with a time the radio link parameter (16) was measured.

Aspect 10. The device of aspect 9, wherein the time relates to:
a time reference of the device;
a different time reference in the wireless communication network;
a combination of multiple time references

Aspect 11. The device of aspect 9 or 10, wherein the time information (26) relates to an absolute and/or relative time measurement and includes information indicating a coherence time, e.g., of time reference grids, a variance, a fluctuation and/or a time drift.

Aspect 12. The device of one of previous aspects, being configured for obtaining a plurality of measurement results, wherein the radio link parameter (16) associated with the operation of the wireless communication network;

wherein the device is configured for generating a log (24) so as to comprise information derived from the plurality of measurement results and time information (26) associated with the plurality of measurement results;

wherein the device is configured for generating a measurement report (18) from the log (24) and for transmitting the measurement report (18) to at least one entity of the wireless communication network;

wherein the radio link parameter (16) is associated with a link (38) operated by the device and/or

wherein the device is configured for generating the measurement report (18) so as to comprise information about at least one instance of the measurement result being obtained prior to a link degrading event causing degrading of the wireless link and for transmitting the measurement report (18) to the entity of the wireless communication network after the link degrading event.

Aspect 13. A device (20) configured for operating in a bidirectional wireless communication network in at least a first operating mode in which the device is in a connected mode;

wherein, in the first operating mode, the device is configured for transmitting and/or receiving wireless signals and for obtaining a plurality of measurement results, obtaining a measurement result comprising measuring or determining a radio link parameter (16) associated with an operation of the wireless communication network;

wherein the device is configured for generating a log (24) so as to comprise information derived from the plurality measurement results and time information associated with the plurality of measurement results;

wherein the device is configured for generating a measurement report (18) from the log (24) and for transmitting the measurement report to at least one entity of the wireless communication network;

wherein the radio link parameter (16) is associated with a link operated by the device; and/or wherein the device is configured for generating the measurement report (18) so as to comprise information about at least one instance of the measurement result being obtained prior to a link degrading event causing degrading of the wireless link and for transmitting the measurement report to the entity of the wireless communication network after the link degrading event.

Aspect 14. The device of aspect 13, wherein the device is configured for generating the measurement report (18) so as to comprise information about at least one instance of the measurement result being obtained prior to a link degrading event causing degrading of the wireless link and for transmitting the measurement report (18) to the entity of the wireless communication network after the link degrading event; and wherein the link degrading event is an event causing a wireless link failure.

Aspect 15. The device of one of previous aspects, wherein the device is configured for generating a log (24) and for reporting the log (24) only in case a predefined triggering event occurs, e.g., a request or a link degradation.

Aspect 16. The device of one of aspects 13 to 15, wherein the device is configured to log measurements in a state of being active, inactive or idle in the wireless communication network.

Aspect 17. The device of one of aspects 13 to 16, wherein the device is configured for including, to the measurement indicated in the measurement report at least one of:
an action in the wireless network determined by the device,
an instruction recognized by the device,
a request recognized by the device
a command recognized by the device, and/or
a configuration of the device and/or other devices

Aspect 18. The device of one of aspects 13 to 17, wherein the device is configured for logging the measurements in at least one of:
a continuous manner;
a timed manner (low-speed, high-speed, dynamic-speed),
a sequenced manner,
an ordered manner,
a requested manner,
a windowed manner,
an instructed manner,
an event-based manner,
a trigger-based manner,
a threshold-based manner and/or
a programmed or scripted manner.

Aspect 19. The device of one of aspects 13 to 18, wherein the device is configured for logging measurements for the measurement report together with a header, identifier, marker or stamp containing one or more of:
an absolute time;
a relative time;
a time relative to a slot,
a frame or the start of service (uptime);
a speed over ground;
a location such as GPS/GNSS coordinates;
an altitude;
a cell ID;
a beam ID;
an antenna pattern;
a cell sector;
a service set identifier (SSID);
an internet service provider (ISP);
a pathloss model (PLM);
a mobile network operator (MNO);
a radio access technology (RAT) connection type such as 5G, 4G, 3G, 2G, Wi-Fi, Bluetooth, LORAN; and/or
a service type such as VoIP, Video On Demand, augmented reality, virtual reality.

Aspect 20. The device of one of aspects 13 to 19, wherein the device is configured for receiving information indicating a measurement result from another device and for generating the log (24) so as to comprise the received measurement result.

Aspect 21. The device of one of aspects 13 to 20, wherein the device is configured for operating in the wireless communication network in the first operating mode in which the device is in a connected mode during a first time interval and in a second operating mode, in which the device at most performs passive communication during a second, different time interval;

wherein, in the first operating mode, the device is configured for obtaining a set (14) of measurement results comprising at least one measurement result by measuring or determining the radio link parameter (16);

wherein the device is configured for generating the measurement report (18) comprising a set of results having at least one measurement result of the set of measurement results.

Aspect 22. The device of one of previous aspects, wherein the device is configured for generating the measurement report (18) based on an report instruction signal (28) received with the device, the report instruction signal comprising information indicating a request to generate the measurement report.

Aspect 23. The device of one of previous aspects, wherein the device is configured for logging measurement results, wherein the device is configured for receiving a logging instruction signal (32) and for logging the measurement results based on the logging instruction signal.

Aspect 24. The device of aspect 23, wherein the logging instruction signal (32) comprises instructions relating to at least one of:
a parameter to be logged;
a parameter to be not logged;
a time interval for which logging is performed;
a number of measurements to be logged; and
fallback options for one or more thereof.

Aspect 25. The device of one of aspects 22 to 24, wherein the device is configured for measuring parameters or determining based on parameters indicated in the report instruction signal (28) and/or indicated in the logging instruction signal (32); and/or wherein the device is configured for not measuring or determining parameters for which that device comprises measurement capability based on the report instruction signal (28) and/or the logging instruction signal (32).

Aspect 26. The device of one of previous aspects, wherein the device is configured for determining an event related to the operation of the wireless communication network and for logging the measurement result based on the determined event.

Aspect 27. The device of one of previous aspects, wherein the device is adapted to include, into the measurement report and associated with the radio link parameter (16) a non-link parameter.

Aspect 28. The device of one of previous aspects, wherein the device is configured for at least one of:

generating and sending a report instruction signal (28) to a further device of the wireless communication network so as to indicate a request to measure and report at least one parameter;

generating and sending a logging instruction signal (32) to a further device of the wireless communication network so as to indicate a request to log at least one parameter;

Aspect 29. The device of one of previous aspects, wherein the device is configured for including validity information into the measurement report, the validity information indicating a validity of the measurement.

Aspect 30. The device of aspect 29, wherein the validity information indicates at least one of:
a time instance or time period the measurement was made;
a resolution or accuracy of the measurement;
a hardware used for the measurement;
a distance to the source of the parameter to be measured;
a certificate indicating a trustworthiness of the device (10).

Aspect 31. The device of one of previous aspects, wherein the device is configured for measuring a receiver related parameter as the radio link parameter; and/or to determining a transmitter related parameter as the radio link parameter.

Aspect 32. The device of aspect 31, wherein the device is configured for determining the transmitter related parameter as one or more of:
Signals: e.g. embedded reference signals (RS), control signals, user plane signals, and/or other reference signals;
Transmission related signals, e.g.:
digital signals to go through digital transmit processing prior to being converted from digital into analogue signal domain;
Digital or analogue control signals applied for beamforming, e.g. phase shifters, delay lines, attenuators and the like
Measured or captured signals, parameters from the transmitter chain, e.g. feedback signals for a digital pre-distortion (DPD) circuit/control of Self-interference-compensation (SIC) used for self- and/or adjacent channel interference cancelation/suppression or spurious emissions or out-of-band (OOB) radiation and/or adjacent channel leakage (ACLR) and the like.
Transmit parameters such as a Cell-ID, a carrier frequency, beamforming weights, antenna parameters or the like
Radio configuration parameters such as a minimum, maximum or actual number of retransmissions, one or more selected antenna panels, used or scheduled time and frequency resources, transmit scheduling information, transmission grants, uplink (UL)-downlink (DL) relations such as in time and/or frequency, e.g., for closed loop control messages, CFO-pre-compensation (CFO: centre/carrier frequency offset), a relationship between messages or settings within one or two directions;
a velocity, a geo-location, an orientation of the entity/device or antenna panel and/or even non-radio link parameters described below.

Aspect 33. The device of one of previous aspects, wherein the device is to measure or determine the radio link parameter for at least one hop of a radio link in the wireless communication network.

Aspect 34. The device of one of previous aspects, being part of a link associated with the radio link parameter (16) as a transmitter, a transceiver, a receiver and a relay or being outside-of-the-link.

Aspect 35. The device of one of previous aspects, wherein the device is configured for measuring or determining the radio link parameter as at least one of
a within-link parameter, e.g., information related to a packet error rate, a throughput, an automatic repeat request count (ARQ); and/or an hybrid automatic repeat request count (HARQ);
an opposing-link parameter, e.g., information related to a cross-link interference (CLI); a signal-to-interference-noise ratio (SINR), an adjacent channel leakage ratio (ACLR) and/or a saturation;
a signal power;
a signal quality, e.g., a RSRP/RSRQ/SNR/SINR
an outside-of-the-link parameter, e.g., information indicating a signal power of a signal, e.g., as a function of frequency (including bandwidth), a time, a resource block, a beam, a cell identification, a direction information such as an Angle of Departure (AoD) and/or an Angle of Arrival (AoA), e.g., with respect to a particular TX beam and/or RX beam.

Aspect 36. The device of one of previous aspects, wherein the device is configured to measure at least one of
a PHY-layer parameter, e.g.,
BER, BLER, MCS levels
RSRP/RSRQ/SNR/SINR of beams measured on SSB, CSI-RS, SRS
Beam numbers on SSB, CSI-RS, SRS;
a higher layer parameter, e.g.,
a number or ID of a serving or connected cell
information indicating cells observed by the device
a latency of communication
a jitter
a throughput of data
as a radio link parameter.

Aspect 37. The device of one of previous aspects being configured for measuring or determining the radio link parameter and at least one of:
an acoustic parameter such as sound, ultrasonic,
a vibration parameter,
a seismic parameter,
a chemical parameter;
an electric parameter such as electric voltage or current, electric potential,
an electromagnetic parameter,
a dielectric parameter,
a radio parameter,
a radar parameter,
an environmental parameter, such as a weather parameter, moisture, humidity, visibility,
a flow related parameter such as fluid velocity; gas flow;
an ionizing radiation parameter,
a parameter related to subatomic particles;
a location-related parameter such as position, angle, displacement, distance, speed and/or acceleration,
an optical parameter such as a colour/wavelength and/or magnitude of light,
an imaging parameter,
a lidar parameter,
a photon parameter,
a pressure parameter;
a force parameter,
a density parameter,
a level parameter;
a thermal parameter such as heat and/or temperature;
a proximity parameter such as a presence or absence of bodies or objects information indicating a potential, a suspected or a known aggressor in view of the wireless communication.

Aspect 38. The device of one of previous aspects, wherein the device is configured for protecting a content of the measurement report (18).

Aspect 39. The device of one of previous aspects, wherein the device is configured for transmitting the measurement report (18) after a link degradation automatically or upon request.

Aspect 40. The device of one of previous aspects, wherein the device is configured for transmitting the measurement report (18) to at least one of a network entity, a communication partner, a next member of a defined group, a basestation, a mobile network operator (MNO), a server running over-the-top, a higher authority such as a regulator, an original equipment manufacturer (OEM) and/or a service provider.

Aspect 41. The device according to one of previous aspects, wherein the device is configured for including, to the measurement report (18) an information indicating a number of hops the measurement report is requested to be forwarded at maximum.

Aspect 42. The device according to one of previous aspects, wherein the device is configured for transmitting the measurement report (18) based on a respective request and for evaluating the request for a priority information; wherein the device is configured for transmitting the measurement report when the priority information indicates a priority of at least a predefined priority level and for not transmitting the measurement report when the priority information indicates a priority of less than the predefined priority level.

Aspect 43. The device according to one of previous aspects, being configured for measuring or determining the radio link parameter (16) for a plurality of cells of the wireless communication network, e.g., at least 64, at least 256 or at least 512 cells, the number of the plurality being advantageously adjustable.

Aspect 44. The device according to one of previous aspects, being at least a component of an apparatus implemented for flying, e.g., a drone.

Aspect 45. The device according to one of previous aspects, being configured for selecting, from a plurality of measurement results a subset of measurement results to be included based on at least one of:
to include a predefined number of measurement results being ranked according to a ranking criterion such as distance, time lapsed, signal strength and reliability; and/or
to select measurement results to be included that are in accordance with a predefined selection criterion such as a best result quality.

Aspect 46. The device according to one of previous aspects, being configured for measuring or determining at least one parameter during a time interval with a first accuracy and for measuring or determining the parameter during a second time interval with a second, higher accuracy.

Aspect 47. The device of aspect 46, wherein the device is configured to start the second time interval upon request or by determining a relevant event associated with the wireless communication network.

Aspect 48. The device according to one of previous aspects, configured for:

performing communication in the wireless communication system in accordance with a communications configuration obtained from a base station of the wireless communication system and scheduling communication of the device;

using information indicating a set of reference signals used in the wireless communication system; and for determining an amount of interference interfering with the communication in the wireless communication system for each of the set of reference signals by measuring to obtain a measurement result indicating the amount of interference perceived by the device through the reference signals of the set of reference signals; and generating a measurement report based on the measurement result and reporting the measurement report to the wireless communication system.

Aspect 49. The device of aspect 48, wherein the device is configured for logging measurement results.

Aspect 50. The device of aspect 48 or 49, wherein the device is configured for determining (estimating), from the measurement result and combination of measurement results, a type of the interference and for including a type information indicating the type into the measurement report.

Aspect 51. The device of aspect 50, wherein the device is configured for evaluating the type of interference based on the configured measurements and/or an angle-of-arrival estimation.

Aspect 52. The device of one of aspects 48 to 51, wherein the device is adapted for reporting the measurement report using at least one uplink radio resource and/or at least one flexible radio resource.

Aspect 53. The device of one of previous aspects, comprising an antenna unit;

wherein the device is configured for selecting and using, for communication in the wireless communication system, a first of a set of different spatial receive filters as a selected filter with the antenna unit to implement a directional selectivity for a reception of signals with the antenna unit; wherein each of the spatial receive filters is associated with a main direction of directional sensitivity; wherein the device is configured for receiving signals from a communication partner using the first spatial receive filter;

wherein the device is configured for performing a measurement procedure during a time different from the communication, the measurement procedure comprising selecting the selected filter in accordance with a direction of an interfering link towards the device, the interfering link interfering with the device;

wherein the device is configured for using information indicating a set of reference signals used in the wireless communication system; and for determining an amount of interference interfering with the communication for each of the set of reference signals by measuring to obtain a measurement result indicating the amount of interference perceived by the device through the reference signals of the set of reference signals;

wherein the device is adapted to select a second spatial filter for the communication based on the measurement results to mitigate interference perceived with the first spatial receive filter.

Aspect 54. The device of aspect 53, wherein the device is configured for selecting the selected filter in accordance with a direction of the interfering link towards the device based on information indicating a control resource set, CORESET, of the interfering link.

Aspect 55. The device of aspect 54, wherein the device is configured for monitoring at least one of:
a physical broadcast channel, PBCH;
a demodulation reference signal in the PBCH, PBCH DM-RS;
a primary synchronization signal, PSS;
a secondary synchronization signal, SSS
to obtain a measurement result and for obtaining the information indicating the CORESET from the measurement result.

56. The device of one of one of aspects 53 to 55, being configured for reporting information indicating at least one of
a spatial receive filter used for the measurement procedure;
a control resource set, CORESET, of the interfering link;
the first spatial receive filter;
the second spatial receive filter
an amount of interference perceived with the first spatial receive filter; and
an amount of interference perceived with the second spatial receive filter.

Aspect 57. The device according to one of previous aspects, being a first device configured for communicating in a wireless communication system, the device comprising an antenna unit and being adapted for establishing a link with a base station; wherein the device is configured for:

selecting a first spatial transmit filter for transmitting a signal with the antenna unit based on a beam correspondence procedure with the base station;

using information indicating a time of transmission of a signal from a different second device; for measuring interference caused by the second device to the first device during the time of transmission and via an interfering channel;

deriving information indicating an amount of interference caused by the first device at the second device using a reciprocal channel assumption with respect to the interfering channel;

selecting a different second spatial transmit filter based on the information indicating the amount of interference so as to mitigate the interference of the first device at the second device.

Aspect 58. The device of aspect 57, wherein the device is configured for measuring for the interference caused by the second device to the first device during the time of transmission and via an interfering channel using a matched spatial receive filter to obtain a main direction of the directional selectivity towards the second device; and evaluating an interference power received with the matched filter based on a maximum interference measured thereby;

wherein the device is configured for calculating a suitable spatial receive filter for mitigating the interference caused by the second device;

for deriving the information indicating the amount of interference caused by the first device by providing an estimate of interference that will be caused when using a similar or equivalent spatial transmit filter, e.g., based on beam correspondence, for transmission;

wherein the device is configured for selecting the different second spatial transmit filter to mitigate interference

Aspect 59. The device according to one of previous aspects being configured for communicating in a wireless communication system and for receiving a signal from a communication partner;

wherein the device is configured for observing a set of radio resources of the wireless communication system, e.g., during which the communication partner transmits or receives signals;

wherein the device is configured for measuring, for each of the radio resources, interference occurring in the radio resource, to obtain measurement results; and

for reporting, to the wireless communication system, the measurement results or information derived thereof; and/or

for determining, based on the measurement results and based on an interference criterion, at least one selected future radio resource; and

for transmitting information indicating the at least one future radio resource to the wireless communication system; and/or for requesting a schedule of downlink and/or uplink signals from the communication partner in the at least one selected future radio resources.

Aspect 60. The device of aspect 59, wherein the device is configured for requesting a schedule of downlink and/or uplink signals from the communication partner in the at least one selected future radio resource together with an indication which radio resource to be used.

Aspect 61. The device of aspect 60, wherein the indication comprises at least one of a prioritized, deprioritized, whitelisted, blacklisted and barred indication of future radio resources.

Aspect 62. The device of one of aspects 59 to 61, wherein the device is configured for measuring the interference as a cross-link-interference perceived from at least one link of a different device.

Aspect 63. The device of one of aspects 59 to 62, wherein the device is configured for measuring the interference as a inter-cell-interference perceived from at least one link of a different base station.

Aspect 64. The device of one of aspects 59 to 63, wherein the device is configured for measuring the interference as a self-interference of itself.

Aspect 65. The device of aspect 58 or 59, wherein the device is configured for measuring the interference based on receiving a reference signal such as a sounding reference signal, SRS; and/or based on an evaluation of a signal power received via a cross-link-interference channel from at least one link of a different device.

Aspect 66. The device of one of aspects 59 to 65, wherein the device is configured for measuring the interference based on receiving a reference signal such as a synchronization signal block, SSB or downlink channel state information reference signal, CSI-RS; and/or based on an evaluation of a signal power received via a inter-cell-interference channel from at least one link of a different base station.

Aspect 67. The device of one of aspects 59 or 66, wherein the device is configured for measuring the self-interference based on knowledge of the signal to be transmitted.

Aspect 68. The device of one of aspects 59 to 67, wherein the set of radio resources is based on a time in which other devices communicating with the communication partner operate in a transmit mode whilst the device operates in a receive mode.

Aspect 69. The device of one of aspects 59 to 68, wherein the device is to determine, from the measurement results, statistics indicating suitable radio resources in the temporal past; and to derive, using the statistics, the selected future radio resources as radio resources that are expected to allow a successful decoding of a signal transmitted to or by the device.

Aspect 70. The device of one of aspects 59 to 69, wherein the device is configured for determine a candidate for the future radio resource as the selected future radio resources based on a decision whether the candidate fulfils a predetermined criterion with regard to a transmission quality.

Aspect 71. The device of one of aspects 59 to 70, wherein the device is configured for determine the selected future radio resources as being expected to have a level of interference of at most a first interference threshold and/or a level of interference of at least a second interference threshold.

Aspect 72. The device of one of aspects 59 to 71, wherein the device is configured for determine the selected future radio resources based on at least one probability of:

a packet collision in the selected future radio resource,

the device being out of coverage during the selected future radio resource

packet loss higher than a threshold in the selected future radio resource

Signal to interference ratio, SIR, exceeding a predetermined threshold the selected future radio resource

Packet erasure events over multiple retransmissions occurring when using the selected future radio resource

Aspect 73. The device of one of aspects 59 to 72, wherein the device is configured for receiving, from the wireless communication system and responsive to transmitting the information or the request an indication indicating that the device is scheduled to receive information in the slot; wherein the device is configured for transmitting, to the wireless communication system a confirmation signal indicating a confirmation for the indicated radio resource and/or wherein the device is configured for transmitting, to the wireless communication system a rejection signal indicating a rejection for the indicated radio resource; and/or

wherein the device is configured for transmitting, to the wireless communication system a packet retransmission request signal indicating an expected misdetection or channel degradation for the indicated radio resource.

Aspect 74. The device of aspect 73, wherein the device is configured for transmitting information indicating the plurality of selected future radio resources to the wireless communication system; and/or for requesting a schedule of downlink signals from the communication partner in a plurality of selected future radio resources;

wherein the indication indicates a subset of the plurality of future radio resources as a selection thereof.

Aspect 75. The device of aspect 73 or 74, wherein the device is configured for transmitting information indicating a plurality of selected future radio resources to the wireless communication system; and/or for requesting a retransmission of downlink data packets from the communication partner in a plurality of selected future radio resources;

wherein the indication indicates a subset of the plurality of future radio resources as a selection thereof.

Aspect 76. The device of one of aspects 59 to 75, wherein the device is configured for transmitting, prior to the selected future radio resource, a pre-emption signal; wherein the device is configured for transmitting the pre-emption signal

to devices of the same wireless communication system to indicate an expected signal in the selected future radio resource and/or

to devices of another wireless communication system configured for transmission in the selected future radio resource.

Aspect 77. The device of one of aspects 59 to 76, wherein the measured radio resources comprise at least one uplink radio resource and/or at least one downlink radio resource; and/or

wherein the future radio resource is an uplink slot or a downlink radio resource or a flexible radio resource.

Aspect 78. A device (30) configured for operating in a wireless communication network, wherein the device (10, 20) is configured for instructing a measuring or determining device of the wireless communication network to:

transmitting a measurement report (18) comprising a measurement result comprising information indicating a radio link parameter associated with the operation of the wireless communication network.

Aspect 79. The device of aspect 78, wherein the operation of the wireless communication network relates to a wireless link of the device.

Aspect 80. The device of aspect 78 or 79, wherein the wireless link is a link of the measuring or determining device.

Aspect 81. The device of one of aspects 78 to 80, wherein the device is configured for evaluate the measurement report (18) for the radio link parameter (16) and for a non-link parameter associated with the radio link parameter; and to determine a reason being related to the non-link parameter that caused a degrading of the wireless link being indicated by the radio link parameter.

Aspect 82. The device of one of aspects 78 to 81, wherein the device is configured for instructing a plurality of measurement devices to perform measurements and for transmitting measurement reports (18), so as to orchestrate distributed measurements.

Aspect 83. The device of one of aspects 78 to 82, being a basestation of the wireless communication network.

Aspect 84. The device of one of aspects 78 to 83, wherein the device is configured for instructing the measuring or determining device of the wireless communication network to measure, from a plurality of parameters, a set of parameters comprising at least one parameter, the plurality of parameters including the radio link parameter; wherein the set of parameters is at least one of:
predefined;
defined dynamically; and/or
selected individually.

Aspect 85. A wireless communication network comprising:

at least a first device according to one of aspects 1 to 77 or a device according to one of aspects 77 to 83; and

at least a second device being a device according to one of aspects 1 to 77 or a device according to one of aspects 78 to 84.

Aspect 86. The wireless communication network of aspect 85, wherein the network is configured to perform a root cause analysis using the measurement report to analyse a cause for a link degrading event and/or to reconfigure the network to avoid or at least partly compensate for a link degrading event.

Aspect 87. The wireless communication system of aspect 85 or 86, wherein the network is to analyse a radio communication link associated with the radio link parameter (16) at
a single end of the communication link;
a first end and a second end of the communication link; and/or
at least three ends of the communication link being a multi-hop link.

Aspect 88. The wireless communication system of one of aspects 85 to 87, wherein the wireless communication network is configured for analysing, e.g., after a link-degrading event and/or during a self-healing/optimization process before the link degrading event a relationship referring to one or more of:
an uplink (UL)-downlink (DL) relation;
a relationship between consecutively received signals; and
a relationship between consecutively transmitted signals

Aspect 89. The wireless communication system of aspect 88, being configured for analysing the relationship between messages or settings within one direction, e.g., relative pointers/reference to messages, events, settings for uni-directional transmission/communication) and/or two directions, e.g., relative pointers/reference to messages, events, settings for bi-directional transmission/communication.

Aspect 90. The wireless communication system of one of aspects 87 to 89, being configured for analysing the relationship so as to comprise a cross-referencing between at least a first hop and a second hop of a multi-hop link.

Aspect 91. The wireless communication system of one of aspects 85 to 90, being configured for signalling that at least a portion of a link is of interest, e.g., the portion being considered to be weak, and to selectively provide for measurement or determining of the radio link parameter (16) and/or other parameters based on the signalling; wherein the network is adapted to provide and evaluate a respective log or measurement report to an analysing unit.

Aspect 92. The wireless communication system of one of aspects 85 to 91, being configured for measuring an interference source parameter related to a receive beam pattern of a device, e.g., an MLRD, and for assessing, with the MLRD and/or other entities of the network, an interference impact of at least one other device on interference management for the receive beam pattern, e.g., to decide about a control of the other device for the interference management.

Aspect 93. A method (1000) for operating a device in a bidirectional wireless communication network in a first operating mode in which the device is in a connected mode during a first time interval and in a second operating mode, in which the device at most performs passive communication during a second, different time interval, the method comprising:

operating (1010) the device in the first operating mode and obtaining, using the device, a set of measurement results comprising at least one measurement result by measuring or determining a radio link parameter associated with an operation of the wireless communication network; and

generating (1020), using the device, a measurement report comprising a set of results having at least one measurement result of the set of measurement results and transmitting the measurement report to an entity of the wireless communication network.

Aspect 94. A method (1100) for operating a device in a bidirectional wireless communication network in at least a first operating mode in which the device is in a connected mode, the method comprising:

operating (1110) the device in the first operating mode, and transmitting and/or receiving wireless signals and so as to obtain a plurality of measurement results, obtaining a measurement result comprising measuring or determining a radio link parameter associated with an operation of the wireless communication network;

generating (1120) a log with the device so as to comprise information derived from the plurality measurement results and time information associated with the plurality of measurement results;

generating (1130) a measurement report from the log, using the device, and transmitting the measurement report to at least one entity of the wireless communication network;

such that the radio link parameter is associated with a link operated by the device and/or such that the device generates the measurement report so as to comprise information about at least one instance of the measurement result being obtained prior to a link degrading event causing degrading of the wireless link and for transmitting the measurement report to the entity of the wireless communication network after the link degrading event.

Aspect 95. A method (1200) for operating a device in a wireless communication network, comprising:

Instructing (1210), using the device, a measuring or determining device of the wireless communication network to:

transmitting a measurement report comprising a measurement result comprising information indicating a radio link parameter associated with the operation of the wireless communication network.

Aspect 96. A computer readable digital storage medium having stored thereon a computer program having a program code for performing, when running on a computer, a method according to one of aspects 93 to 95.

Aspect 97. A wireless communication system comprising:

a base station adapted for scheduling, using a communications configuration, communication of a plurality of devices, the plurality of devices including a reporting device according to one of aspects 1 to 77;

wherein the reporting device is configured for performing communication in the wireless communication system in accordance with the communications configuration;

wherein the reporting device is configured for using information indicating a set of reference signals used in the wireless communication system; and for determining an amount of interference interfering with the communication in the wireless communication system for each of the set of reference signals by measuring, e.g., RSRP, RSSI or any other adopted signal metric, to obtain a measurement result indicating the amount of interference perceived by the reporting device through the reference signals of the set of reference signals;

wherein the reporting device is configured for reporting, to the wireless communication system a measurement report being based on the measurement result; and

wherein the wireless communication system is configured for using the measurement report and information about other devices communicating in the wireless communication system and information about reference signals used by the other devices for adapting the communications configuration of at least one device of the plurality of devices for mitigating interference.

Aspect 98. The wireless communication system of aspect 97, being configured for identifying an interferer causing interference to the reporting device; and for adapting the communications configuration of the reporting device and/or of the interferer to reduce an amount of interference.

Aspect 99. The wireless communication system of aspect 97 or 98, being configured for further identifying the interferer causing the interference potentially to other devices in the vicinity of the reporting device; and for adapting the communications configuration of the reporting device and/or of the interferer to reduce an amount of interference.

Aspect 100. The wireless communication system of aspect 99, wherein the reporting device is configured for obtaining the measurement result based on measuring uplink radio resources scheduled to the reporting device for obtaining information related to the interferer causing interference to the reporting device and based on measuring uplink radio resources scheduled to the other devices for obtaining information related to the interferer causing the interference potentially to the other devices.

Aspect 101. The wireless communication system of one of previous aspects, wherein the reporting device is configured for measuring interference by observing transmit signals of other devices, e.g. in their current uplink radio resources and for performing the measurement while the reporting device is in a receive mode, e.g., during a current downlink, DL, and/or uplink, UL, radio resource.

Aspect 102. The wireless communication system of aspect 101, wherein the reporting device is adapted to transmit, to the base station a suggestion for a future communications configuration, e.g., based on a listen before talk procedure or enhanced listen before talk procedure described herein.

Aspect 103. The wireless communication system of one of aspects 97 to 102, wherein the wireless communication system comprises a plurality of base stations;

wherein the reporting device is configured for reporting the measurement report to the base station being a first base station and a scheduling base station for the reporting device;

the wireless communication system being configured for identifying an interferer causing interference to the reporting device, the interferer being scheduled by a different second base station;

wherein the first base station is to adapt a communications configuration for the reporting device to mitigate the interference; and/or

wherein the first base station is configured for providing information to the second base station, wherein the second base station is configured for adapting a communications configuration of the interferer to mitigate the interference based on the information.

Aspect 104. The wireless communication system of one of aspects 94 to 103, wherein the wireless communication system is adapted for using information about interferes and the interference they cause in the wireless communication system based on reports received from reporting devices to determine the communications configuration to obtain an overall mitigated interference for scheduled devices based on an optimization criterion.

Aspect 105. The wireless communication system of one of aspects 97 to 104, wherein the wireless communication system is configured for determining, from the measurement result or the measurement report, a type of the interference and for including a type information indicating the type into the measurement report.

Aspect 106. The wireless communication system of one of aspects 97 to 105, wherein the reporting device is adapted for measuring continuously, repeatedly or based upon request and for deciding whether to report the measurement report or not based on a decision criterion applied to the measurement result.

Aspect 107. The wireless communication system of one of aspects 97 to 106, wherein the reporting device is adapted to evaluate the measurement results and for generating the measurement report to comprise an evaluation result.

Aspect 108. The wireless communication system of one of aspects 97 to 107, wherein the reporting device is adapted to generate the measurement report by condensing, compressing or summarizing a set of measurement results.

Aspect 109. A base station configured for operating in a wireless communication system, the base station adapted for scheduling, using a communications configuration, communication of a plurality of devices, the plurality of devices including a reporting device being a device in accordance with one of aspects 1 to 69;

wherein the base station is configured for receiving a report generated by the reporting device, the measurement report indicating an amount of interference perceived by the reporting device through a reference signal of a set of reference signals used in the wireless communication system; and

wherein the base station is configured for using the measurement report and information about other devices communicating in the wireless communication system and information about reference signals used by the other devices for adapting the communications configuration of at least one device of the plurality of devices for mitigating interference.

Aspect 110. A wireless communication system comprising:

at least one base station;

a plurality of devices being scheduled with communication by the at least one base station;

wherein each of the devices is a device according to one of aspects 1 to 77 and is configured for:

observing a device-individual set of downlink radio resources of the wireless communication system;

measuring, for each of the downlink radio resources, interference occurring in the downlink radio resource, to obtain measurement results; and

reporting, to the wireless communication system, the measurement results or information derived thereof;

wherein the wireless communication system is configured for determining a communications configuration for the plurality of devices that mitigates interference caused by transmitting signals to the devices during future downlink radio resources based on evaluation of the reported downlink radio resources, e.g., by extrapolation.

Aspect 111. The wireless communication system of aspect 110, wherein the wireless communication system is configured for

identifying, for future downlink radio resources and for a reference communications configuration, potential interferes and potential victims, e.g., the device itself and/or other devices, potentially experiencing interference by the interferers; and at least one of:

scheduling at least one interferer and/or at least one victim to a different radio resource when compared to the reference communications configuration; and

changing a transmission behaviour of a potential interferer;

to determine the communications configuration.

Aspect 112. The wireless communication system of aspect 110 or 111, wherein the wireless communication system is adapted to repeatedly measure the radio resources of a first UL/DL configuration and/or a different second UL/DL configuration and to determine a measure for interference such as CLI, for the first and the second UL/DL configuration, and for selecting one of the first and the second UL/DL configurations as a future UL/DL configuration based on the interference.

Aspect 113. A wireless communication system configured for providing a wireless communication at least from a base station to a device;

wherein the device is a device in accordance with one of aspects 1 to 77 and is configured for:

observing a radio environment of the device to obtain an observation result; and to determine, based on the observation result, at least one radio resource as being vulnerable to a cross link interference and/or an inter-cell interference;

reporting, to the base station a report indicating the at least one radio resource;

receiving information indicating a communications configuration to receive a signal in a scheduled future radio resource;

wherein the wireless communication system is configured for transmitting a pre-emption signal to indicate an expected signal in the scheduled future radio resource.

Aspect 114. The wireless communication system of aspect 113, wherein the base station is configured for determining the communications configuration based on the report.

Aspect 115. The wireless communication system of aspect 114, being configured to transmit the pre-emption signal with the device to receive the signal in the scheduled future radio resource; and/or with the base station to transmit the signal in the scheduled future radio resource.

Aspect 116. The wireless communication system of one aspects 113 to 115, wherein the pre-emption signal is adapted to identify/address at least one radio resource to be temporarily protected by other devices nearby by avoiding transmitting using the at least one radio resource.

Aspect 117. The wireless communication system of one of aspects 114 to 116, being adapted for observing the radio environment also with the base station to obtain a bi-directional observation.

Aspect 118. The wireless communication system of one of aspects 114 to 117, wherein the device is configured for observing the radio environment during an initial stage. [

Aspect 119. The wireless communication system of one of aspects 113 to 118, wherein the base station is configured for observing the radio resources and parts of the spectrum associated with a link with the device; and for reporting information indicating a link quality or an interference information associated with the link to the device to obtain a bi-directional link information at the device together with the observation result.

Aspect 120. The wireless communication system according to one of pervious aspects, wherein the wireless communication system comprises an integrated access and backhaul, IAB, network, wherein the base station is a gNB of the IAB network.

Aspect 121. The wireless communication system according to one of pervious aspects, wherein the wireless communication system is adapted for a dynamic indication for restriction and/or availability of beams between nodes of the wireless communication system in the configured radio resources; wherein radio resources can be allocated/addressed in time (e.g., a slot) and frequency (subcarrier, bandwidth parts, ands) and/or combinations of the two dimensions.

Aspect 122. A method for measuring interference, the method comprising:

operating a device in a wireless communication system, the device being adapted to operate in a downlink mode, the device comprising an antenna unit, the device adapted for selecting and using one of a set of different spatial receive filters as a selected filter with the antenna unit to implement a directional selectivity for receiving signals with the antenna unit during the downlink mode;

applying the selected filter;

measuring prior, during or after the downlink mode the interference with the antenna unit and the selected filter; and

determining an impact of the measured interference on a reception of a signal during a previous, current or future downlink mode.

Aspect 123. The method of aspect 122, wherein measuring the interference comprises:

receiving a reference signal such as a sounding reference signal; and determining, from reception of the reference signal a Reference Signal Received Power; and/or

receiving a signal from a data signal and/or a control signal and determining from the reception of the signal a Received Signal Strength Indication.

Aspect 124. The method of aspect 122 or 123, wherein measuring the interference comprises:

receiving a reference signal such as a Synchronization Signal Block, SSB or Channel State Information Reference signals (CSI-RS); and determining, from reception of the reference signal a Reference Signal Received Power; and/or

receiving a signal power from data and/or control signals; and determining, from reception of the Received Signal Power a Received Signal Strength Indication.

Aspect 125. A method for addressing interference, the method comprising:

operating a receiver-device in a wireless communication system, the device comprising an antenna unit for receiving signals in the wireless communication system;

receiving a reference signal transmitted by an interfering device in the wireless communication system;

informing the wireless communication system that the receiver-device suffers from interference caused by the interfering device; and

identifying the interfering device using measures related to the reference signal.

Aspect 126. The method of aspect 125, wherein identifying the interfering device comprises:

determining a Reference Signal Received Power of a reception of the reference signal at the receiver-device;

evaluating one or more of a bandwidth part associated with the reference signal; a resource block used for transmitting the reference signal and a time slot used for transmitting the reference signal to obtain an evaluation result; and providing a report to a base station, comprising information indicating the evaluation result;

evaluating a past scheduling in the wireless communication systems to identify the interfering device.

Aspect 127. The method of aspect 125 or 126, wherein the evaluation result is obtained by a zero power, ZP, or a non-zero power, NZP, interference measurement.

Aspect 128. The method of one of aspects 125 to 127 wherein identifying the interference device comprises a combination of information obtained from the reference signal of the interfering device together with its time slot and the settings of the spatial filter used in the receiving device.

Aspect 129. The method of one of aspects 125 to 128 wherein identifying the interference device comprises a combination of information obtained from the reference signal of the interfering device wherein the reference signal may be at least one of:
Identifiable Sounding Reference Signal (SRS) sequence (number/ID),
A specific phase shift/phase applied on a SRS or SRS sequence,
A synchronisation signal block, SSB,
A channel State Information Reference Signal, CSI-RS,
A SSID from a WiFi access point,
A bluetooth beacon, or
Any other identifiable and known reference signal, a receiver could correlate with and derive a measurement specifically related to the interference transmitter.

Aspect 130. The method of one of aspects 125 to 129, wherein a bandwidth part associated with the reference signal; a resource block used for transmitting the reference signal and/or a time slot used for transmitting the reference signal is evaluated by use of an interferer-subcarrier spacing underlying the evaluation, the interferer-subcarrier spacing being different from a subcarrier spacing scheduled to the receiver-device.

Aspect 131. The method of aspect 130, comprising: informing the receiver-device about the interferer-subcarrier spacing; and/or measuring different subcarrier spacing during the evaluation to obtain different evaluation results and determining the interferer-subcarrier spacing.

Aspect 132. A receiver device configured for operating in a wireless communication system, the receiver device configured for implementing a method of one of aspects 124 to 129.

Aspect 133. The receiver device according to aspect 132 being in accordance with any of aspects 1 to 77.

Aspect 134. A computer readable digital storage medium having stored thereon a computer program having a program code for performing, when running on a computer, a method according to one of aspects 125 to 132.

Aspect 135. A method for operating a wireless communication system, the method comprising:

operating a base station for scheduling, using a communications configuration, communication of a plurality of devices, the plurality of devices including a reporting device;

operating the reporting device for performing communication in the wireless communication system in accordance with the communications configuration;

such that the reporting device uses information indicating a set of reference signals used in the wireless communication system; and determines an amount of interference interfering with the communication in the wireless communication system for each of the set of reference signals by measuring to obtain a measurement result indicating the amount of interference perceived by the reporting device through the reference signals of the set of reference signals;

such that the reporting device reports, to the wireless communication system a measurement report being based on the measurement result; and

such that the wireless communication system uses the measurement report and information about other devices communicating in the wireless communication system and information about reference signals used by the other devices for adapting the communications configuration of at least one device of the plurality of devices for mitigating interference.

Aspect 136. A method for operating a device in a wireless communication system, the method comprising:

performing communication in the wireless communication system in accordance with a communications configuration obtained from a base station of the wireless communication system and scheduling communication of the device;

using information indicating a set of reference signals used in the wireless communication system; and determining an amount of interference interfering with the communication in the wireless communication system for each of the set of reference signals by measuring to obtain a measurement result indicating the amount of interference perceived by the device through the reference signals of the set of reference signals; and

generating a measurement report based on the measurement result and reporting the measurement report to the wireless communication system.

Aspect 137. A method for operating a base station in a wireless communication system, the base station adapted for scheduling, using a communications configuration, communication of a plurality of devices, the plurality of devices including a reporting device, the method comprising;

receiving a report generated by the reporting device, the measurement report indicating an amount of interference perceived by the reporting device through a reference signal of a set of reference signals used in the wireless communication system; and using the measurement report and information about other devices communicating in the wireless communication system and information about reference signals used by the other devices for adapting the communications configuration of at least one device of the plurality of devices for mitigating interference.

Aspect 138. A method for operating a device in a wireless communication system, the device comprising an antenna unit, the method comprising:

selecting and using, for communication in the wireless communication system, a first of a set of different spatial receive filters as a selected filter with the antenna unit to implement a directional selectivity for a reception of signals with the antenna unit; wherein each of the spatial receive filters is associated with a main direction of directional sensitivity; such that the device receives signals from a communication partner using the first spatial receive filter;

performing a measurement procedure during a time different from the communication, the measurement procedure comprising selecting the selected filter in accordance with a direction of an interfering link towards the device, the interfering link interfering with the device;

using information indicating a set of reference signals used in the wireless communication system;

determining an amount of interference interfering with the communication for each of the set of reference signals by measuring to obtain a measurement result indicating the amount of interference perceived by the device through the reference signals of the set of reference signals; and

selecting a second spatial filter for the communication based on the measurement results to mitigate interference perceived with the first spatial receive filter.

Aspect 139. A method for operating a first device in a wireless communication system, the device comprising an antenna unit and being adapted for establishing a link with a base station; wherein the method comprises:

selecting a first spatial transmit filter for transmitting a signal with the antenna unit based on a beam correspondence procedure with the base station;

using information indicating a time of transmission of a signal from a different second device; for measuring interference caused by the second device to the first device during the time of transmission and via an interfering channel;

deriving information indicating an amount of interference caused by the first device at the second device using a reciprocal channel assumption with respect to the interfering channel;

selecting a different second spatial transmit filter based on the information indicating the amount of interference so as to mitigate the interference of the first device at the second device.

Aspect 140. A method for operating a device in a wireless communication system for receiving a signal from a communication partner, the method comprising;

observing a set of radio resources of the wireless communication system, e.g., during which the communication partner transmits or receives signals;

measuring, for each of the radio resources, interference occurring in the radio resource, to obtain measurement results; and

reporting, to the wireless communication system, the measurement results or information derived thereof; and/or

determining, based on the measurement results and based on an interference criterion, at least one selected future radio resource; and

transmitting information indicating the at least one future radio resource to the wireless communication system; and/or for requesting a schedule of downlink and/or uplink signals from the communication partner in the at least one selected future radio resources.

Aspect 141. A method for operating a wireless communication system comprising at least one base station; and a plurality of devices being scheduled with communication by the at least one base station, the method comprising:

observing, with each of the devices, a device-individual set of radio resources of the wireless communication system;

measuring, for each of the radio resources, interference occurring in the radio resource, to obtain measurement results; and

reporting, to the wireless communication system, the measurement results or information derived thereof;

determining, with the wireless communication system, a communications configuration for the plurality of devices that mitigates interference caused by transmitting signals to the devices during future radio resources based on evaluation of the reported radio resources, e.g., by extrapolation.

Aspect 142. A method for operating a wireless communication system for providing a wireless communication at least from a base station to a device, the method comprising;

operating the device for:

observing a radio environment of the device to obtain an observation result; and to determine, based on the observation result, at least one radio resource as being vulnerable to a cross link interference;

reporting, to the base station a report indicating the at least one radio resource; and

receiving information indicating a communications configuration to receive a signal in a scheduled future radio resource;

transmitting within the wireless communication system a pre-emption signal to indicate an expected signal in the scheduled future radio resource.

Aspect 143. A computer readable digital storage medium having stored thereon a computer program having a program code for performing, when running on a computer, a method according to one of aspects 135 to 142.

Aspect 144. A device configured in a wireless communication network, e.g., in a full-duplex mode, the device configured for:

measuring self-interference related parameters related to wireless communication of the device, e.g., including signal power from the wireless network or from outside the wireless communication network; and

reporting the self-interference related parameters; and/or determining a self-interference mitigation parameter for mitigating the self-interference and for reporting the self-interference mitigation parameter.

Aspect 145. The device of aspect 144, wherein the self-interference parameter comprises at least one of:
an effective SIR,
a worst case SIR,
a best case SIR,
an average/weighted SIR,
a SIR above a threshold,
a SIR below a threshold,
a SIP within a range,

Aspect 146. The device of aspect 144 or 145, wherein the device is configured for evaluating and reporting frequency depending/selective SIR like above and
a frequency protection gap
UL-DL separation gap
Full-duplex gap
A self-interference protection gap,
A CLI/SL interference protection gap

Aspect 147. The device of one of aspects 144 to 146, wherein the device is configured for measuring one or more of CLI from particular or a group of UEs caused by self-interference with a frequency gap of at least or exactly of a particular value or range.

Aspect 148. The device of one of aspects 144 to 147, wherein the device is configured for receiving, from the wireless communication system information about a configuration of particular bandwidth part allocated for particular UL and or DL resources; wherein the device (UE) is configured to use the above provided information for a quantized measurement, evaluation and reporting of CLI, SI, protection gaps etc.

Aspect 149. A wireless communication system comprising a device of one of aspects 144 to 148 being adapted for scheduling uplink and/or downlink resources based on the report received from the device.

Aspect 150. The wireless communication system of aspect 149, being adapted for scheduling the uplink resource and/or the downlink resources for a plurality of groups of devices, one group thereof comprising the device.

Aspect 151. The wireless communication system of aspect 150, wherein each group can be allocated to a bandwidth part BWP allowing observing/measuring UEs to observe CLI from particular BWP allowing a reduced effort in signaling frequency dependent CLI feedback.

Aspect 152. A method for operating a device in a wireless communication network, e.g., in a full-duplex mode, the method comprising:

measuring self-interference related parameters related to wireless communication of the device, e.g., including signal power from the wireless network or from outside the wireless communication network; and

reporting the self-interference related parameters; and/or determining a self-interference mitigation parameter for mitigating the self-interference and for reporting the self-interference mitigation parameter.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are advantageously performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

ABBREVIATION TABLE

| Abbreviation | Definition | Further description |
|---|---|---|
| 2G | second generation | |
| 3G | third generation | |
| 3GPP | third generation partnership project | |
| 4G | fourth generation | |
| 5G | fifth generation | |
| 5GC | 5G core network | |
| ACLR | adjacent channel leakage ratio | |
| AoA | angle of arrival | |
| AoD | angle of departure | |
| AP | access point | |
| ARQ | automatic repeat request | |
| BER | bit-error rate | |
| BLER | block-error rate | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received signal | |
| CP1 | control plane 1 | |
| CP2 | control plane 2 | |
| CSI-RS | channel state information reference | |
| CU | central unit | |
| D2D | device-to-device | |
| DAPS | dual active protocol stack | |
| DC-CA | dual-connectivity carrier aggregation | |
| DECT | digitally enhanced cordless telephony | |
| DL | downlink | |
| DMRS | demodulation reference signal | |
| DOA | direction of arrival | |
| DRB | data radio bearer | |
| DU | distributed unit | |
| ECGI | E-UTRAN cell global identifier | |
| E-CID | enhanced cell ID | |
| eNB | evolved node b | |
| EN-DC | E-UTRAN-New Radio dual connectivity | |
| EUTRA | Enhanced UTRA | |
| E-UTRAN | Enhanced UTRA network | |
| gNB | next generation node-b | |
| GNSS | global navigation satellite system | |
| GPS | global positioning system | |
| HARQ. | hybrid ARQ | |
| IAB | integrated access and backhaul | |
| ID | identity/identification | |
| IIOT | industrial Internet of things | |
| KPI | key-performance indicator | |
| LTE | Long-term evolution | |
| MCG | master cell group | |
| MCS | modulation coding scheme | |
| MDT | minimization of drive tests | |
| MIMO | multiple-input/multiple-output | |
| MLR | measure, log and report | |
| MLRD | MLR device | |
| MNO | mobile network operator | |
| MR-DC | multi-RAT dual connectivity | |
| NCGI | new radio cell global identifier | |
| NG | next generation | |
| ng-eNB | next generation eNB | node providing E-UTRA |
| NG-RAN | either a gNB or an ng-eNB | |
| NR | new radio | |
| NR-U | NR unlicensed | NR operating in unlicensed |
| OAM | operation and maintenance | |
| OEM | OEM original equipment manufacturer | |
| OTT | OTT over-the-top | |
| PCI | physical cell identifier | Also known as PCID |
| PDCP | packet data convergence protocol | |
| PER | packet error rate | |
| PHY | physical | |
| PLMN | public land mobile network | |
| QCL | quasi colocation | |
| RA | random access | |
| RACH | random access channel | |
| RAN | radio access network | |
| RAT | radio access technology | |
| RF | radio frequency | |
| RIM | radio access network information | |
| RIM-RS | RIM reference signal | |
| RLC | radio link control | |
| RLF | radio link failure | |
| RLM | radio link monitoring | |
| RP | reception point | |
| R-PLMN | registered public land mobile network | |
| RRC | radio resource control | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| SA | standalone | |
| SCG | secondary cell group | |
| SDU | service data unit | |
| SIB | system information block | |
| SINR | signal-to-interference-plus-noise ratio | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SS | synchronization signal | |
| SSB | synchronization signal block | |
| SSID | service set identifier | |
| SS-PBCH | sounding signal/physical broadcast | |
| TAC | tracking area code | |
| TB | transmission block | |
| TDD | time division duplex | |
| TSG | technical specification group | |
| UDN | ultra-dense networks | |
| UE | user equipment | |
| UL | uplink | |
| URLLC | ultra-reliable low latency communication | |
| UTRAN | universal trunked radio access network | |
| V2X | vehicle-to-everything | |
| VoIP | voice over Internet protocol | |
| WI | work item | |
| WLAN | wireless local area network | |

1. A device configured for operating in a bidirectional wireless communication network in a first operating mode in which the device is in a connected mode during a first time interval and in a second operating mode, in which the device at most performs passive communication during a second, different time interval;
wherein, in the first operating mode, the device is configured for acquiring a set of measurement results comprising at least one measurement result by measuring or determining a radio link parameter associated with an operation of the wireless communication network;
wherein the device is configured for generating a measurement report comprising a set of results comprising at least one measurement result of the set of measurement results and for transmitting the measurement report to an entity of the wireless communication network.

2. The device of claim 1, wherein the device is configured for acquiring the set of measurement results by measuring or determining at least one non-radio link parameter associated with the operation of the wireless communication network and for generating the measurement report so as to comprise information indicating the non-radio link parameter.

3. The device of claim 2, wherein the device is configured for generating the measurement report so as to comprise the information indicating the non-radio link parameter and so as to not comprise the radio link parameter.

4. The device of claim 3, wherein the device is configured for not measuring or determining the radio link parameter when generating the measurement report so as to not comprise the radio link parameter.

5. The device of claim 1, wherein the device is configured for measuring or determining a plurality of parameters comprising the radio link parameter so as to acquire a plurality of measurement results; wherein the device is configured for generating the measurement report by selecting for the set of measurement results a subset of the plurality of measurement results;
wherein the device is configured for selecting the subset based on a selection signal received, the selection signal indicating the parameters that are requested to be measured and/or reported by the device.

6. The device of claim 1, being configured for acquiring a plurality of measurement results, wherein the radio link parameter (16) associated with the operation of the wireless communication network;
wherein the device is configured for generating a log so as to comprise information derived from the plurality of measurement results and time information associated with the plurality of measurement results;
wherein the device is configured for generating a measurement report from the log and for transmitting the measurement report to at least one entity of the wireless communication network;
wherein the radio link parameter is associated with a link operated by the device and/or
wherein the device is configured for generating the measurement report so as to comprise information about at least one instance of the measurement result being acquired prior to a link degrading event causing degrading of the wireless link and for transmitting the measurement report to the entity of the wireless communication network after the link degrading event.

7. A device configured for operating in a bidirectional wireless communication network in at least a first operating mode in which the device is in a connected mode;
wherein, in the first operating mode, the device is configured for transmitting and/or receiving wireless signals and for acquiring a plurality of measurement results, acquiring a measurement result comprising measuring or determining a radio link parameter associated with an operation of the wireless communication network;
wherein the device is configured for generating a log so as to comprise information derived from the plurality measurement results and time information associated with the plurality of measurement results;
wherein the device is configured for generating a measurement report from the log and for transmitting the measurement report to at least one entity of the wireless communication network;
wherein the radio link parameter is associated with a link operated by the device; and/or
wherein the device is configured for generating the measurement report so as to comprise information about at least one instance of the measurement result being acquired prior to a link degrading event causing degrading of the wireless link and for transmitting the measurement report to the entity of the wireless communication network after the link degrading event.

8. The device of claim 7, wherein the device is configured for generating the measurement report so as to comprise information about at least one instance of the measurement result being acquired prior to a link degrading event causing degrading of the wireless link and for transmitting the measurement report to the entity of the wireless communication network after the link degrading event; and wherein the link degrading event is an event causing a wireless link failure.

9. The device of claim 1, wherein the device is configured for generating a log and for reporting the log only in case a predefined triggering event occurs that comprises a link degradation.

10. The device of one of claim 7, wherein the device is configured for receiving information indicating a measurement result from another device and for generating the log so as to comprise the received measurement result.

11. The device of one of claim 7, wherein the device is configured for operating in the wireless communication network in the first operating mode in which the device is in a connected mode during a first time interval and in a second operating mode, in which the device at most performs passive communication during a second, different time interval;
wherein, in the first operating mode, the device is configured for acquiring a set of measurement results comprising at least one measurement result by measuring or determining the radio link parameter;
wherein the device is configured for generating the measurement report comprising a set of results comprising at least one measurement result of the set of measurement results.

12. The device of claim 1, wherein the device is configured for generating the measurement report based on an report instruction signal received with the device, the report instruction signal comprising information indicating a request to generate the measurement report.

13. The device of claim 1, wherein the device is configured for logging measurement results, wherein the device is configured for receiving a logging instruction signal and for logging the measurement results based on the logging instruction signal.

14. The device of claim 1, wherein the device is configured for at least one of:
generating and sending a report instruction signal to a further device of the wireless communication network so as to indicate a request to measure and report at least one parameter;
generating and sending a logging instruction signal to a further device of the wireless communication network so as to indicate a request to log at least one parameter;

15. The device of claim 1, wherein the device is configured for including validity information into the measurement report, the validity information indicating a validity of the measurement;
wherein the validity information indicates at least one of:
a resolution or accuracy of the measurement;
a hardware used for the measurement;
a distance to the source of the parameter to be measured;
a certificate indicating a trustworthiness of the device.

16. The device of claim 1 being configured for measuring or determining the non-radio link parameter and at least one of:
an acoustic parameter,
a vibration parameter,
a seismic parameter,
a chemical parameter;
an electric parameter,
an electromagnetic parameter,
a dielectric parameter,
a radio parameter,
a radar parameter,
an environmental parameter,
a flow related parameter;
an ionizing radiation parameter,
a parameter related to subatomic particles;
a location-related parameter;
an optical parameter,
an imaging parameter,
a lidar parameter,
a photon parameter,
a pressure parameter;
a force parameter,
a density parameter,
a level parameter;
a thermal parameter;
a proximity parameter;
information indicating a potential, a suspected or a known aggressor in view of the wireless communication.

17. The device of claim 1, wherein the device is configured for protecting a content of the measurement report.

18. The device of claim 1, wherein the device is configured for transmitting the measurement report after a link degradation automatically.

19. The device according to claim 1, wherein the device is configured for including, to the measurement report an information indicating a number of hops the measurement report is requested to be forwarded at maximum.

20. The device according to claim 1, wherein the device is configured for transmitting the measurement report based on a respective request and for evaluating the request for a priority information; wherein the device is configured for transmitting the measurement report when the priority information indicates a priority of at least a predefined priority level and for not transmitting the measurement report when the priority information indicates a priority of less than the predefined priority level.

21. The device according to claim 1, being at least a component of an apparatus implemented for flying.

22. The device according to claim 1, being configured for measuring or determining at least one parameter during a time interval with a first accuracy and for measuring or determining the parameter during a second time interval with a second, higher accuracy.

23. The device of claim 22, wherein the device is configured to start the second time interval upon request or by determining a relevant event associated with the wireless communication network.

24. A wireless communication network comprising:
at least a first device according to claim 1; and
at least a second device being a device according to claim 1;
wherein the network is configured to perform a root cause analysis using the measurement report to analyse a cause for a link degrading event and/or to reconfigure the network to avoid or at least partly compensate for a link degrading event.

25. A method for operating a device in a bidirectional wireless communication network in a first operating mode in which the device is in a connected mode during a first time interval and in a second operating mode, in which the device at most performs passive communication during a second, different time interval, the method comprising:
operating the device in the first operating mode and acquiring, using the device, a set of measurement results comprising at least one measurement result by measuring or determining a radio link parameter associated with an operation of the wireless communication network; and
generating, using the device, a measurement report comprising a set of results comprising at least one measurement result of the set of measurement results and transmitting the measurement report to an entity of the wireless communication network.

26. A non-transitory digital storage medium having a computer program stored thereon to perform the method for operating a device in a bidirectional wireless communication network in a first operating mode in which the device is in a connected mode during a first time interval and in a second operating mode, in which the device at most performs passive communication during a second, different time interval, the method comprising:
operating the device in the first operating mode and acquiring, using the device, a set of measurement results comprising at least one measurement result by measuring or determining a radio link parameter associated with an operation of the wireless communication network; and
generating, using the device, a measurement report comprising a set of results comprising at least one measurement result of the set of measurement results and transmitting the measurement report to an entity of the wireless communication network,
when said computer program is run by a computer.
